(19) United States
(12) Patent Application Publication
(10) Pub. No.: US 2026/0002090 A1
(43) Pub. Date: Jan. 1, 2026

(54) HYDROPHOBIC AND HYDROPHILIC MODIFIED MALEATED NATURAL OILS AND COMPOSITIONS THEREOF

(71) Applicant: ISP INVESTMENTS LLC, Wilmington, DE (US)

(72) Inventors: Osama M. MUSA, Bedminster, NJ (US); Mousumi GHOSH, Elmwood Park, NJ (US); Donald I. PRETTYPAUL, Englewood, NJ (US); Diane M. KENNEDY, Bayonne, NJ (US)

(21) Appl. No.: 18/869,549

(22) PCT Filed: Jun. 6, 2023
(86) PCT No.: PCT/US2023/024534

§ 371 Date: Nov. 26, 2024

Related U.S. Application Data
(60) Provisional application No. 63/347,234, filed on May 31, 2022.

(51) Int. Cl. C11C 3/04

(52) U.S. Cl. CPC C11C 3/04

(57) ABSTRACT

The present invention provides compositions comprising a reaction product of (a) a maleated natural oil, comprising a natural oil with maleated functionality; and (b) a functionalized or unfunctionalized moiety selected from the group costing of hydrophobic moieties, hydrophilic moieties, and combinations thereof; with the proviso that the hydrophilic moiety is not a glycerol moiety. In another aspect of the invention, the invention provides compositions comprising a reaction product of (a) a maleated natural oil, comprising a natural oil with maleated functionality; (b) a functionalized or unfunctionalized hydrophobic moiety; and (c) a glycerol moiety. In yet another aspect, the present application provides compositions comprising a reaction product of (a) a maleated natural oil, comprising a natural oil with maleated functionality: (b) two functionalized or unfunctionalized hydrophilic moieties. The above compositions may further comprise a functional system active ingredient. The modified maleated natural oils are useful in a wide variety of compositions and applications. In yet another aspect of the invention, the invention provides the compound represented by the structures set out below: (Formula).

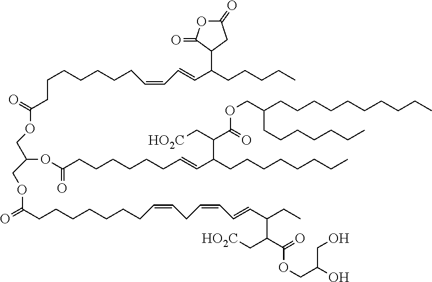 [SMILES: CCCCCCCCCCC(CCCCCCC)COC(=O)C(CC(=O)O)C(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C(CC(=O)O)C(=O)OCC(O)CO)CCCCCCCC]

### FIELD OF THE INVENTION

The present application provides compositions comprising modified maleated natural oils. The modified maleated natural oils do not exhibit many of the limited properties of maleated natural oils. The modified maleated natural oils are useful in a wide variety of compositions and applications.

### BACKGROUND OF THE INVENTION

Modified natural oils can be non-dispersible in water or alcohols. As a result, these oils can be incorporated into a wide variety of compositions. Such compositions include, but are not limited to, personal care (e.g., hair care, sun care, skin care, oral care), adhesives, coatings, paints, electronics, household, industrial and institutional (HI&I) compositions, inks, membranes, metal working fluids, oilfield chemicals, plastics and plasticizers, textiles, industrial products, biocides, pharmaceuticals/nutritionals, and agrochemical compositions.

Natural oils, such as soybean and linseed oils, are one of the most promising raw materials for the synthesis of renewable compounds, including polymers, plastics, and plasticizers. These natural materials are inexpensive, highly abundant, come from reliable and sustainable sources, and have high potential for modification. Natural oils are generally blends of different triglycerides, the esterification product of fatty acids and glycerol, and contain varying degrees of unsaturation (i.e., double bonds). Oils can be characterized by a hydroxyl value and the fatty acid compositions. Both natural fatty acids and natural oils must be chemically modified to make them sufficiently reactive to allow structural alterations and polymerizations to occur because the olefin functional groups are relatively unreactive. Unsaturated double bonds in these compounds have been converted to epoxide functional groups and succinic anhydride functional groups, allowing the addition of many hydroxyl containing species to be introduced into the natural oils.

Maleated natural oils are natural oils that have been chemically functionalized by the chemical addition of epoxide (oxirane) and succinic anhydride functional groups. Examples include epoxidized and maleated soybean oil and linseed oil, unsaturated natural oils lend themselves to these chemical functionalizations.

U.S. Pat. No. 9,809,538B2 describes a modified natural compound synthesized from epoxidized natural fatty acid, maleated natural fatty acid, epoxidized natural oil, or maleated natural oil; and lactam compound with hydroxyl(s) to form e.g. adhesive or beverage composition.

A discussion of reaction scheme for the maleinization reaction in the vegetable oil is provided in the article “Maleated soybean oil and its multifunctional properties,” by Gripp, Anna A., Steinberg, David C., published in Cosmetics Exhibition & Conference Conference Proceedings, Barcelona, Mar. 22-24, 1994.

A discussion of reaction scheme for the maleinization reaction in the vegetable oil is provided in the article “Microwave Assisted Syntheses of Vegetable Oil Based Monomer,” by Rafael T. Alarcon et al., published in Journal of Polymers and the Environment 28:1265-1278, 2020.

A discussion of generalized reaction between maleic anhydride and unsaturated vegetable oils is provided in the handbook of maleic Anhydride based materials-syntheses, properties and applications by Osama M. Musa in chapter 3 page 166, published in Springer International Publishing Switzerland 2016.

U.S. Pat. No. 2,754,306A describes a reaction with a soybean oil, maleic anhydride based and iso-octyl alcohol to provide an improved plasticizer for nitrocellulose compositions.

PCT Application No. 2019113068A1 and 2005071050A1 describes a technology related to metalworking fluids comprising maleated soybean oil derivatives.

A discussion of maleic anhydride polymerization and modified plant oils with polyols is provided in the article “Polymerization of Maleic Anhydride-Modified Plant Oils with Polyols,” by Tarik Eren, Selim H. Kusefoglu, Richard Wool published in Journal of Applied Polymer Science, Barcelona, Volume 90, Issue 1, Pages 197-202, 2003.

EP U.S. Pat. No. 2,754,306A describes an adhesive containing a polycondensate and a dienophile modified fatty acid as a cross-linking agent.

US Publication 20180070584A1 describes an adjuvant composition that includes a maleated natural oil derivative into agrochemical formulations and applied to target substrates to kill, inhibit, or repel pests.

PCT Application No. 2005071050A1 describes a metalworking fluid comprising oil in water emulsion from a reaction product of maleic anhydride and a triglyceride oil from a plant or land animal and further reacted with water, Group IA and IIA metals, ammonium hydroxide, various amines, alkanolamines, polyols, alkoxylated alkanolamines, poly(alkylene oxide) s, or polyamines or mixtures.

Despite the renewability, biodegradability, sustainability, and beneficial functions provided by natural fatty acids, natural oils and their maleated counterparts, they exhibit properties that can limit their application. For example, maleated soybean oil is insoluble and non-dispersible in water or alcohols. As a result, these oils may tend to exude or phase-separate from formulated compositions. This feature makes their formulation more difficult, often requiring additional ingredients to facilitate solutions, emulsions, or dispersions. Natural and maleated natural oils may not impart the desired property needed in end-uses, such as solubilization capability, glass transition, flexibility, shine, and/or plasticization. Consequently, the performance (including, but not limited to stability, resistance to phase separation, absorption, clean-up, solubility potential, staining potential, lubrication, film formation, uniformity of spreading, comedogenic tendency, ease of removal), and aesthetic qualities (such as skin-feel, greasiness, shiny appearance) may be less than desired. Finally, although such natural oils are an important renewable material, they are not always the formulator's first choice, and, in fact, often are not considered at all.

Mineral oils and vegetable oils are often used as components of personal care compositions. Accordingly, there is a need for materials that are renewable, natural, and biodegradable having different and controllable chemical, physical, and/or mechanical properties such that the limitations found in natural and maleated natural oils are minimized or eliminated. Most personal care compositions contain more than one inert ingredient to help deliver the active ingredient to the desired skin care properties. Others are persistent in the skin care having toxic products or other undesired side-effects. In addition, each time a new active component is released to the market, it necessitates the development of a unique composition to get the active ingredient into the field. Therefore, there is a need to develop new, functionalized maleated natural oils for use in personal care inert ingredients that are non-toxic and inspired by or created from renewable resources.

### SUMMARY OF THE INVENTION

The present invention provides compositions comprising a reaction product of (a) a maleated natural oil, comprising a natural oil with maleated functionality; and (b) a functionalized or unfunctionalized moiety selected from the group costing of hydrophobic moieties, hydrophilic moieties, and combinations thereof; with the proviso that the hydrophilic moiety is not a glycerol moiety

In another aspect of the invention, the invention provides compositions comprising a reaction product of (a) a maleated natural oil, comprising a natural oil with maleated functionality; (b) a functionalized or unfunctionalized hydrophobic moiety; and (c) a glycerol moiety.

In yet another aspect, the present application provides compositions comprising (A) a reaction product of: (a) a maleated natural oil, comprising a natural oil with maleated functionality; and (b) a functionalized or unfunctionalized moiety selected from the group consisting of hydrophobic moieties, hydrophilic moieties, and combinations thereof; and (B) (a) a functional system active ingredient.

In yet another aspect, the present application provides compositions comprising a reaction product of
(a) a maleated natural oil, comprising a natural oil with maleated functionality;
(b) two functionalized or unfunctionalized hydrophilic moieties.

In yet another aspect, the present application provides compositions comprising:
(A) a reaction product of
(a) a maleated natural oil, comprising a natural oil with maleated functionality;
(b) two functionalized or unfunctionalized hydrophilic moieties; and
(B) a functional system active ingredient.

In yet another aspect of the invention, the invention provides compounds represented by the structures set out below:

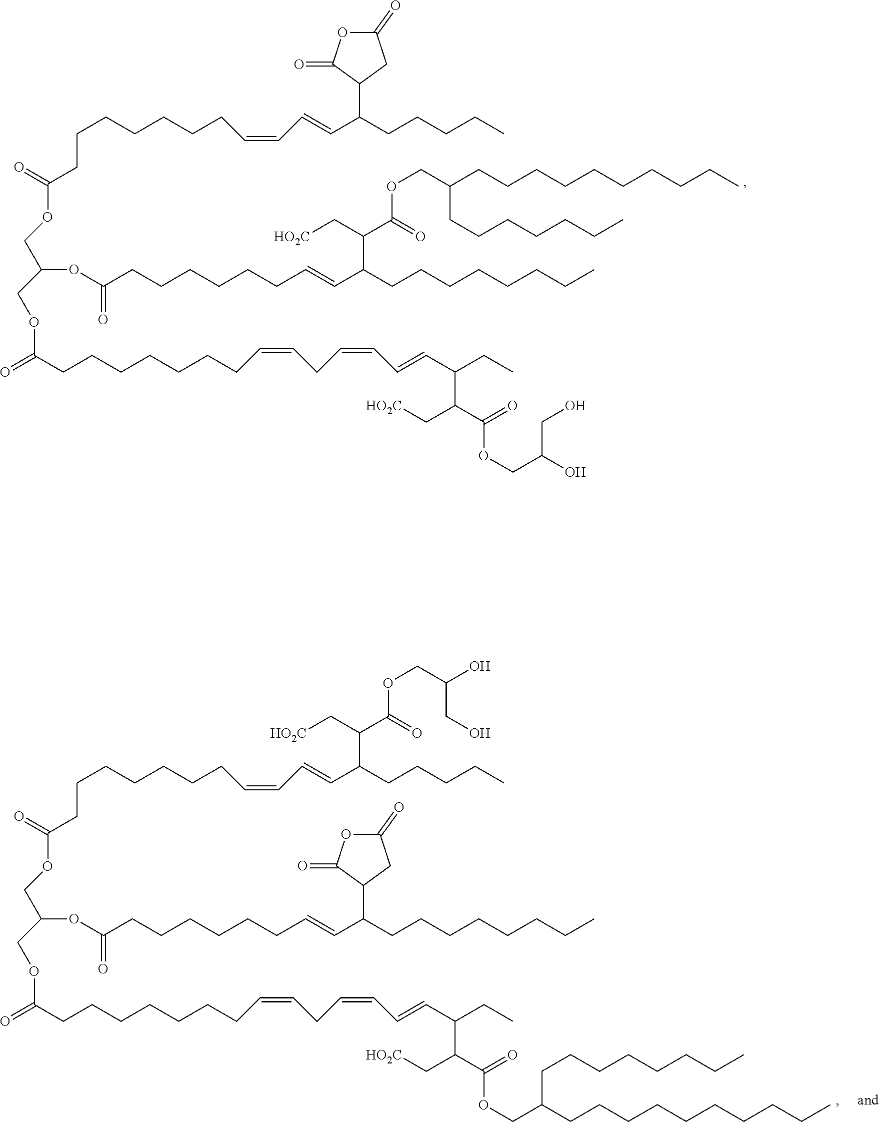 [SMILES: CCCCCCCCCCC(CCCCCCC)COC(=O)C(CC(=O)O)C(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C(CC(=O)O)C(=O)OCC(O)CO)CCCCCCCC ; CCCCCCCCCCC(CCCCCCCC)COC(=O)C(CC(=O)O)C(/C=C/C=C\C/C=C\CCCCCCCC(=O)OCC(COC(=O)CCCCCCC/C=C\C=C\C(CCCCC)C(CC(=O)O)C(=O)OCC(O)CO)OC(=O)CCCCCC/C=C/C(CCCCCCCC)C1CC(=O)OC1=O)CC]

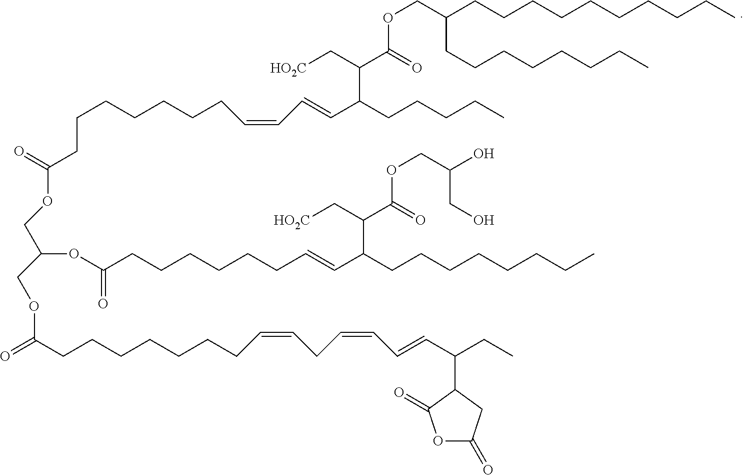 [SMILES: CCCCCCCCCCC(CCCCCCCC)COC(=O)C(CC(=O)O)C(/C=C/C=C\CCCCCCCC(=O)OCC(COC(=O)CCCCCCC/C=C\C/C=C\C=C\C(CC)C1CC(=O)OC1=O)OC(=O)CCCCCC/C=C/C(CCCCCCCC)C(CC(=O)O)C(=O)OCC(O)CO)CCCCC]

The modified maleated natural oils are useful in a wide variety of compositions and applications.

### DETAILED DESCRIPTION OF THE INVENTION

The present application provides compositions comprising modified maleated natural oils which do not exhibit many of the limited properties of maleated natural oils. The modified maleated natural oils are useful in a wide variety of compositions and applications.

Natural oils are abundant, inexpensive, and are derived from sustainable sources. Natural oils are useful for synthesizing renewable compounds such as polymers, plastics, and plasticizers, which compounds are useful in a variety of compositions. A difficultly with utililizing natural oils is that they are blends of triglycerides containing varying degrees of unsaturated groups, which unsaturated groups are relatively unreactive. To make these natural oils reactive, these unsaturated groups are generally chemically modified to make them reactive. For example, these unsaturated groups can be reacted with maleates to provide epoxide functional groups and succinic anhydride functional groups. Despite these chemical modifications, the maleated natural oils can still exhibit limited properties such as insolubility or non-dispersibility in water and alcohols. Accordingly, there is a need for further modified maleated natural oils which do not exhibit the limited properties of maleated natural oils.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

The singular forms “a,” “an,” and “the” include plural forms unless the context clearly dictates otherwise specified or clearly implied to the contrary by the context in which the reference is made. The term “Comprising” and “Comprises of” includes the more restrictive claims such as “Consisting essentially of” and “Consisting of”.

For purposes of the following detailed description, other than in any operating examples, or where otherwise indicated, numbers that express, for example, quantities of ingredients used in the specification and claims are to be understood as being modified in all instances by the term “about”. The numerical parameters set forth in the specification and attached claims are approximations that may vary depending upon the desired properties to be obtained in carrying out the invention.

All percentages, parts, proportions and ratios as used herein, are by weight of the total composition, unless otherwise specified. All such weights as they pertain to listed ingredients are based on the active level and, therefore; do not include solvents or by-products that may be included in commercially available materials, unless otherwise specified.

All publications, articles, papers, patents, patent publications, and other references cited herein are hereby incorporated herein in their entirety for all purposes to the extent consistent with the disclosure herein.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results.

The term “branched and unbranched alkyl groups” refers to alkyl groups, which may be straight chained or branched. Branched groups include isopropyl, tert-butyl, and the like.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “each independently selected from the group consisting of” means when a group appears more than once in a structure, that group may be selected independently each time it appears.

The term “polymer” refers to a compound comprising repeating structural units (monomers) connected by covalent chemical bonds. Polymers may be further derivatized, crosslinked, grafted or end-capped. Non-limiting examples of polymers include copolymers, terpolymers, tetrapolymers, quaternary polymers, and homologues. The term “copolymer” refers to a polymer consisting essentially of two or more different types of monomers polymerized to obtain said copolymer.

The term “reaction product” refers to a substance produced from a chemical reaction of one or more reactant substances.

The term “natural oil” refers to compounds comprising triglycerides and may contain varying levels of fatty acids, monoglycerides, diglycerides and triglycerides refer to oil derived from plants or animal sources. Natural oils also include fatty acid glyceryl esters, which are synthesized by reacting glycerol with 1, 2, or 3 molar equivalents of a fatty acid or a mixture of fatty acids. These compounds can be mono, di or triglycerides of a single fatty acid or a mixture of fatty acids.

The term “maleated natural oil”, as used herein, refers to natural oil contains at least one or more maleated functionalities. Accordingly, the term “maleation” or “maleated” as used hereafter should be understood to mean “functionalization” insofar as the use of functionalizing reagents other than maleic anhydride are contemplated for use in the process of the invention.

As used herein, the term “moiety” or “moieties” refers to a part or a functional group(s) of a molecule.

The term “functional system active ingredient” refers to any ingredient that provides pharmacological activity or other direct effect in the diagnosis, cure, mitigation, treatment, or prevention of disease, or affects the structure or any function of the body of man or animals. The functional system active ingredient may be present either in a personal care product or a household care product. When the functional system active ingredient is present in a personal care product that contains at least one active personal care ingredient, the personal care active ingredient includes, but is not limited to, analgesics, anesthetics, antibiotic agents, antifungal agents, antiseptic agents, antidandruff agents, antibacterial agents, vitamins, hormones, antidiarrhea agents, corticosteroids, anti-inflammatory agents, vasodilators, kerolytic agents, dry-eye compositions, wound-healing agents, anti-infection agents, as well as solvents, diluents, adjuvants and other ingredients such as water, mineral oils, preservatives, surfactants, propellants, fragrances, essential oils, and viscosifying agents.

The term “functionalized” with reference to any moiety refers to the presence of one or more functional groups in the moiety. Various functional groups may be introduced in a moiety by way of one or more functionalization reactions known to a person having ordinary skill in the art. Non-limiting examples of functionalization reactions include: alkylation, epoxidation, sulfonation, hydrolysis, amidation, esterification, hydroxylation, dihydroxylation, amination, ammonolysis, acylation, nitration, oxidation, dehydration, elimination, hydration, dehydrogenation, hydrogenation, acetalization, halogenation, dehydrohalogenation, Michael addition, aldol condensation, Canizzaro reaction, Mannich reaction, Clasien condensation, Suzuki coupling, and the like. In one non-limiting embodiment, the term “functionalized” with reference to any moiety refers to the presence of one more functional groups selected from the group consisting of alkyl, alkenyl, hydroxyl, carboxyl, halogen, alkoxy, amino, imino, and combinations thereof, in the moiety.

As used herein, the term “hydrophilic” means that the compound has an affinity for water, whereas “hydrophobic” means not having an affinity for water.

The terms are relative terms, where a hydrophilic moiety it has a higher affinity for water than a hydrophobic moiety, but the hydrophilic moiety may or may not be completely water soluble.

Likewise, hydrophobic moieties have less of an affinity for water than hydrophilic moieties, but the hydrophobic moieties may not necessarily be water-repellant. While hydrophilic moieties have an affinity for water and other polar solvents, hydrophobic moieties tend to have an affinity for oils, fats, and other non-polar solvents.

The term “unreacted maleated functionality” refers to a composition comprising a reaction product of maleated natural oil in which the components of maleated functionality are completely unreacted and properties are not changed.

The term “hydrocarbyl” includes straight-chain and branched-chain alkyl, alkenyl, alkynyl, cycloalkyl, cycloalkenyl, aryl groups, and combinations thereof with optional heteroatom(s). A hydrocarbyl group may be mono-, di- or polyvalent and have carbon chains contain at least 2 carbon atoms and preferably 2 to 100 carbon atoms.

The term “alkyl” refers to a functionalized or unfunctionalized, monovalent, straight-chain, branched-chain, or cyclic C₁-C₆₀ hydrocarbyl group optionally having one or more heteroatoms. In one non-limiting embodiment, an alkyl is a C₁-C₄₅ hydrocarbyl group. In another non-limiting embodiment, an alkyl is a C₁-C₃₀ hydrocarbyl group. Non-limiting examples of alkyl include methyl, ethyl, n-propyl, isopropyl, n-butyl, isobutyl, tert-butyl, n-pentyl, isopentyl, n-hexyl, n-heptyl, n-octyl, 2-ethylhexyl, tert-octyl, iso-norbornyl, n-dodecyl, tert-dodecyl, n-tetradecyl, n-hexadecyl, n-octadecyl, n-eicosyl, cyclobutyl, cyclopentyl, cyclohexyl, and the like. The definition of “alkyl” also includes groups obtained by combinations of straight-chain, branched-chain and/or cyclic structures.

The term “aryl” refers to a functionalized or unfunctionalized, monovalent, aromatic hydrocarbyl group optionally having one or more heteroatoms. The definition of aryl includes carbocyclic and heterocyclic aromatic groups. Non-limiting examples of aryl groups include phenyl, naphthyl, indenyl, indanyl, azulenyl, fluorenyl, anthracenyl, furyl, thienyl, pyridyl, pyrrolyl, oxazolyl, thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, isoquinolinyl, cinnolinyl, phthalazinyl, quinazolinyl, quinoxalinyl, 1,8-naphthridinyl, pteridinyl, carbazolyl, acridinyl, phenazinyl, phenothiazinyl, phenoxyazinyl, pyrazolo[1,5-c]triazinyl, and the like.

The term “aralkyl” refers to an alkyl group comprising one or more aryl substituent(s) wherein “aryl” and “alkyl” are as defined above. Non-limiting examples of aralkyl groups include benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like.

The term “alkylene” refers to a functionalized or unfunctionalized, divalent, straight-chain, branched-chain, or cyclic C₁-C₄₀ hydrocarbyl group optionally having one or more heteroatoms. In one non-limiting embodiment, an alkylene is a C₁-C₃₀ group. In another non-limiting embodiment, an alkylene is a C₁-C₂₀ group. Non-limiting examples of alkylene groups include:

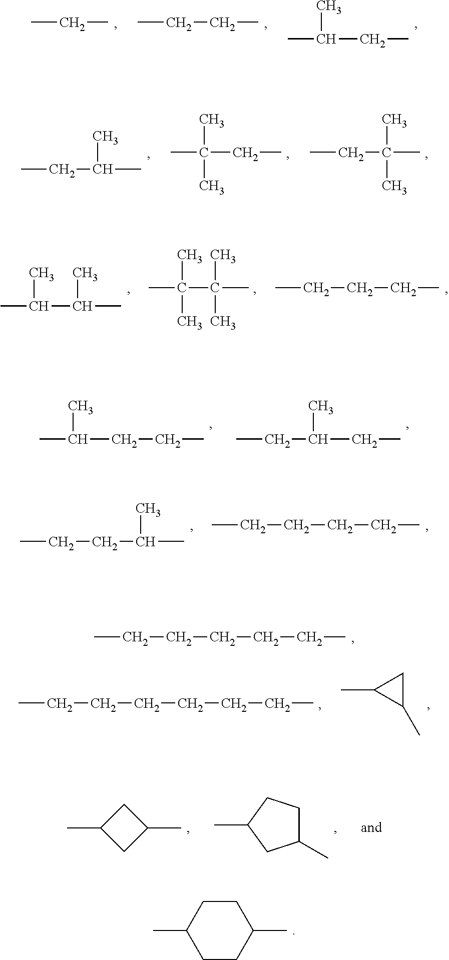

The term “arylene” refers to a functionalized or unfunctionalized, divalent, aromatic hydrocarbyl group optionally having one or more heteroatoms. The definition of arylene includes carbocyclic and heterocyclic groups. Non-limiting examples of arylene groups include phenylene, naphthylene, pyridinylene, and the like.

The term “heteroatom” refers to oxygen, nitrogen, sulfur, silicon, phosphorous, or halogen. The heteroatom(s) may be present as a part of one or more heteroatom-containing functional groups.

Non-limiting examples of heteroatom-containing functional groups include ether, hydroxy, epoxy, carbonyl, carboxamide, carboxylic ester, carboxylic acid, imine, imide, amine, sulfonic, sulfonamide, phosphonic, and silane groups. The heteroatom(s) may also be present as a part of a ring such as in heteroaryl and heteroarylene groups.

The structures set out below may refer to the first, second, or third structure, or combinations thereof. The succinic anhydride group may be present in the top, middle, or lower chain.

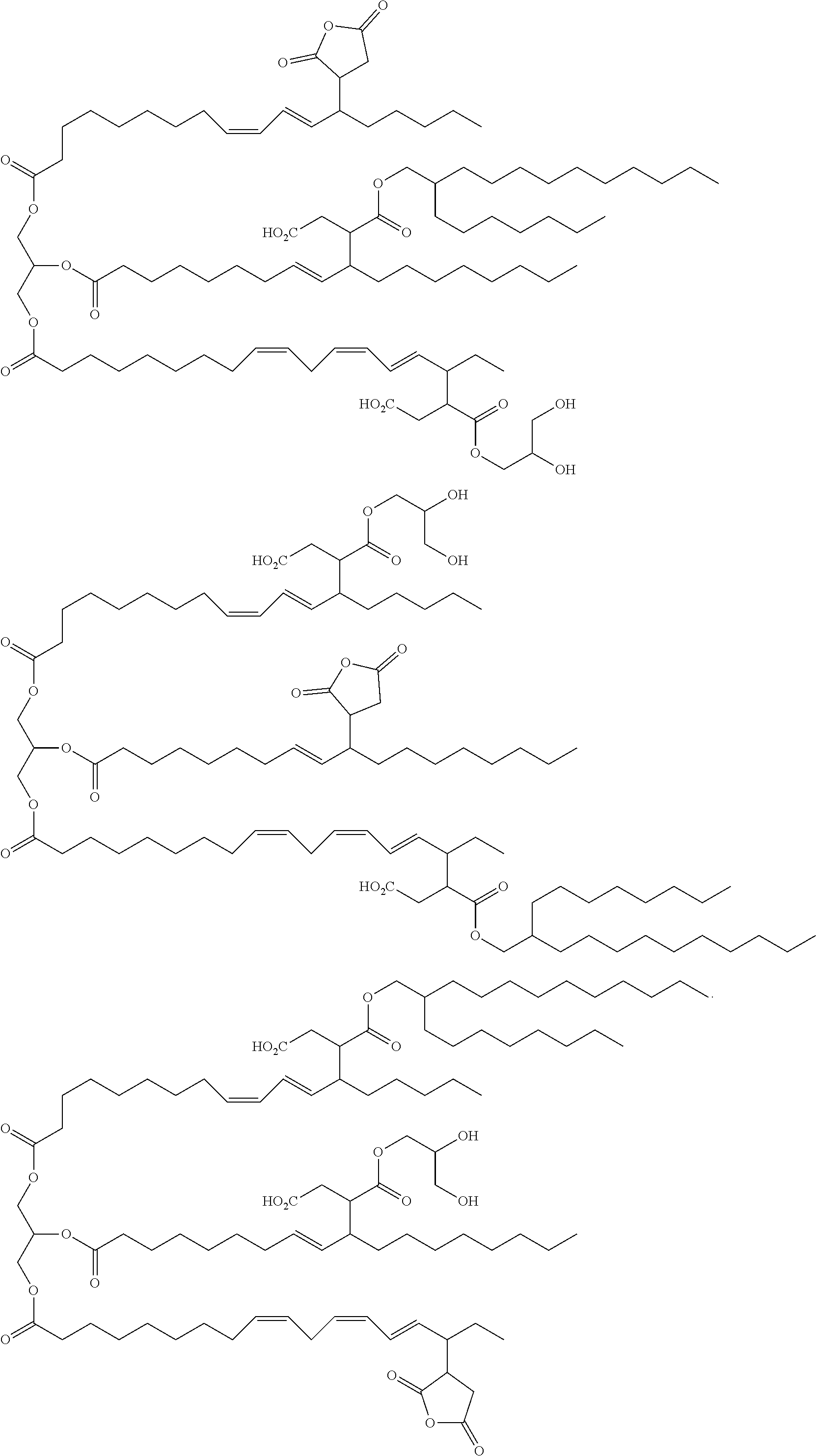

In one non-limiting embodiment, the hydrophobic moiety and the hydrophilic moiety is a hydrocarbyl alcohol, a hydrocarbyl amine, a silicon-based compound, or a combination thereof.

Hydrocarbyl alcohols are classified as primary, secondary and tertiary alcohols, based on the number of carbon atoms connected to the carbon atom that bears the hydroxyl group. Each classification of alcohol may have a general formula. For example,
the general formula for primary alcohols is

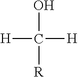

the general formula for secondary alcohols is

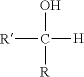

and
the general formula for tertiary alcohols is

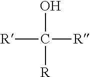

wherein R, R′ and R″ stand for hydrogen, different alkyl, alkylene, aryl, aralkyl, arylene, heteroatom groups.

The present invention provides compositions comprising a reaction product of (a) a maleated natural oil, comprising a natural oil with maleated functionality; and (b) a functionalized or unfunctionalized moiety selected from the group consisting of hydrophobic moieties, hydrophilic moieties, and combinations thereof; with the proviso that the hydrophilic moiety is not a glycerol moiety. Preferably, the reaction product comprises an unreacted maleated functionality or a maleated functionality functionalized with a hydrophobic moiety, a hydrophilic moiety, or combinations thereof.

Preferably, the hydrophobic moiety is a moiety selected from the group consisting of unsubstituted or substituted alkyl, cycloalkyl, alkenyl, and aryl alcohols, wherein any of the beforehand mentioned groups may be with or without heteroatoms, containing from about C₆ to about C₃₆ atoms, unsubstituted or substituted alkyl, cycloalkyl, alkenyl, and aryl amines, wherein any of the beforehand mentioned groups may be with or without heteroatoms, containing from about C₆ to about C₃₆ atoms, silicon-based compounds, and combinations thereof.

Preferably, the hydrophilic moiety is a moiety selected from the group consisting of unsubstituted or substituted alkyl, cycloalkyl, alkenyl, and aryl alcohols, wherein any of the beforehand mentioned groups may be with or without heteroatoms, containing from about C₁ to about C₅ atoms, unsubstituted or substituted alkyl, cycloalkyl, alkenyl, and aryl amines, wherein any of the beforehand mentioned groups may be with or without heteroatoms, containing from about C₁ to about C₅ atoms, unsubstituted or substituted polyols, wherein any of the beforehand mentioned groups may be with or without heteroatoms, containing from about C₂ to about C₃₆ atoms, silanes, and combinations thereof.

Preferably, the silane is functionalized with an alcohol or an amine, and combinations thereof. More preferably, the hydrophobic alcohol is selected from the group consisting of heptanol, nonanol, decanol, dodecanol, phenol, ethylbenzyl alcohol, 2-ethyl-1-hexanol, 1-octanol, 2-octanol, 2-octyl-1-dodecyl alcohol, 2-tertradecanol, 2-hexadecanol, 3,7-dimethyl-1-octanol, 2-propyl-1-pentanol, 4-methyl-1-pentanol, and mixtures thereof. More preferably, the hydrophilic alcohol is selected from the group consisting of methanol, ethanol, propanol, isopropanol, butanol, ethylene glycol, propylene glycol, diethylene glycol, dipropylene glycol, dibutylene glycol, polyethylene glycol, methoxypolyethylene glycol, polypropylene glycol, hexylene glycol, sorbitol, neopentylglycol, eythritol, mannitol, xylitol, threitol, pentaerythritol, beta-cyclodextrin, L-Ribose, 2-deoxy-D-galactose, and mixtures thereof.

Preferably, the hydrophobic amine is selected from the group consisting of benzylamine, cyclohexylamine, hexylamine, methylhexylamine, phenethylamine, octylamine, oleylamine, decylamine, dodecylamine, octadecylamine, undecyl amine, pentadecyl amine, 2-methyl butyl amine, dimethyl amine, and mixtures thereof. Preferably, the hydrophilic amine is selected from the group consisting of 2-methylpentane-1,5-diamine, diethanol amine, diisopropanolamine, serinol hydrochloride, 2-amino-2-ethyl-1,3-propanediol, N-methyl-D-glucosamine, D-galactosamine hydrochloride, D-glucosamine hydrochloride, D-mannosamine hydrochloride, and mixtures thereof.

Preferably, the silicon-based compound is a hydrophobic compound selected from the group consisting of aminopropylmethylsiloxane-dimethylsiloxane, N-ethylaminoisobutyl terminated polydimethylsiloxane, poly(1,1-dimethylsilazane) telomer, aminopropyl terminated polydimethylsiloxane, monoaminopropyl terminated polydimethylsiloxane, (tetramethylpiperidinyloxy)propylmethylsiloxane]-dimethylsiloxane copolymer, polydimethylsiloxane, carbinol (hydroxyl) terminated polydimethylsiloxane, monocarbinol terminated polydimethylsiloxane, monocarbinol terminated functional polydimethylsiloxane, [Bis(hydroxyethyl)amine] terminated polydimethylsiloxane, silanol terminated polydimethylsiloxane, silanol terminated polydiphenylsiloxane, dodecylmethylsiloxane-hydroxypolyalkyleneoxypropyl methylsiloxane, and mixtures thereof. Preferably, the silane is a hydrophilic compound selected from the group consisting of 3-aminopropylsilanetriol, N-(2-aminoethyl)-3-aminopropylsilanetriol, and mixtures thereof.

Preferably, the maleated natural oil is selected from the group consisting of maleated avocado oils, maleated coconut oils, maleated corn oils, maleated cottonseed oils, maleated jojoba oils, maleated linseed oils, maleated nut oils, maleated olive oils, maleated palm oils, maleated raisin oils, maleated rapeseed oils, maleated safflower oils, maleated sesame oils, maleated soybean oils, maleated squash oils, maleated sunflower oils, maleated almond oils, maleated canola oils, maleated flaxseed oils, maleated grapeseed oils, maleated palm oils, maleated palm kernel oils, maleated peanut oils, maleated walnut oils, maleated chickpea oils and mixtures thereof. More preferably, the maleated natural oil is a maleated soybean oil.

Preferably, the composition is selected from the group consisting of skin care compositions, oral care compositions, hair care compositions, energy compositions, construction compositions, biocidal compositions, preservative compositions, nutraceutical compositions, food compositions, agricultural compositions, coating compositions, cosmetic compositions, homecare compositions, industrial and institutional compositions, textile compositions, laundry compositions, cleaning compositions, and disinfecting compositions.

In another aspect, the present invention provides a composition comprising a reaction product of (a) a maleated natural oil, comprising a natural oil with maleated functionality; (b) a functionalized or unfunctionalized hydrophobic moiety; and (c) a glycerol moiety. Preferably, the reaction product comprises an unreacted maleated functionality or a maleated functionality functionalized with a hydrophobic moiety, a hydrophilic moiety, or combinations thereof.

Preferably, the hydrophobic moiety is a moiety selected from the group consisting of unsubstituted or substituted alkyl, cycloalkyl, alkenyl, and aryl alcohols, wherein any of the beforehand mentioned groups may be with or without heteroatoms, containing from about C₆ to about C₃₆ atoms, unsubstituted or substituted alkyl, cycloalkyl, alkenyl, and aryl amines, wherein any of the beforehand mentioned groups may be with or without heteroatoms, containing from about C₆ to about C₃₆ atoms, silicon-based compounds, and combinations thereof. Preferably, the hydrophobic moiety is an alcohol selected from the group consisting of heptanol, nonanol, decanol, dodecanol, phenol, ethylbenzyl alcohol, 2-ethyl-1-hexanol, 1-octanol, 2-octanol, 2-octyl-1-dodecyl alcohol, 2-tertradecanol, 2-hexadecanol, 3,7-dimethyl-1-octanol, 2-propyl-1-pentanol, 4-methyl-1-pentanol, and mixtures thereof. Preferably, the hydrophobic moiety is an amine selected from the group consisting of benzylamine, cyclohexylamine, hexylamine, methylhexylamine, phenethylamine, octylamine, oleylamine, decylamine, dodecylamine, octadecylamine, undecyl amine, pentadecyl amine, 2-methyl butyl amine, dimethyl amine, and mixtures thereof.

Preferably, the silicon-based compound is a hydrophobic compound selected from the group consisting of aminopropylmethylsiloxane-dimethylsiloxane, N-ethylaminoisobutyl terminated polydimethylsiloxane, poly(1,1-dimethylsilazane) telomer, aminopropyl terminated polydimethylsiloxane, monoaminopropyl terminated polydimethylsiloxane, (tetramethylpiperidinyloxy)propylmethylsiloxane]-dimethylsiloxane copolymer, polydimethylsiloxane, carbinol (hydroxyl) terminated polydimethylsiloxane, monocarbinol terminated polydimethylsiloxane, monocarbinol terminated functional polydimethylsiloxane, [Bis(hydroxyethyl)amine] terminated polydimethylsiloxane, silanol terminated polydimethylsiloxane, silanol terminated polydiphenylsiloxane, dodecylmethylsiloxane-hydroxypolyalkyleneoxypropyl methylsiloxane, and mixtures thereof.

Preferably, the maleated natural oil is selected from the group consisting of maleated avocado oils, maleated coconut oils, maleated corn oils, maleated cottonseed oils, maleated jojoba oils, maleated linseed oils, maleated nut oils, maleated olive oils, maleated palm oils, maleated raisin oils, maleated rapeseed oils, maleated safflower oils, maleated sesame oils, maleated soybean oils, maleated squash oils, maleated sunflower oils, maleated almond oils, maleated canola oils, maleated flaxseed oils, maleated grapeseed oils, maleated palm oils, maleated palm kernel oils, maleated peanut oils, maleated walnut oils, maleated chickpea oils and mixtures thereof. More preferably, the maleated natural oil is a maleated soybean oil.

Preferably, the composition is selected from the group consisting of skin care compositions, oral care compositions, hair care compositions, energy compositions, construction compositions, biocidal compositions, preservative compositions, nutraceutical compositions, food compositions, agricultural compositions, coating compositions, cosmetic compositions, homecare compositions, industrial and institutional compositions, textile compositions, laundry compositions, cleaning compositions, and disinfecting compositions.

A preferred composition comprises compounds selected from the group of structures represented by the structures set out below:

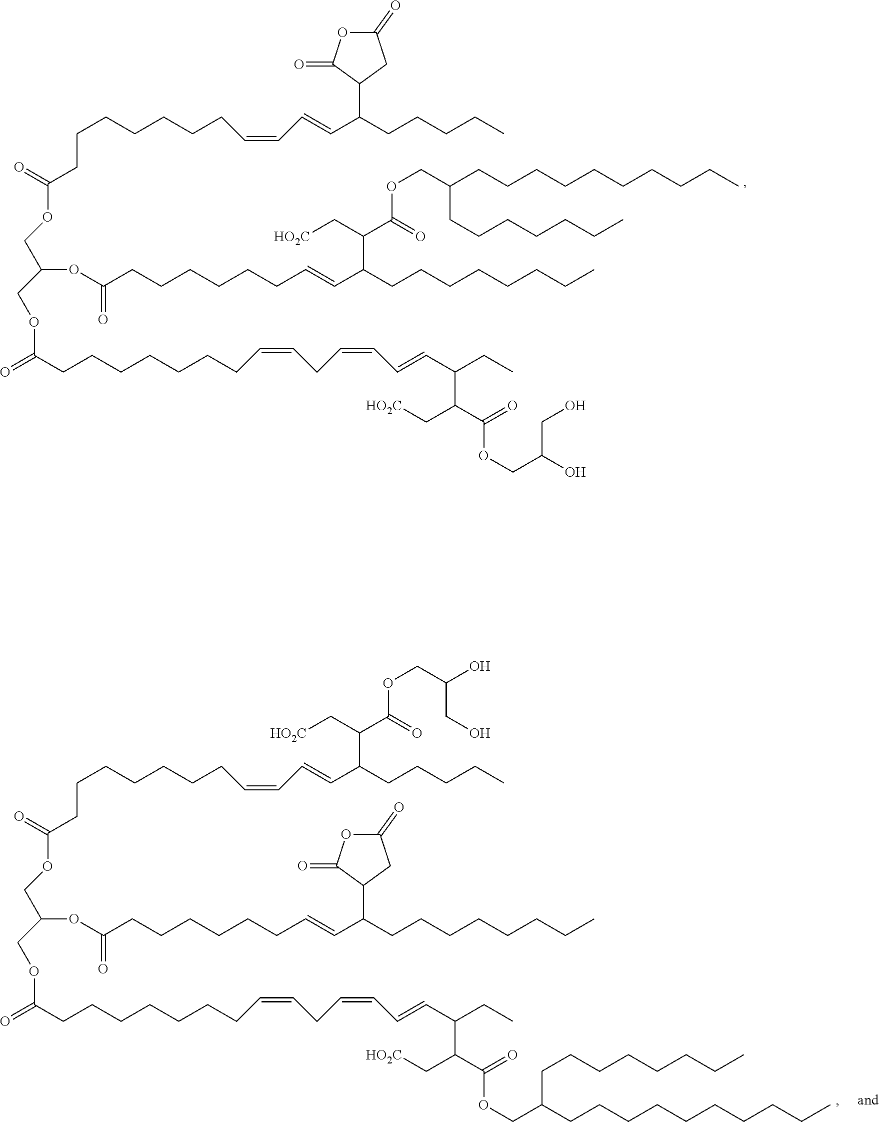 [SMILES: CCCCCCCCCCC(CCCCCCC)COC(=O)C(CC(=O)O)C(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C(CC(=O)O)C(=O)OCC(O)CO)CCCCCCCC ; CCCCCCCCCCC(CCCCCCCC)COC(=O)C(CC(=O)O)C(/C=C/C=C\C/C=C\CCCCCCCC(=O)OCC(COC(=O)CCCCCCC/C=C\C=C\C(CCCCC)C(CC(=O)O)C(=O)OCC(O)CO)OC(=O)CCCCCC/C=C/C(CCCCCCCC)C1CC(=O)OC1=O)CC]

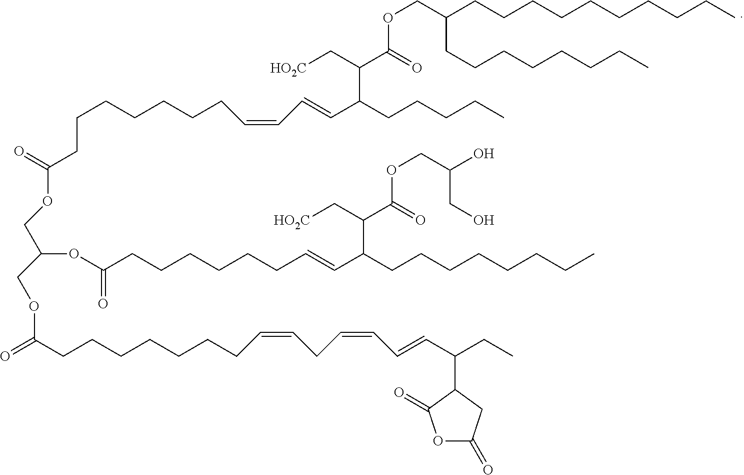 [SMILES: CCCCCCCCCCC(CCCCCCCC)COC(=O)C(CC(=O)O)C(/C=C/C=C\CCCCCCCC(=O)OCC(COC(=O)CCCCCCC/C=C\C/C=C\C=C\C(CC)C1CC(=O)OC1=O)OC(=O)CCCCCC/C=C/C(CCCCCCCC)C(CC(=O)O)C(=O)OCC(O)CO)CCCCC]

A preferred compound may be selected from the group of structures represented by the structures set out below:

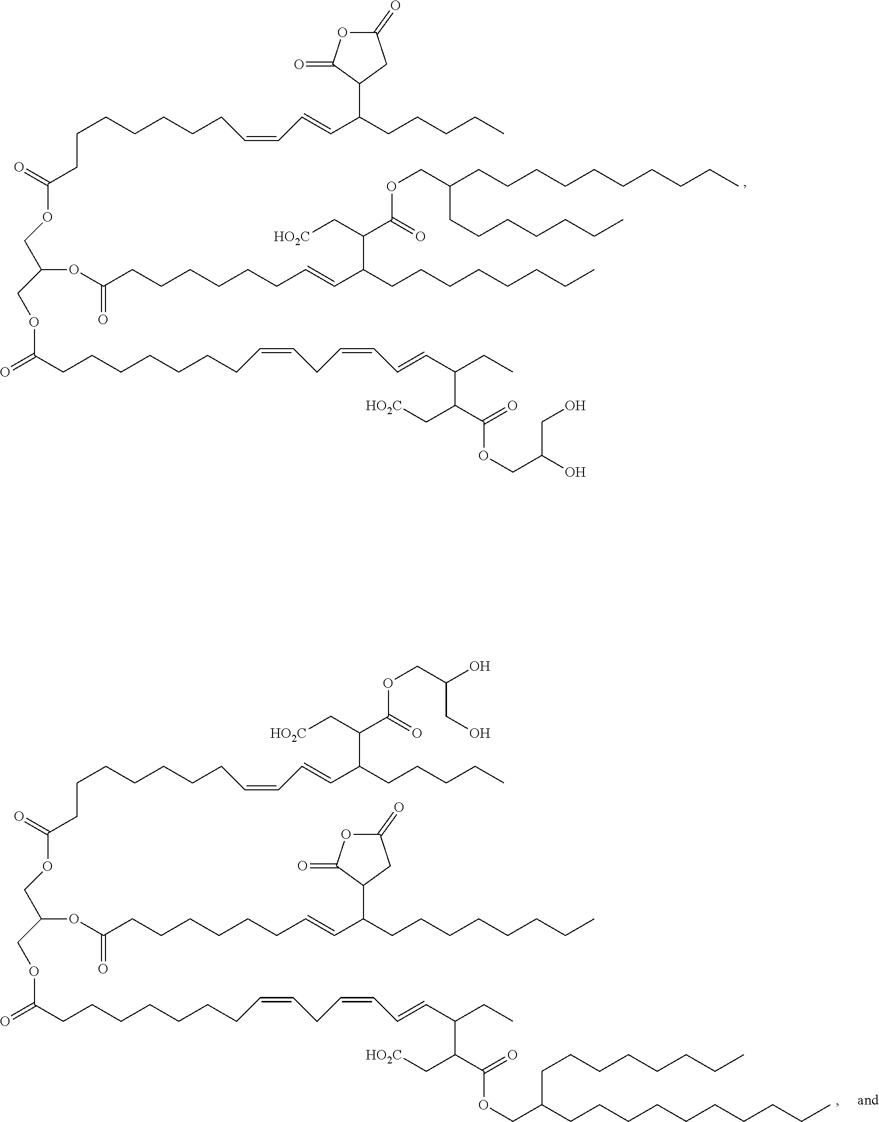 [SMILES: CCCCCCCCCCC(CCCCCCC)COC(=O)C(CC(=O)O)C(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C(CC(=O)O)C(=O)OCC(O)CO)CCCCCCCC ; CCCCCCCCCCC(CCCCCCCC)COC(=O)C(CC(=O)O)C(/C=C/C=C\C/C=C\CCCCCCCC(=O)OCC(COC(=O)CCCCCCC/C=C\C=C\C(CCCCC)C(CC(=O)O)C(=O)OCC(O)CO)OC(=O)CCCCCC/C=C/C(CCCCCCCC)C1CC(=O)OC1=O)CC]

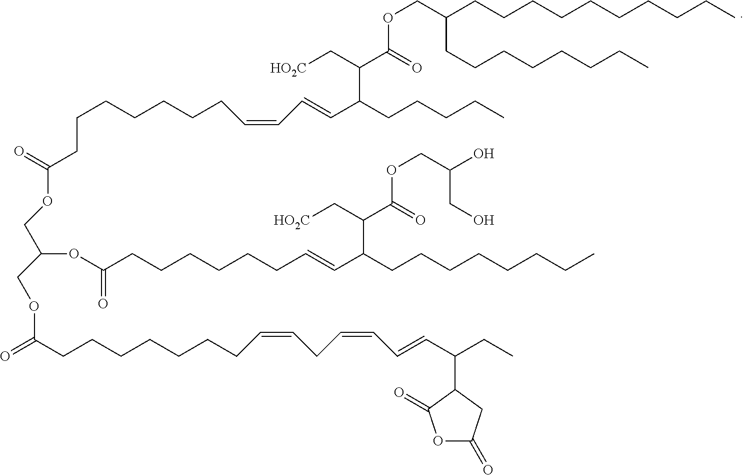 [SMILES: CCCCCCCCCCC(CCCCCCCC)COC(=O)C(CC(=O)O)C(/C=C/C=C\CCCCCCCC(=O)OCC(COC(=O)CCCCCCC/C=C\C/C=C\C=C\C(CC)C1CC(=O)OC1=O)OC(=O)CCCCCC/C=C/C(CCCCCCCC)C(CC(=O)O)C(=O)OCC(O)CO)CCCCC]

In yet another aspect, the invention provides a composition comprising: (A) a reaction product of: (a) a maleated natural oil, comprising a natural oil with maleated functionality; and (b) a functionalized or unfunctionalized moiety selected from the group consisting of hydrophobic moieties, hydrophilic moieties, and combinations thereof; with the proviso that the hydrophilic moiety is not a glycerol moiety, and (B) (a) a functional system active ingredient.

The preferences listed for the invention set out above for a “composition comprising a reaction product of (a) a maleated natural oil, comprising a natural oil with maleated functionality; and (b) a functionalized or unfunctionalized moiety selected from the group consisting of hydrophobic moieties, hydrophilic moieties, and combinations thereof; with the proviso that the hydrophilic moiety is not a glycerol moiety” also apply to this aspect of the invention.

The compositions may be selected from the group consisting of skin care compositions, oral care compositions, hair care compositions, energy compositions, construction compositions, biocidal compositions, preservative compositions, nutraceutical compositions, food compositions, agricultural compositions, coating compositions, cosmetic compositions, homecare compositions, industrial and institutional compositions, textile compositions, laundry compositions, cleaning compositions, and disinfecting compositions.

In yet another aspect, the invention provides a composition comprising: (A) a reaction product of (a) a maleated natural oil, comprising a natural oil with maleated functionality; (b) a functionalized or unfunctionalized hydrophobic moiety; (c) a glycerol moiety; and (B) a functional system active ingredient.

The preferences listed for the invention set out above for a “composition comprising: (A) a reaction product of (a) a maleated natural oil, comprising a natural oil with maleated functionality; (b) a functionalized or unfunctionalized hydrophobic moiety; (c) a glycerol moiety; and (B) a functional system active ingredient” also apply to this aspect of the invention.

The compositions may be selected from the group consisting of skin care compositions, oral care compositions, hair care compositions, energy compositions, construction compositions, biocidal compositions, preservative compositions, nutraceutical compositions, food compositions, agricultural compositions, coating compositions, cosmetic compositions, homecare compositions, industrial and institutional compositions, textile compositions, laundry compositions, cleaning compositions, and disinfecting compositions.

A preferred composition comprises compounds selected from the group of structures represented by the structures set out below:

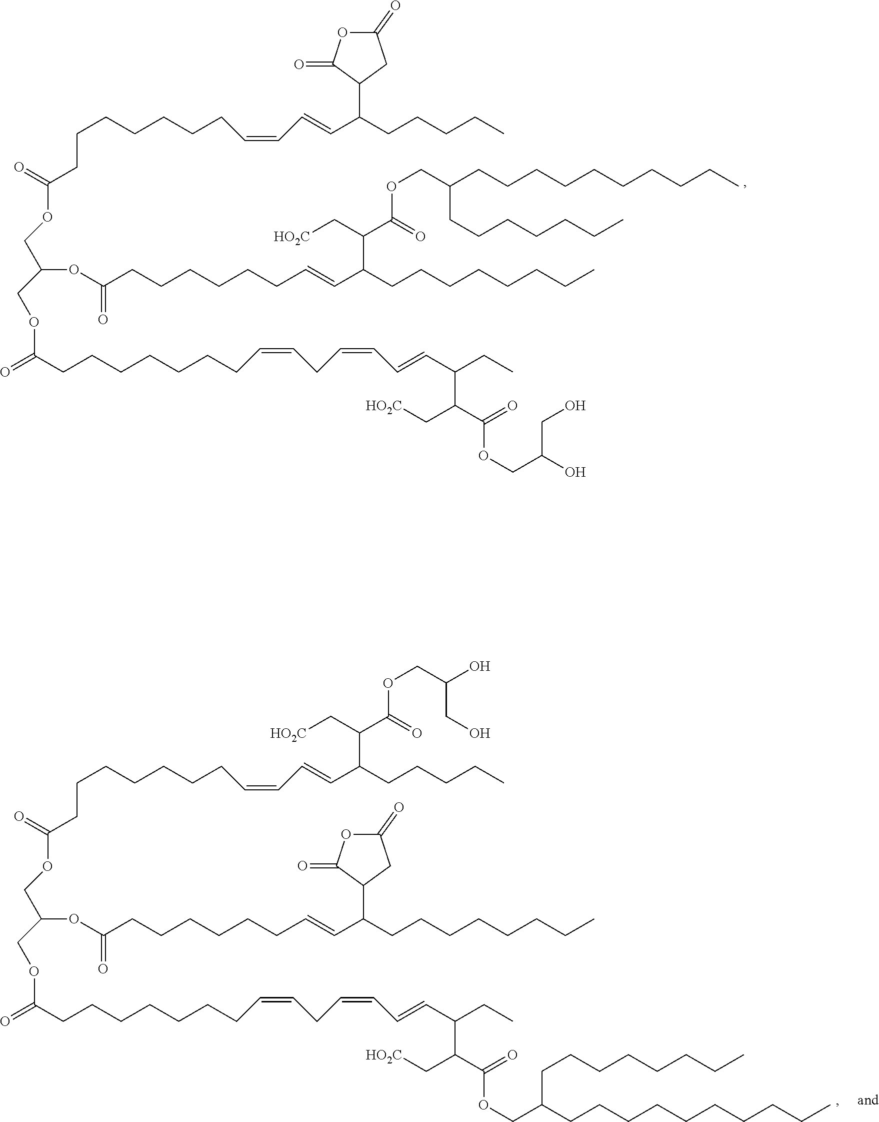 [SMILES: CCCCCCCCCCC(CCCCCCC)COC(=O)C(CC(=O)O)C(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C(CC(=O)O)C(=O)OCC(O)CO)CCCCCCCC ; CCCCCCCCCCC(CCCCCCCC)COC(=O)C(CC(=O)O)C(/C=C/C=C\C/C=C\CCCCCCCC(=O)OCC(COC(=O)CCCCCCC/C=C\C=C\C(CCCCC)C(CC(=O)O)C(=O)OCC(O)CO)OC(=O)CCCCCC/C=C/C(CCCCCCCC)C1CC(=O)OC1=O)CC]

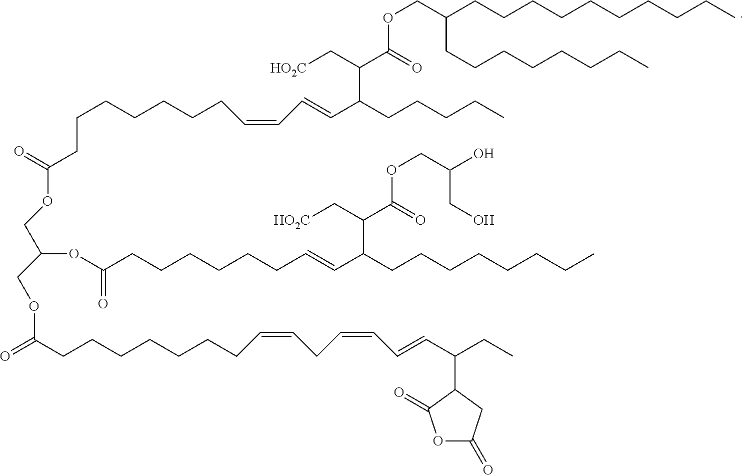 [SMILES: CCCCCCCCCCC(CCCCCCCC)COC(=O)C(CC(=O)O)C(/C=C/C=C\CCCCCCCC(=O)OCC(COC(=O)CCCCCCC/C=C\C/C=C\C=C\C(CC)C1CC(=O)OC1=O)OC(=O)CCCCCC/C=C/C(CCCCCCCC)C(CC(=O)O)C(=O)OCC(O)CO)CCCCC]

In vet another aspect, the invention provides a personal care composition comprising: (A) a reaction product of: (a) a maleated natural oil, comprising a natural oil with maleated functionality; and (b) a functionalized or unfunctionalized moiety selected from the group consisting of hydrophobic moieties, hydrophilic moieties, and combinations thereof; with the proviso that the hydrophilic moiety is not a glycerol moiety; and (B) (a) a personal care functional system active ingredient.

The preferences listed for the invention set out above for a “composition comprising a reaction product of (a) a maleated natural oil, comprising a natural oil with maleated functionality; and (b) a functionalized or unfunctionalized moiety selected from the group consisting of hydrophobic moieties, hydrophilic moieties, and combinations thereof; with the proviso that the hydrophilic moiety is not a glycerol moiety” also apply to this aspect of the invention.

The composition may be present in an amount of from about 0.01% to about 10% and (B) is present in an amount of from about 90% to about 99.99%.

The personal care functional system active ingredient may be selected from the group consisting of color agents, hair care agents, skin care agents, and sun care agents.

In yet another aspect, the invention provides a personal care composition comprising: (A) a reaction product of (a) a maleated natural oil, comprising a natural oil with maleated functionality; (b) a functionalized or unfunctionalized hydrophobic moiety; and (c). a glycerol moiety; and (B) a personal care functional system active ingredient.

The preferences listed for the invention set out above for a “composition comprising: (A) a reaction product of (a) a maleated natural oil, comprising a natural oil with maleated functionality; (b) a functionalized or unfunctionalized hydrophobic moiety; (c) a glycerol moiety; and (B) a functional system active ingredient” also apply to this aspect of the invention.

The composition may be present in an amount of (A) in an amount of from about 0.01% to about 10% and (B) is present in an amount of from about 90% to about 99.99%.

The personal care functional system active ingredient may be selected from the group consisting of color agents, hair care agents, skin care agents, and sun care agents.

The personal care composition may be a formulation selected from the group consisting of sprays, lotions, mousses, fluids, serums, solutions, suspensions, perms, emulsions, gels, mists, vesicles, dispersions, pastes, creams, solid sticks, shampoos, balms, wipes, milks, foams, jellies and liquids.

In yet another aspect, the invention provides a skin care composition comprising: (A) a reaction product of: (a) a maleated natural oil, comprising a natural oil with maleated functionality; and (b) a functionalized or unfunctionalized moiety selected from the group consisting of hydrophobic moieties, hydrophilic moieties, and combinations thereof; with the proviso that the hydrophilic moiety is not a glycerol moiety; and (B) (a) a skin care functional system active ingredient.

The preferences listed for the invention set out above for a “composition comprising: (A) a reaction product of (a) a maleated natural oil, comprising a natural oil with maleated functionality; (b) a functionalized or unfunctionalized hydrophobic moiety; (c) a glycerol moiety; and (B) a functional system active ingredient” also apply to this aspect of the invention.

The composition may be present in an amount of (A) in an amount of from about 0.01% to about 10% and (B) is present in an amount of from about 90% to about 99.99%.

The skin care functional system active ingredient may be selected from the group consisting of color agents, hair care agents, skin care agents, and sun care agents.

In yet another aspect, the invention provides a skin care composition comprising: (A) a reaction product of (a) a maleated natural oil, comprising a natural oil with maleated functionality; (b) a functionalized or unfunctionalized hydrophobic moiety; and (c) a glycerol moiety; and (B) a skin care functional system active ingredient.

The preferences listed for the invention set out above for a “composition comprising: (A) a reaction product of (a) a maleated natural oil, comprising a natural oil with maleated functionality; (b) a functionalized or unfunctionalized hydrophobic moiety; (c) a glycerol moiety; and (B) a functional system active ingredient” also apply to this aspect of the invention.

The composition may be present in an amount of (A) in an amount of from about 0.01% to about 10% and (B) is present in an amount of from about 90% to about 99.99%.

Preferably, the skin care functional system active ingredient is selected from the group consisting of color agents, hair care agents, skin care agents, and sun care agents.

Preferably, the skin care functional system active ingredient is a formulation selected from the group consisting of sprays, lotions, mousses, fluids, serums, solutions, suspensions, perms, emulsions, gels, mists, vesicles, dispersions, pastes, creams, solid sticks, shampoos, balms, wipes, milks, foams, jellies and liquids.

In yet another aspect, the present application provides compositions comprising a reaction product of
(a) a maleated natural oil, comprising a natural oil with maleated functionality;
(b) two functionalized or unfunctionalized hydrophilic moieties.

In yet another aspect, the present application provides compositions comprising:
(A) a reaction product of
(a) a maleated natural oil, comprising a natural oil with maleated functionality;
(b) two functionalized or unfunctionalized hydrophilic moieties; and
(B) a functional system active ingredient.

In one non-limiting embodiment, the hydrophobic moiety hydrocarbyl alcohol contains C₂ to C₃₆ carbon atoms and is linear, branched, saturated, unsaturated, aliphatic, aromatic, monofunctional or multifunctional.

In one non-limiting embodiment, the hydrocarbyl alcohol is selected from the group consisting of monohydric alcohols, dihydric alcohols, polyhydric alcohols and combinations thereof.

In one non-limiting embodiment, the hydrocarbyl amine is selected from the group consisting of primary amines, secondary amines and combinations thereof.

Hydrocarbyl amines are classified as primary, secondary and tertiary alcohols, based on the number of carbon atoms connected to the carbon atom that bears the hydroxyl group. Each classification of alcohol may have a general formula. For example,
the general formula for primary amine is

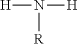

and
the general formula for secondary amine is

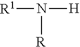

wherein R, R′ stand for hydrogen, different alkyl, alkylene, aryl, aralkyl, arylene, heteroatom groups.

In one non-limiting embodiment, the hydrophobic moiety hydrocarbyl amine contains C₂ to C₃₆ carbon atoms and is linear, branched, saturated, unsaturated, aliphatic, aromatic, monofunctional or multifunctional.

In one non-limiting embodiment, the silicon-base compound is a

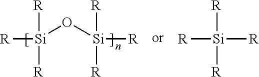

wherein R stands for different alkyl, alkylene, aryl, aralkyl, arylene, hetero groups functionalized with at least one or more alcohol, an amine or a combination thereof and n has the value of 1 to 10.

In one non-limiting embodiment, the silicon-base compound is a siloxane, or a silane functionalized with an alcohol, an amine or a combination thereof.

In one non-limiting embodiment, the silicon-based compound is a linear, branched, saturated, unsaturated, aliphatic, aromatic, monofunctional or multifunctional compound.

In one non-limiting embodiment, the hydrocarbyl alcohol is selected from the group consisting of monohydric alcohols, dihydric alcohols, polyhydric alcohols and combinations thereof.

In one non-limiting embodiment, the hydrocarbyl alcohol is a hydrophobic alcohol selected from the group consisting of propanol, butanol, pentanol, heptanol, nonanol, decanol, dodecanol, phenol, ethylbenzyl alcohol, 2-ethyl-1-hexanol, 1-octanol, 2-octanol, 2-octyl-1-dodecyl alcohol, 2-tertradecanol, 2-hexadecanol, 3,7-dimethyl-1-octanol, 2-propyl-1-pentanol, 4-methyl-1-pentanol and mixtures thereof.

In one non-limiting embodiment, the hydrocarbyl alcohol is a hydrophilic alcohol selected from the group consisting of methanol, ethanol, propanol, isopropanol, butanol, ethylene glycol, propylene glycol, diethylene glycol, dipropylene glycol, dibutylene glycol, polyethylene glycol, methoxypolyethylene glycol, polypropylene glycol, hexylene glycol, glycerol, sorbitol, octanol, methyl ethyl pentanol, trimethyl pentanol, ethyl hexanol, methyl heptanol, nonanol, methyl octanol, ethyl heptanol, methyl ethyl hexanol, cyclohexanol, dimethyl heptanol, decanol, methyl nonanol, ethyl octanol, trimethyl heptanol, undecanol, methyl decanol, ethyl nonanol, dodecanol, tetradecanol, hexadecanol, octadecanol, benzyl alcohol, phenoxyethanol, neopentylglycol, trimethylol propane, methyldiethanol amine, erythritol, mannitol, xylitol, pentaerythritol, threitol, pentaerythritol, beta-cyclodextrin, L-Ribose, 2-deoxy-D-galactose and mixtures thereof.

In one non-limiting embodiment, the hydrocarbyl amine is hydrophobic amine selected from the group consisting of benzylamine, cyclohexylamine, hexylamine, methylhexylamine, phenethylamine, octylamine, oleylamine, decylamine, dodecylamine, octadecylamine, undecyl amine, pentadecyl amine, 2-methyl butyl amine, dimethyl amine and mixtures thereof.

In one non-limiting embodiment, the hydrocarbyl amine is hydrophilic amine selected from the group consisting of 2-methylpentane-1,5-diamine, diethanol amine, diisopropanolamine, serinol hydrochloride, 2-amino-2-ethyl-1,3-propanediol, N-methyl-D-glucosamine, D-galactosamine hydrochloride, D-glucosamine hydrochloride, D-mannosamine hydrochloride and mixtures thereof.

In one non-limiting embodiment, the silicon-based compound is a hydrophobic compound selected from the group consisting of aminopropylmethylsiloxane-dimethylsiloxane, N-ethylaminoisobutyl terminated polydimethylsiloxane, poly(1,1-dimethylsilazane) telomer, aminopropyl terminated polydimethylsiloxane, monoaminopropyl terminated polydimethylsiloxane, (tetramethylpiperidinyloxy)propylmethylsiloxane]-dimethylsiloxane copolymer, polydimethylsiloxane, carbinol (hydroxyl) terminated polydimethylsiloxane, monocarbinol terminated polydimethylsiloxane, monocarbinol terminated functional polydimethylsiloxane, [Bis(hydroxyethyl)amine] terminated polydimethylsiloxane, silanol terminated polydimethylsiloxane, silanol terminated polydiphenylsiloxane, dodecylmethylsiloxane-hydroxypolyalkyleneoxypropyl methylsiloxane and mixtures thereof.

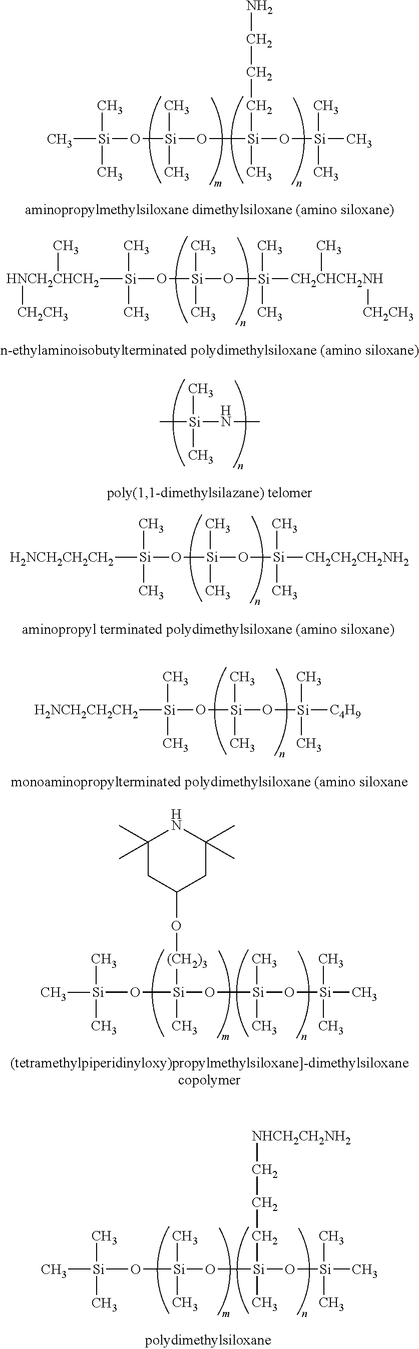

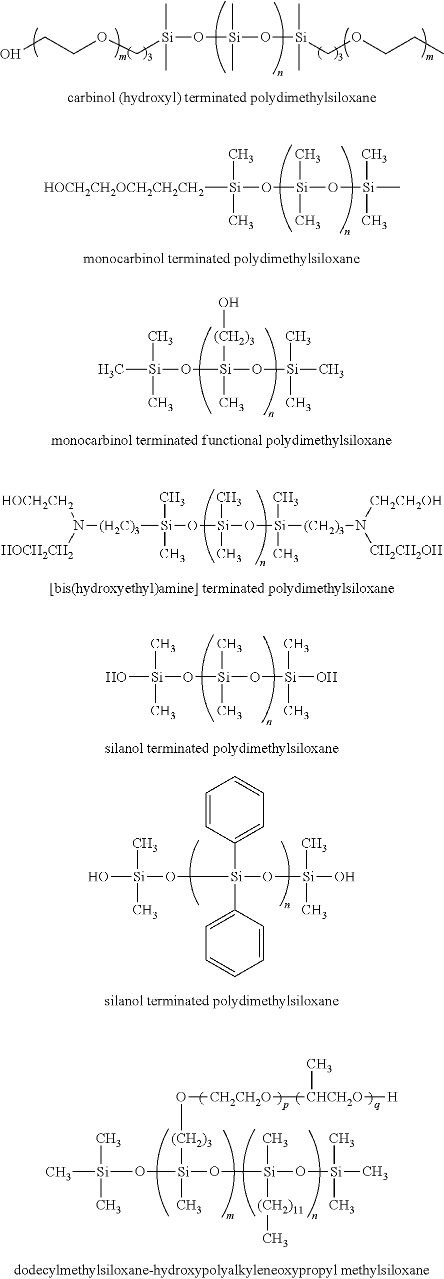

In one non-limiting embodiment, the silicon-based compound is hydrophilic compound selected from the group consisting of 3-aminopropylsilanetriol, N-(2-aminoethyl)-3-aminopropylsilanetriol and mixtures thereof.

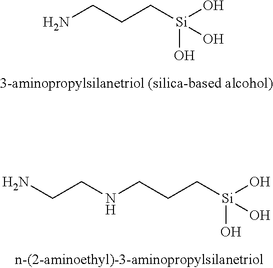 [SMILES: NCCC[Si](O)(O)O ; NCCNCCC[Si](O)(O)O]

In one non-limiting embodiment, the maleated natural oil is selected from the group consisting of a maleated avocado oil, a maleated coconut oil, a maleated corn oil, a maleated cottonseed oil, a maleated jojoba oil, a maleated linseed oil, a maleated nut oil, a maleated olive oil, a maleated palm oil, a maleated raisin oil, a maleated rapeseed oil, a maleated safflower oil, a maleated sesame oil, a maleated soybean oil, a maleated squash oil, a maleated sunflower oil, a maleated almond oil, a maleated canola oil, a maleated flaxseed oil, a maleated grapeseed oil, a maleated palm oil, a maleated palm kernel oil, a maleated peanut oil, and a maleated walnut oil thereof.

The reactions according to the application may be readily synthesized by procedures known by those skilled in the art, non-limiting examples of which include free radical solution polymerization, dispersion polymerization, emulsion polymerization, ionic chain polymerization, living polymerization, bulk polymerization, suspension polymerization or precipitation polymerization. Particularly, the polymerization is carried out by any one of the methods disclosed in “Principles of Polymerization” 4th edition, 2004, Wiley by George Odian and is referred and disclosed herein in its entirety and described in “Decomposition Rate of Organic Free Radical Polymerization” by K. W. Dixon (section II in Polymer Handbook, volume 1, 4th edition, Wiley-Interscience, 1999), which is herein incorporated in its entirety by reference.

The maleinization reaction in natural oil can occur under heating in three different ways. The first one is known as “Ene” reaction (reaction between an allylic hydrogen and an enophile-pericyclic reaction), obtaining a triglyceride structure with anhydride moieties (succinic anhydride). The second one is a radical addition, which consumes a double bond in the fatty acid, incorporating the succinic anhydride into the natural oil structure. The final reaction is also a radical addition that incorporates the maleic anhydride into the natural oil structure without consuming C═C bonds (fatty acid chain and maleic anhydride); this reaction occurs due to deprotonation of a hydrogen between two alkenes groups. Subsequently, the maleinized natural oil can be reacted with hydrophobic moiety and the hydrophilic moiety of a hydrocarbyl alcohol, a hydrocarbyl amine, a silicon-based compound forming a reticulated structure (see examples). This kind of reaction has been applied at the reaction occurred by heating 6-10 hours at 210° C.

Thus, the reaction of the non-limiting example above, for illustration purposes only, may be performed at elevated temperatures, such as a temperature between about 150° C. and about 300° C., alternatively between about 170° C. and about 230° C., or alternatively between about 200° C. and about 220° C. The reaction time may be between about 0.5 hours and about 10 hours. In one embodiment the reaction time is between about 1 hour and about 5 hours, and in another embodiment, between about 2 hours and 4 hours. and in another embodiment, between about 6 hours and 10 hours.

During maleation, the mole ratio of natural oil to maleic anhydride in some embodiments is equal to 1, in other embodiments from 1 to 2, in other embodiments from 1 to 2.8 and in still other embodiments from 1 to 3.2 moles of maleic anhydride for each mole of natural oil.

The mole ratio of reaction of maleated natural oil and a hydrophobic moiety, a hydrophilic moiety or a combination thereof mixtures is equal to 1:1 to form a reaction product comprising at least one unreacted maleated functionality.

In one non-limiting embodiment, the composition is a skin care composition, an oral care composition, a hair care composition, an energy composition, a construction composition, a biocidal composition, a preservative composition, a nutraceutical composition, a food composition, an agricultural composition, a coating composition, a cosmetic composition, a homecare composition, an industrial and institutional composition, a textile composition, a laundry composition, a cleaning composition or a disinfecting composition.

According to another embodiment of the present application, it is contemplated to employ at least one functional system active ingredient selected from the group consisting of skin care ingredients, hair care ingredients, oral care ingredients, home care ingredients, energy based ingredients, construction based ingredients, biocide based ingredients, preservative based ingredients, nutraceutical based ingredients, food based ingredients, agricultural based ingredients, coating based ingredients, cosmetic based ingredients, industrial and institutional based ingredients, textile based ingredients, laundry based ingredients, cleaning based ingredients or disinfection based ingredients.

According to another embodiment of the present application, it is contemplated to employ at least one personal care ingredient includes color cosmetic ingredients, hair care ingredients, skin care ingredients or sun care ingredients.

According to another embodiment of the present application, it is contemplated to employ at least one personal care functional system active ingredient selected from the group consisting of surfactants, water-insoluble ingredients, oxidizing agents, conditioning agents, humectants, pH adjusting buffers, waxes, mineral oils, emulsifiers, fatty substances, gelling agents, thickeners, emollients, hydrophilic or lipophilic active agent, antioxidants, sequestering agents, preserving agents, acidifying or basifying agents, fragrances, fillers, dyestuffs, plant extracts, moisturizers, proteins, peptides, neutralizing agents, solvents, anti-dandruff ingredients, reducing agents and combinations thereof.

In one embodiment of the present application, at least one primary surfactant, co-surfactant or a system of surfactants comprising at least one primary surfactant and at least one co-surfactant are employed to prepare sun care or skin care compositions, and wherein said primary surfactants, co-surfactants or a system surfactant can be selected from the group consisting of anionic surfactants, cationic surfactants, non-ionic surfactants, zwitterionic surfactants and amphoteric surfactants.

The range of surfactants can be from 0.1 wt. % to 20 wt. % based on the total weight of the composition. Other ranges of surfactants are from 0.1 wt. % to 5 wt. %, from 5 wt. % to 10 wt. %, from 10 wt. % to 15 wt. %, or from 15 wt. % to 20 wt. % of total weight of the composition. The contemplated surfactants for use herein are as follows:
(A) Anionic Surfactants: Anionic surfactants are particularly useful in accordance with certain embodiments of the present application. Surfactants of the anionic type that may be useful include:
(1) Sulfonates and Sulfates: Suitable anionic surfactants include sulfonates and sulfates such as alkyl sulfates, alkylether sulfates, alkyl sulfonates, alkylether sulfonates, alkylbenzene sulfonates, alkylbenzene ether sulfates, alkylsulfoacetates, secondary alkane sulfonates, secondary alkylsulfates, alkyl sulfosuccinates and the like. Further, examples of anionic surfactants include water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like.
(2) Phosphates and Phosponates: Suitable anionic surfactants also include phosphates such as alkyl phosphates, alkylether phosphates, aralkylphosphates, and aralkylether phosphates. Examples include a mixture of mono-, di- and tri-(alkyltetraglycolether)-o-phosphoric acid esters generally referred to as trilaureth-4-phosphate commercially available under the trade designation HOSTAPHAT 340KL from Clariant Corp., as well as PPG-5 ceteth 10 phosphate available under the trade designation CRODAPHOS SG from Croda Inc., Parsipanny, NJ.
(3) Amine Oxides: Suitable anionic surfactants also include amine oxides. Examples of amine oxide surfactants include lauryldimethylamine oxide, laurylamidopropyldimethylamine oxide, and/or cetyl amine oxide.
(B) Amphoteric Surfactants: Surfactants of the amphoteric type include surfactants having tertiary amine groups which may be protonated as well as quaternary amine containing zwitterionic surfactants. Those that may be useful include:
(1) Ammonium Carboxylate Amphoterics: Examples of such amphoteric surfactants include, but are not limited to: certain betaines such as cocobetaine and cocamidopropyl betaine; monoacetates such as sodium lauroamphoacetate; diacetates such as disodium lauroamphoacetate; amino- and alkylamino-propionates such as lauraminopropionic acid.
(2) Ammonium Sulfonate Amphoterics: These classes of amphoteric surfactants are often referred to as “sultaines” or “sulfobetaines” for example, cocamidopropylhydroxysultaine.
(C) Nonionic Surfactants: Surfactants of the nonionic type that may be particularly useful include:
(1) Polyethylene oxide extended sorbitan monoalkylates (i.e. Polysorbates); (2) Polyalkoxylated alkanols; (3) Polyalkoxylated alkylphenols include polyethoxylated octyl or nonyl phenols having HLB values of at least about 14, which are commercially available under the trade designations ICONOL and TRITON; (4) Polaxamers. Surfactants based on block copolymers of ethylene oxide (EO) and propylene oxide (PO) may also be effective. Both EO-PO-EO blocks and PO-EO-PO blocks are expected to work well as long as the HLB is at least about 14, and preferably at least about 16. Such surfactants are commercially available under the trade designations PLURONIC and TETRONIC from BASF; (5) Polyalkoxylated esters-Polyalkoxylated glycols such as ethylene glycol, propylene glycol, glycerol, and the like may be partially or completely esterified, i.e. one or more alcohols may be esterified, with a (C8 to C22) alkyl carboxylic acid. Such polyethoxylated esters having an HLB of at least about 14, and preferably at least about 16, may be suitable for use in compositions of the present invention; (6) Alkyl Polyglucosides—This includes glucopon 425, which has a (C8 to C16) alkyl chain length.
(D) Cationic Surfactants: Surfactants of the cationic type that may be useful include but are not limited to, primary amines, secondary amines, tertiary amines, quaternary amines, alkanolamines, mono-alkyl alkanolamines, di-alkyl alkanolamines, tri-alkyl alkanolamines, alkyl mono alkanolamines, alkyl di-alkanolamines, alkylamines, mono-alkyl amines, di-alkyl amines, tri-alkylamines, alkoxylated amines, alkyl and aryl amine alkoxylates, methoxylated alkylamines, ethoxylated alkylamines, alkoxylated alkanolamines, alkyl alkanolamines, alkoxylated ethylene diamine derivatives, alkyl/aryl/arylalkyl amine oxides. Preferred cationic surfactants of the present invention include, but are not limited to, (a) alkyl alkanolamines; and (b) alkyl tertiary amines.

Additional information on useful cationic surfactants for the purpose of present invention is set forth in Mccutcheon's Detergents and Emulsifiers, North American Ed., 1982 and Kirk-Othmer, Encyclopedia of Chemical Technology, 3rd Ed., Vol. 22, pp. 346-387, the contents of which are incorporated herein by reference.

Suitable emollients for use herein include, for example, optionally hydroxy-substituted C8-C50 unsaturated fatty acids and esters thereof, C1-C24 esters of C8-C30 saturated fatty acids such as isopropyl myristate, cetyl palmitate and octyldodecylmyristate (Wickenol 142), beeswax, saturated and unsaturated fatty alcohols such as behenyl alcohol and cetyl alcohol, hydrocarbons such as mineral oils, petrolatum, squalane, fatty sorbitan esters, lanolin and lanolin derivatives, such as lanolin alcohol ethoxylated, hydroxylated and acetylated lanolins, cholesterol and derivatives thereof, animal and vegetable triglycerides such as almond oil, peanut oil, wheat germ oil, linseed oil, jojoba oil, oil of apricot pits, walnuts, palm nuts, pistachio nuts, sesame seeds, rapeseed, cade oil, corn oil, peach pit oil, poppyseed oil, pine oil, castor oil, soybean oil, avocado oil, safflower oil, coconut oil, hazelnut oil, olive oil, grapeseed oil, and sunflower seed oil and C1-C24 esters of dimer and trimer acids such as diisopropyl dimerate, diisostearylmalate, diisostearyldimerate and triisostearyltrimerate.

Suitable emollients for use herein include isocetyl alcohol, octyl palmitate, isostearyl neopentanoate and isocetyl stearyl stearate, natural or synthetic oils selected from mineral, vegetable, and animal oils, fats and waxes, fatty acid esters, fatty alcohols, alkylene glycol and polyalkylene glycol ethers and esters, fatty acids and mixtures thereof.

Preferred emollients are selected from hydrocarbons such as isohexadecane, mineral oils, petrolatum, squalane, lanolin alcohol, and stearyl alcohol. These emollients may be used independently or in mixtures and may be present in the composition of the present invention in an amount from about 1% to about 30% by weight, and preferably are present in an amount from about 5% to about 15% by weight of the total composition.

Suitable emulsifiers include the following classes of ethers and esters: ethers of polyglycols and of fatty alcohols, esters of polyglycols and of fatty acids, ethers of polyglycols and of fatty alcohols which are glycosylated, esters of polyglycols and of fatty acids which are glycosylated, ethers of C12-30 alcohols and of glycerol or of polyglycerol, esters of C12-30 fatty acids and of glycerol or of polyglycerol, ethers of oxyalkylene-modified C12-30 alcohols and of glycerol or polyglycerol, ethers of C12-30 fatty alcohols comprising and of sucrose or of glucose, esters of sucrose and of C12-30 fatty acids, esters of pentaerythritol and of C12-30 fatty acids, esters of sorbitol and/or of sorbitan and of C12-30 fatty acids, ethers of sorbitol and/or of sorbitan and of alkoxylated sorbitan, ethers of polyglycols and of cholesterol, esters of C12-30 fatty acids and of alkoxylated ethers of sorbitol and/or sorbitan, and combinations thereof. Linear or branched type silicone emulsifiers may also be used. Particularly useful polyether modified silicones include KF-6011, KF-6012, KF-6013, KF-6015, KF-6015, KF-6017, KF-6043, KF-6028, and KF-6038 from Shin-Etsu. Also particularly useful are the polyglycerolated linear or branched siloxane emulsifiers including KF-6100, KF-6104, and KF-6105 from Shin-Etsu. Emulsifiers also include include glyceryl stearate and laureth 23, PEG 20 stearate, and mink-amidopropyl dimethyl 2-hydroxyethylammonium chloride and emulsifying silicone elastomers. Suitable emulsifying silicone elastomers may include at least one polyalkyl ether or polyglycerolated unit.

Moisturizers employed in the present application would include glycols, glycerols, propylene glycol, diethylene glycol monoethyl ether, sorbitol, sodium salt of pyroglutamic acid, glycerol, glycerol derivatives, glycerin, trehalose, sorbitol, maltitol, dipropylene glycol, 1,3-butylene glycol, sodium hyaluronate, and the like.

Examples of humectants which can be incorporated into a product of the present application are glycerine, propylene glycol, polypropylene glycol, polyethylene glycol, lactic acid, sodium lactate, pyrrolidone carboxylic acid, urea, phospholipids, collagen, elastin, ceramides, lecithin sorbitol, PEG-4, and mixtures thereof. Additional suitable moisturizers are polymeric moisturizers that belong to water soluble and/or water swellable in nature. Polysaccharides such as hyaluronic acid, chitosan can also be employed along with moisturizers of the present application as binder to enhance their property. The range of moisturizer is from about 0.1 wt. % to about 10 wt. %.

The compositions of the invention can also contain a hydrophilic gelling agent at a level from about 0.01% to about 10%, preferably from about 0.02% to about 2%, and especially from about 0.02% to about 0.5%. The gelling agent preferably has a viscosity (1% aqueous solution, 20° C., Brookfield RVT) of at least about 4000 mPa·s, more preferably at least about 10,000 mPa·s and especially at least 50,000 mPa·s.

Suitable hydrophilic gelling agents can generally be described as water-soluble or colloidally water-soluble polymers, and include cellulose ethers (e.g. hydroxyethyl cellulose, methyl cellulose, hydroxypropylmethyl cellulose), polyvinylalcohol, polyquaternium-10, guar gum, hydroxypropyl guar gum and xanthan gum.

Among suitable hydrophilic gelling agents are acrylic acid/ethyl acrylate copolymers and the carboxyvinyl polymers sold by the B.F. Goodrich Company under the trademark of Carbopol® resins. These resins consist essentially of a colloidally water-soluble polyalkenyl polyether crosslinked polymer of acrylic acid crosslinked with from 0.75% to 2.00% of a crosslinking agent such as polyallyl sucrose or polyally pentaerythritol. Examples include Carbopol 934, Carbopol 940, Carbopol 950, Carbopol 980, Carbopol 951 and Carbopol 981. Carbopol 934 is a water-soluble polymer of acrylic acid crosslinked with about 1% of a polyallyl ether of sucrose having an average of about 5.8 allyl groups for each sucrose molecule. Also suitable for use herein are hydrophobically-modified crosslinked polymers of acrylic acid having amphipathic properties available under the Trade Name Carbopol 1382, Carbopol 1342 and Pemulen TR-1 (CTFA Designation: Acrylates/10-30 Alkyl Acrylate Crosspolymer). A combination of the polyalkenyl polyether cross-linked acrylic acid polymer and the hydrophobically modified crosslinked acrylic acid polymer is also suitable for use herein. Other suitable gelling agents suitable for use herein are oleogels such as trihydroxystearin and aluminum magnesium hydroxy stearate.

Non-limiting examples of suitable thickeners and/or viscosifiers include: Acetamide MEA; acrylamide/ethalkonium chloride acrylate copolymer; acrylamide/ethyltrimonium chloride acrylate/ethalkonium chloride acrylate copolymer; acrylamides copolymer; acrylamide/sodium acrylate copolymer; acrylamide/sodium acryloyldimethyltaurate copolymer; acrylates/acetoacetoxyethyl methacrylate copolymer; acrylates/beheneth-25 methacrylate copolymer; acrylates/C10-C30 alkyl acrylate crosspolymer; acrylates/ceteth-20 itaconate copolymer; acrylates/ceteth-20 methacrylate copolymer; acrylates/laureth-25 methacrylate copolymer; acrylates/palmeth-25 acrylate copolymer; acrylates/palmeth-25 itaconate copolymer; acrylates/steareth-50 acrylate copolymer; acrylates/steareth-20 itaconate copolymer; acrylates/steareth-20 methacrylate copolymer; acrylates/stearyl methacrylate copolymer; acrylates/vinyl isodecanoate crosspolymer; acrylic acid/acrylonitrogens copolymer; adipic acid/methyl DEA crosspolymer; agar; agarose; alcaligenes polysaccharides; algin; alginic acid; almondamide DEA; almondamidopropyl betaine; aluminum/magnesium hydroxide stearate; ammonium acrylates/acrylonitrogens copolymer; ammonium acrylates copolymer; ammonium acryloyldimethyltaurate/vinyl formamide copolymer; ammonium acryloyldimethyltaurate/VP copolymer; ammonium alginate; ammonium chloride; ammonium polyacryloyldimethyl taurate; ammonium sulfate; amylopectin; apricotamide DEA; apricotamidopropyl betaine; arachidyl alcohol; arachidyl glycol; Arachis hypogaea (peanut) flour; ascorbyl methylsilanol pectinate; Astragalus gummifer gum; attapulgite; Avena sativa (oat) kernel flour; avocadamide DEA; avocadamidopropyl betaine; azelamide MEA; babassuamide DEA; babassuamide MEA; babassuamidopropyl betaine; behenamide DEA; behenamide MEA; behenamidopropyl betaine; behenyl betaine; bentonite; butoxy chitosan; caesalpinia spinosa gum; calcium alginate; calcium carboxymethyl cellulose; calcium carrageenan; calcium chloride; calcium potassium carbomer; calcium starch octenylsuccinate; C20-40 alkyl stearate; canolamidopropyl betaine; capramide DEA; capryl/capramidopropyl betaine; carbomer; carboxybutyl chitosan; carboxymethyl cellulose acetate butyrate; carboxymethyl chitin; carboxymethyl chitosan; carboxymethyl dextran; carboxymethyl hydroxyethylcellulose; carboxymethyl hydroxypropyl guar; carnitine; cellulose acetate propionate carboxylate; cellulose gum; ceratonia siliqua gum; cetearyl alcohol; cetyl alcohol; cetyl babassuate; cetyl betaine; cetyl glycol; cetyl hydroxyethylcellulose; chimyl alcohol; cholesterol/HDI/pullulan copolymer; cholesteryl hexyl dicarbamate pullulan; citrus aurantium dulcis (orange) peel extract; cocamide DEA; cocamide MEA; cocamide MIPA; cocamidoethyl betaine; cocamidopropyl betaine; cocamidopropyl hydroxysultaine; coco-betaine; coco-hydroxysultaine; coconut alcohol; coco/oleamidopropyl betaine; coco-Sultaine; cocoyl sarcosinamide DEA; cornamide/cocamide DEA; cornamide DEA; croscarmellose; cross-linked bacillus/glucose/sodium glutamate ferment; cyamopsis tetragonoloba (guar) gum; decyl alcohol; decyl betaine; dehydroxanthan gum; dextrin; dibenzylidene sorbitol; diethanolaminooleamide DEA; diglycol/CHDM/isophthalates/SIP copolymer; dihydroabietyl behenate; dihydrogenated tallow benzylmonium hectorite; dihydroxyaluminum aminoacetate; dimethicone/PEG-10 crosspolymer; dimethicone/PEG-15 crosspolymer; dimethicone propyl PG-betaine; dimethylacrylamide/acrylic acid/polystyrene ethyl methacrylate copolymer; dimethylacrylamide/sodium acryloyldimethyltaurate crosspolymer; disteareth-100 IPDI; DMAPA acrylates/acrylic acid/acrylonitrogens copolymer; erucamidopropyl hydroxysultaine; ethylene/sodium acrylate copolymer; gelatin; gellan gum; glyceryl alginate; glycine soja (soybean) flour; guar hydroxypropyltrimonium chloride; hectorite; hyaluronic acid; hydrated silica; hydrogenated potato starch; hydrogenated tallow; hydrogenated tallowamide DEA; hydrogenated tallow betaine; hydroxybutyl methylcellulose; hydroxyethyl acrylate/sodium acryloyldimethyl taurate copolymer; hydroxyethylcellulose; hydroxyethyl chitosan; hydroxyethyl ethylcellulose; hydroxyethyl stearamide-MIPA; hydroxylauryl/hydroxymyristyl betaine; hydroxypropylcellulose; hydroxypropyl chitosan; hydroxypropyl ethylenediamine carbomer; hydroxypropyl guar; hydroxypropyl methylcellulose; hydroxypropyl methylcellulose stearoxy ether; hydroxypropyl starch; hydroxypropyl starch phosphate; hydroxypropyl xanthan gum; hydroxystearamide MEA; isobutylene/sodium maleate copolymer; isostearamide DEA; isostearamide MEA; isostearamide mIPA; isostearamidopropyl betaine; lactamide MEA; lanolinamide DEA; lauramide DEA; lauramide MEA; lauramide MIPA; lauramide/myristamide DEA; lauramidopropyl betaine; lauramidopropyl hydroxysultaine; laurimino bispropanediol; lauryl alcohol; lauryl betaine; lauryl hydroxysultaine; lauryl/myristyl glycol hydroxypropyl ether; lauryl sultaine; lecithinamide DEA; linoleamide DEA; linoleamide MEA; linoleamide MIPA; lithium magnesium silicate; lithium magnesium sodium silicate; macrocystis pyrifera (kelp); magnesium alginate; magnesium/aluminum/hydroxide/carbonate; magnesium aluminum silicate; magnesium silicate; magnesium trisilicate; methoxy PEG-22/dodecyl glycol copolymer; methylcellulose; methyl ethylcellulose; methyl hydroxyethylcellulose; microcrystalline cellulose; milkamidopropyl betaine; minkamide DEA; minkamidopropyl betaine; MIPA-myristate; montmorillonite; Moroccan lava clay; myristamide DEA; myristamide MEA; myristamide MIPA; myristamidopropyl betaine; myristamidopropyl hydroxysultaine; myristyl alcohol; myristyl betaine; natto gum; nonoxynyl hydroxyethylcellulose; oatamide MEA; oatamidopropyl betaine; octacosanyl glycol isostearate; octadecene/MA copolymer: oleamide DEA; oleamide MEA; oleamide MIPA; oleamidopropyl betaine; oleamidopropyl hydroxysultaine; oleyl betaine; olivamide DEA; olivamidopropyl betaine; oliveamide MEA; palmamide DEA; palmamide MEA; palmamide MIPA; palmamidopropyl betaine; palmitamide DEA; palmitamide MEA; palmitamidopropyl betaine; palm kernel alcohol; palm kernelamide DEA; palm kernelamide MEA; palm kernelamide MIPA; palm kernelamidopropyl betaine; peanutamide MEA; peanutamide MIPA; pectin; PEG-800; PEG-crosspolymer; PEG-150/decyl alcohol/SMDI copolymer; PEG-175 diisostearate; PEG-190 distearate; PEG-15 glyceryl tristearate: PEG-140 glyceryl tristearate; PEG-240/HDI copolymer bis-decyltetradeceth-20 ether; PEG-100/IPDI copolymer; PEG-180/laureth-50/TMMG copolymer; PEG-10/lauryl dimethicone crosspolymer; PEG-15/lauryl dimethicone crosspolymer; PEG-2M; PEG-5M; PEG-7M; PEG-9M; PEG-14M; PEG-20M; PEG-23M; PEG-25M; PEG-45M; PEG-65M; PEG-90M; PEG-115M; PEG-160M; PEG-180M; PEG-120 methyl glucose trioleate; PEG-180/octoxynol-40/TMMG copolymer; PEG-150 pentaerythrityl tetrastearate; PEG-4 rapeseedamide; PEG-150/stearyl alcohol/SMDI copolymer; phaseolus angularis seed powder; polianthes tuberosa extract; polyacrylate-3; polyacrylic acid; polycyclopentadiene; polyether-1; polyethylene/isopropyl maleate/MA copolyol; polyglyceryl-3 disiloxane dimethicone; polyglyceryl-3 polydimethylsiloxyethyl dimethicone; polymethacrylic acid; polyquaternium-52; polyvinyl alcohol; potassium alginate; potassium aluminum polyacrylate; potassium carbomer; potassium carrageenan; potassium chloride; potassium palmate; potassium polyacrylate; potassium sulfate; potato starch modified; PPG-2 cocamide; PPG-1 hydroxyethyl caprylamide; PPG-2 hydroxyethyl cocamide; PPG-2 hydroxyethyl coco/isostearamide; PPG-3 hydroxyethyl soyamide; PPG-14 laureth-60 hexyl dicarbamate; PPG-14 laureth-60 isophoryl dicarbamate; PPG-14 palmeth-60 hexyl dicarbamate; propylene glycol alginate; PVP/decene copolymer; PVP montmorillonite; pyrus cydonia seed; pyrus malus (apple) fiber; rhizobian gum; ricebranamide DEA; ricinoleamide DEA; ricinoleamide MEA; ricinoleamide MIPA; ricinoleamidopropyl betaine; ricinoleic acid/adipic acid/AEEA copolymer; rosa multiflora flower wax; sclerotium gum; sesamide DEA; sesamidopropyl betaine; sodium acrylate/acryloyldimethyl taurate copolymer; sodium acrylates/acrolein copolymer; sodium acrylates/acrylonitrogens copolymer; sodium acrylates copolymer; sodium acrylates crosspolymer; sodium acrylate/sodium acrylamidomethylpropane sulfonate copolymer; sodium acrylates/vinyl isodecanoate crosspolymer; sodium acrylate/vinyl alcohol copolymer; sodium carbomer; sodium carboxymethyl chitin; sodium carboxymethyl dextran; sodium carboxymethyl beta-glucan; sodium carboxymethyl starch; sodium carrageenan; sodium cellulose sulfate; sodium chloride; sodium cyclodextrin sulfate: sodium hydroxypropyl starch phosphate; sodium isooctylene/MA copolymer; sodium magnesium fluorosilicate; sodium oleate; sodium palmitate; sodium palm kernelate; sodium polyacrylate; sodium polyacrylate starch; sodium polyacryloyldimethyl taurate; sodium polygamma-glutamate; sodium polymethacrylate; sodium polystyrene sulfonate; sodium silicoaluminate; sodium starch octenylsuccinate; sodium stearate; sodium stearoxy PG-hydroxyethylcellulose sulfonate; sodium styrene/acrylates copolymer; sodium sulfate; sodium tallowate; sodium tauride acrylates/acrylic acid/acrylonitrogens copolymer; sodium tocopheryl phosphate; Solanum tuberosum (potato) starch; soyamide DEA; soyamidopropyl betaine; starch/acrylates/acrylamide copolymer; starch hydroxypropyltrimonium chloride; stearamide AMP; stearamide DEA; stearamide DEA-distearate; stearamide DIBA-stearate; stearamide MEA; stearamide MEA-stearate; stearamide MIPA; stearamidopropyl betaine; steareth-60 cetyl ether; steareth-100/PEG-136/HDI copolymer; stearyl alcohol; stearyl betaine; sterculia urens gum; synthetic fluorphlogopite; tallamide DEA; tallow alcohol; tallowamide DEA; tallowamide MEA; tallowamidopropyl betaine; tallowamidopropyl hydroxysultaine; tallowamine oxide; tallow betaine; tallow dihydroxyethyl betaine; tamarindus indica seed gum; tapioca starch; TEA-alginate; TEA-carbomer; TEA-hydrochloride; trideceth-2 carboxamide MEA; tridecyl alcohol; triethylene glycol dibenzoate; trimethyl pentanol hydroxyethyl ether; Triticum vulgare (wheat) germ powder; Triticum vulgare (wheat) kernel flour; Triticum vulgare (wheat) starch; tromethamine acrylates/acrylonitrogens copolymer; tromethamine magnesium aluminum silicate; undecyl alcohol; undecylenamide DEA; undecylenamide MEA; undecylenamidopropyl betaine; welan gum; wheat germamide DEA; wheat germamidopropyl betaine; xanthan gum; yeast beta-glucan; yeast polysaccharides; Zea mays (corn) starch; and blends thereof.

Preferred thickeners for use herein include crosslinked maleic anhydride-alkyl methylvinylethers, and copolymers, sold as Stabileze® QM (International Specialty Products (ISP)). Also useful are Carbomer®, natural gums, highly crosslinked polymethacrylate copolymer such as Microsponges® 5647, which take the form of generally spherical particles of crosslinked hydrophobic polymer having a pore size of from about 0.01 to about 0.05 μm and a surface area of 200-300 m²/g.

Neutralizing agents suitable for use in neutralizing acidic group containing hydrophilic gelling agents herein include sodium hydroxide, potassium hydroxide, ammonium hydroxide, monoethanolamine, diethanolamine and triethanolamine, and aminomethyl propanol.

The skin care and sun care composition of present application can be preserved by adding minor quantity of preservatives to the compositions. Such preservatives can be selected from, but are not limited to triazoles, imidazoles, naphthalene derivatives, benzimidazoles, morphline derivatives, dithiocarbamates, benzisothiazoles, benzamides, boron compounds, formaldehyde donors, isothiazolones, thiocyanates, quaternary ammonium compounds, iodine derivates, phenol derivatives, micobicides, pyridines, dialkylthiocarbamates, nitriles, parabens, alkyl parabens and salts thereof. Wherein the range of preservative employed is in the range of from about 0.01 wt. % to about 10 wt. %. The preservative concentration in the composition, based on the total weight of that composition, is in the range of between about 0.05% and about 1.0% by weight, preferably between about 0.1% and about 0.4% by weight. Suitable preservatives for use herein include sodium benzoate and propyl paraben, and mixtures thereof.

The preferred fatty substance-based additive/excipient for the present application include fatty alcohols, natural and synthetic waxes, ceramides, mineral oils, vegetable oils, animal oils, synthetic oils. The other preferred fatty substance are isododecane, hydrogenated polyisobutene, squalane, isononyl isononanoate, cyclotetra-and-pentadimethicones, phenyltrimethicone, ethylene homopolymers, ethoxylated fats and oils, fluoroalkanes, seracite, shea butter, arachidyl propionate alone or in combination. For the definition of waxes, mention may be made, for example, of P. D. Dorgan, Drug and Cosmetic Industry, December 1983, pp. 30-33.

The suitable solvent of the present application can consist of water, a cosmetically/dermatologically acceptable solvent, or a blend of water and a cosmetically/dermatologically acceptable solvent, such as a lower alcohol composed of C1 to C4, such as ethanol, isopropanol, t-butanol, n-butanol, alkylene glycols such as propylene glycol, and glycol ethers. However, the compositions of the invention can be anhydrous. The most preferred solvents of the present application would include water, ethanol and/or iso-propanol. It is contemplated to employ other suitable solvents for preparing products of the present application which would include but are not limited to, linear and branched C1-C6 alcohols, such as ethanol, propanol, isopropanol, butanol, hexanol, and mixtures thereof; aromatic alcohols, such as benzyl alcohol, cycloaliphatic alcohols, such as cyclohexanol, and the like; saturated C12-C30 fatty alcohol, such as lauryl alcohol, myristyl alcohol, cetyl alcohol, stearyl alcohol, behenyl alcohol, and the like. Non-limiting examples of polyols include polyhydroxy alcohols, such as glycerin, propylene glycol, butylene glycol, hexylene glycol, C2-C4 alkoxylated alcohols and C2-C4 alkoxylated polyols, such as ethoxylated, propoxylated, and butoxylated ethers of alcohols, diols, and polyols having about 2 to about 30 carbon atoms and 1 to about 40 alkoxy units, polypropylene glycol, polybutylene glycol, and the like. Non-limiting examples of non-aqueous auxiliary solvents include silicones, and silicone derivatives, such as cyclomethicone, and the like, aliphatic solvents such as cyclohexane and heptane, ketones such as acetone and methyl ethyl ketone, and mixtures thereof; ethers such as diethyl ether, dimethoxymethane, and mixtures thereof, natural and synthetic oils and waxes, such as vegetable oils, plant oils, animal oils, essential oils, mineral oils, C7-C40 isoparaffins, alkyl carboxylic esters, such as ethyl acetate, amyl acetate, ethyl lactate, and the like, jojoba oil, shark liver oil, and the like.

The alkaline pH adjusting agents such as alkali metal hydroxides, for example, sodium hydroxide, and potassium hydroxide; ammonium hydroxide; organic bases, such as triethanolamine, diisopropylamine, dodecylamine, diisopropanolamine, aminomethyl propanol, cocamine, oleamine, morpholine, triamylamine, triethylamine, tromethamine (2-amino-2-hydroxymethyl)-1,3-propanediol), and tetrakis(hydroxypropyl)ethylenediamine; and alkali metal salts of inorganic acids, such as sodium borate (borax), sodium phosphate, sodium pyrophosphate, and the like, and mixtures thereof. Acidic pH adjusting agents can be organic acids, including amino acids, and inorganic mineral acids. Non-limiting examples of acidic pH adjusting agents include acetic acid, citric acid, fumaric acid, glutamic acid, glycolic acid, hydrochloric acid, lactic acid, nitric acid, phosphoric acid, sodium bisulfate, sulfuric acid, tartaric acid, and the like, and mixtures thereof. The desired pH of the personal care composition is in the range of from about 2 to about 13, and in some embodiment, it is preferably between about 4 to about 8. The utility levels of the pH modifying agent can be present in an effective amount required to achieve the desired pH level.

The coloring agents, colorants or dyes used herein include natural foods colors and dyes suitable for food, drug and cosmetic applications. These colorants are also known as FD & C, and D&C dyes and lakes and are preferably water-soluble in nature. A full recitation of all FD&C and D&C dyes and their corresponding chemical structures may be found in the Kirk-Othmer Encyclopedia of Chemical Technology, Volume 5, pages 857-884, which text is accordingly incorporated herein by reference. These coloring agents may be incorporated in amount up to about 3%, more particularly up to about 2%, and in some cases less than about 1% by weight of the personal care compositions.

A perfume or fragrance obtained from natural or synthetic source can be employed in the present skin/sun care composition. The fragrance can be used along with a suitable solvent, diluents or carrier. Fragrances may be added in any conventionally known method, for example, admixing to a composition or blending with other ingredients used to form a composition, in amounts which are found to be useful to increase or impart the desired scent characteristics to the disinfectant or cleaning compositions. Fragrances for the present application can be one or more selected from the following non-limiting group of compounds such as essential oils, absolutes, resinoids, resins, concretes, hydrocarbons, alcohols, aldehydes, ketones, ethers, acids, esters, acetals, ketals, nitriles, including saturated and unsaturated compounds and aliphatic, carbocyclic and heterocyclic compounds.

The term “sequestering agent” or “chelating agent” as used herein relates to a compound which is capable of bonding or complexing a metal ion between two or more atoms of the compound, thereby neutralizing or controlling harmful effects of such metal ions. Wherein holding or bonding of a metal ion is through combination of one or more different types of bonds including coordination and/or ionic bonds. Further, the information on sequestering and chelating agents that are considered for the present application is duly disclosed in T. E. Furia, CRC Handbook of Food Additives, 2nd Edition, pp. 271-294 (1972), and M. S. Peterson and A. M. Johnson (Eds.), Encyclopedia of Food Science, pp. 694-699 (1978) are incorporated herein by reference in its entirety.

Suitable sunscreens which can be formulated into the compositions of the instant invention are those selected from among: methoxydibenzoylmethane; octyl salicylate; pentyl dimethyl PABA; octyl dimethyl PABA; benzophenone-1; benzophenone-6; 2-(2H-benzotriazole-2-yl)-4,6-di-tert-pentylphenol; ethyl-2-cyano-3,3-diphenylacrylate; homomethyl salicylate (homosalate); bis-ethylhexyloxyphenol methoxyphenyl triazine; methyl-(1,2,2,6,6-pentamethyl-4-piperidyl)-sebacate; 2-(2H-benzotriazole-2-yl)-4-methylphenol; diethylhexyl butamido triazone; amyl dimethyl PABA; 4,6-bis(octylthiomethyl)-o-cresol; red petroleum; ethylhexyl triazone; octocrylene; isoamyl-p-methoxycinnamate; drometrizole; titanium dioxide; 2,4-di-tert-butyl-6-(5-chloro-2H-benzotriazole-2-yl)-phenol; 2-hydroxy-4-octyloxybenzophenone; benzophenone-2; diisopropyl methylcinnamate; PEG-25 PABA; 2-(1,1-dimethylethyl)-6-[[3-(1,1-demethylethyl)-2-hydroxy-5-methylphenyl]methyl-4-methylphenyl acrylate; drometrizole trisiloxane; menthyl anthranilate; butyl methoxydibenzoylmethane; 2-ethoxyethyl p-methoxycinnamate; benzylidene camphor sulfonic acid; dimethoxyphenyl-[1-(3,4)]-4,4-dimethyl 1,3-pentanedione; zinc oxide; N,N′-hexane-1,6-diylbis[3-(3,5-di-tert-butyl-4-hydroxyphenylpropionamide)]; pentaerythritol tetrakis[3-(3,5-di-tert-butyl-4-hydroxyphenyl)propionate]; 2,6-di-tert-butyl-4-[4,6-bis(octylthio)-1,3,5-triazin-2-ylamino]phenol; 2-(2H-benzotriazole-2-yl)-4,6-bis(1-methyl-1-phenylethyl) phenol; trolamine salicylate; diethylanolamine p-methoxycinnamate; polysilicone-15; 4-methylbenzylidene camphor; bisoctrizole; N-phenyl-benzenamine; reaction products with 2,4,4-trimethylpentene; sulisobenzone; (2-ethylhexyl)-2-cyano-3,3-diphenylacrylate; digalloyl trioleate; polyacrylamido methylbenzylidene camphor; glyceryl ethylhexanoate dimethoxycinnamate; 1,3-bis-[(2′-cyano-3′,3′-diphenylacryloyl)oxy]-2,2-bis-[(2′-cyano-bis-(2,2,6,6-tetramethyl-4-piperidyl)-sebacate; benzophenone-5; 1,3,5-tris(3,5-di-tert-butyl-4-hydroxybenzyl)-1,3,5-triazine-2,4,6 (1H,3H,5H)-trione; hexamethylendiamine; benzophenone-8; ethyl-4-bis(hydroxypropyl)aminobenzoate; 6-tert-butyl-2-(5-chloro-2H-benzotriazole-2-yl)-4-methylphenol; p-aminobenzoic acid; 3,3′,3″,5,5′,5″-hexa-tert-butyl-a-a′-a″-(mesitylene-2,4,6-triyl)tri-p-cresol; lawsone with dihydroxyacetone; benzophenone-9; benzophenone-4; ethylhexyl dimethoxy benzylidene dioxoimidazoline propionate; N,N′-bisformyl-N,N′-bis-(2,2,6,6-tetramethyl-4-piperidinyl)-; 3-benzylidene camphor; terephthalylidene dicamphor sulfonic acid; camphor benzalkonium methosulfate; bisdisulizole disodium; etocrylene; ferulic acid; 2-(2H-benzotriazole-2-yl)-4-(1,1,3,3-tetramethylbutyl)-phenol; 4,6-bis(dodecylthiomethyl)-o-cresol; β-2-glucopyranoxy propyl benzophenone; phenylbenzimidazole sulfonic acid; benzophenone-3; diethylamine hydroxybenzoyl hexylbenzoate; 3′,3′-diphenylacryloyl)oxy]methyl}-propane; ethylhexyl p-methoxycinnamate, and blends thereof.

Suitable sunscreens which can be formulated into the compositions of the instant invention are those selected from among: aminobenzoic acid, amyldimethyl PABA, cinoxate, diethanolamine p-methoxycinnamate, digalloyl trioleate, dioxybenzone, 2-ethoxyethyl p-methoxycinnamate, ethyl 4-bis(hydroxypropyl)aminobenzoate, 2-ethylhexyl-2-cyano-3,3-diphenylacrylate, ethylhexyl p-methoxycinnamate, 2-ethylhexyl salicylate, glyceryl aminobenzoate, homomenthyl salicylate, homosalate, 3-imidazol-4-ylacrylic acid and ethyl ester, methyl anthranilate, octyldimethyl PABA, 2-phenylbenzimidazole-5-sulfonic acid and salts, red petrolatum, sulisobenzone, titanium dioxide, triethanolamine salicylate, N,N,N-trimethyl-4-(2-oxoborn-3-ylidene methyl)anillinium methyl sulfate, and mixtures thereof.

The composition may also contain additional materials such as, for example, fillers such as nylon, electrolytes such as sodium chloride, proteins, antioxidants and chelating agents as appropriate.

In some embodiments, the suitable range of a reaction product of a maleated natural oil and one or more functionalized or unfunctionalized moieties selected from a hydrophobic moiety, a hydrophilic moiety or a combination can be varied from about 0.01 wt. % to about 0.1 wt. %, from about 0.1 wt. % to about 1 wt. %, or from about 1 wt. % to about 5 wt. %, or from about 5 wt. % to about 10 wt. % based on the total weight of the aqueous personal care composition.

In some embodiments, the suitable range of functional system active ingredient for the present application can be varied from about 0.1 wt. % to about 1 wt. %; or from about 1 wt. % to about 2.5 wt. %; or from about 2.5 wt. % to about 5 wt. %; or from about 5 wt. % to about 10 wt. %; or 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. %; or from about 85 wt. % to about 90 wt. % based on the total weight of the oral care antimicrobial

In some embodiments, the suitable range of personal care ingredient for the present application can be varied from about 0.1 wt. % to about 1 wt. %; or from about 1 wt. % to about 2.5 wt. %; or from about 2.5 wt. % to about 5 wt. %; or from about 5 wt. % to about 10 wt. %; or 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. %; or from about 85 wt. % to about 90 wt. % based on the total weight of the oral care antimicrobial composition.

In some embodiments, the suitable range of skin care ingredient for the present application can be varied from about 0.1 wt. % to about 1 wt. %; or from about 1 wt. % to about 2.5 wt. %; or from about 2.5 wt. % to about 5 wt. %; or from about 5 wt. % to about 10 wt. %; or 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. %; or from about 85 wt. % to about 90 wt. % based on the total weight of the oral care antimicrobial composition.

As per another embodiment of the present application, the aqueous personal care composition of the present application is formulated into a spray, a lotion, a mousse, a fluid, a serum, a solution, a perm, an emulsion, a gel, a vesicle a dispersion, a paste, a cream, a solid stick, a shampoo, a balm, a wipe, a milk, a foam, a jelly and/or a liquid.

The reactions and compositions according to the application may be analyzed by known techniques. Especially preferred are the techniques of 13C nuclear magnetic resonance (NMR) spectroscopy, gas chromatography (GC), Infra-red (IR), Liquid Chromatography (LC) and gel permeation chromatography (GPC) in order to decipher identity, residual monomer concentrations, molecular weight, and molecular weight distribution.

Further, certain aspects of the present application are illustrated in detail by way of the following examples. The examples are given herein for illustration of the application and are not intended to be limiting thereof.

### EXAMPLES

### Example A: Grafting of Maleic Anhydride onto Natural Oils

### Example A1: Grafting of 1 Mole of Maleic Anhydride onto Soybean Oil

In a 1-Liter, 4 neck kettle equipped with a thermocouple, a condenser, a nitrogen sparge adapter, and a mechanical stirrer, 600 g of yellow color Soybean oil and 67 g (1 mole eq. based on SBO) of maleic anhydride were charged. The mixture was sparged with nitrogen for 15 min at RT only. The mixture was slowly heated from room temperature to 210° C. and was held isothermally at 210° C. for about 6-8 hours. The one pot reaction without catalyst and solvent yields >96% amber color viscous product which was characterized by NMR and LC<1% residual maleic anhydride.

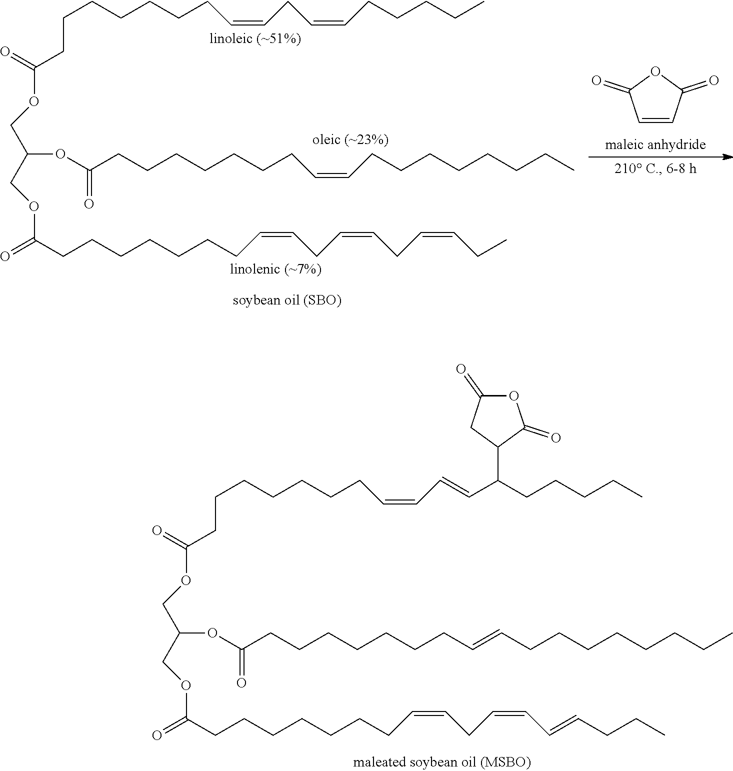 [SMILES: CC/C=C\C/C=C\C/C=C\CCCCCCCC(=O)OCC(COC(=O)CCCCCCC/C=C\C/C=C\CCCCC)OC(=O)CCCCCCC/C=C\CCCCCCCC ; O=C1C=CC(=O)O1 ; CCC/C=C/C=C\C/C=C\CCCCCCCC(=O)OCC(COC(=O)CCCCCCC/C=C\C=C\C(CCCCC)C1CC(=O)OC1=O)OC(=O)CCCCCCC/C=C/CCCCCCCC]

### Example A2: Grafting of 2 Moles of Maleic Anhydride onto Soybean Oil

In a 1-Liter, 4 neck kettle equipped with a thermocouple, a condenser, a nitrogen sparge adapter, and a mechanical stirrer, 600 g of yellow color Soybean oil and 137.7 g (2 mole eq. based on SBO) of maleic anhydride were charged. The mixture was sparged with nitrogen for 15 min at RT only. The mixture was slowly heated from room temperature to 210° C. and was held isothermally at 210° C. for about 6-8 hours. The one pot reaction without catalyst and solvent yields >96% amber color viscous product which was characterized by NMR and LC<1% residual maleic anhydride.

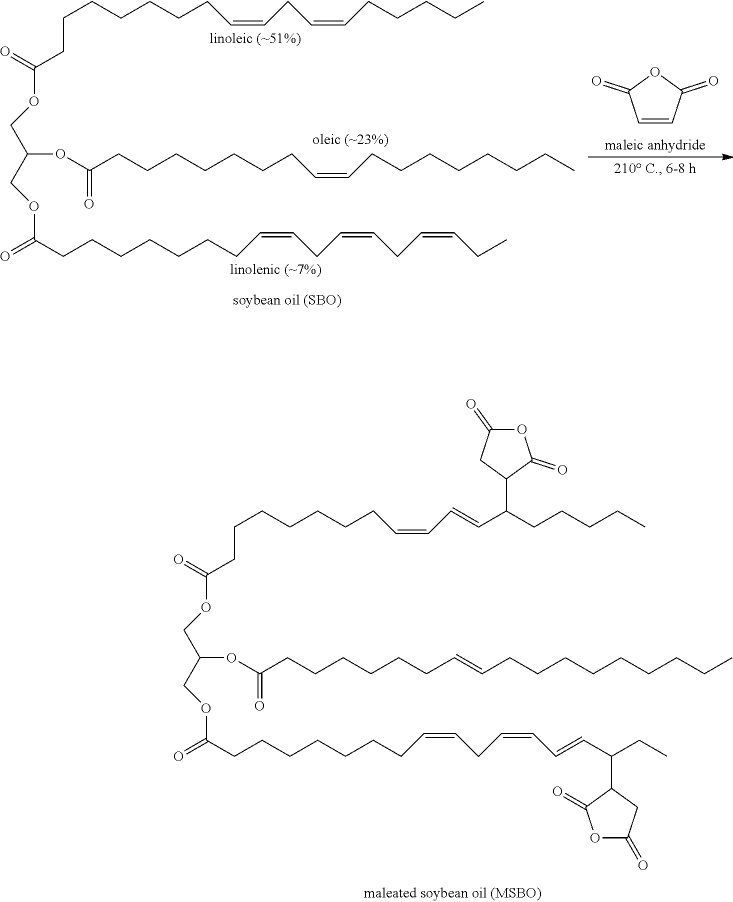 [SMILES: CC/C=C\C/C=C\C/C=C\CCCCCCCC(=O)OCC(COC(=O)CCCCCCC/C=C\C/C=C\CCCCC)OC(=O)CCCCCCC/C=C\CCCCCCCC ; O=C1C=CC(=O)O1 ; CCCCCCCCC/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C1CC(=O)OC1=O]

### Example A3: Grafting of 3 Moles of Maleic Anhydride onto Soybean Oil

In a 1-Liter, 4 neck kettle equipped with a thermocouple, a condenser, a nitrogen sparge adapter, and a mechanical stirrer, 600 g of yellow color soybean oil and 204 g (3 mole eq. based on SBO) of maleic anhydride were charged. The mixture was sparged with nitrogen for 15 min at RT only. The mixture was slowly heated from room temperature to 210° C. and was held isothermally at 210° C. for about 6-8 hours. The one pot reaction without catalyst and solvent yields >96% amber color viscous product which was characterized by NMR and LC<1% residual maleic anhydride

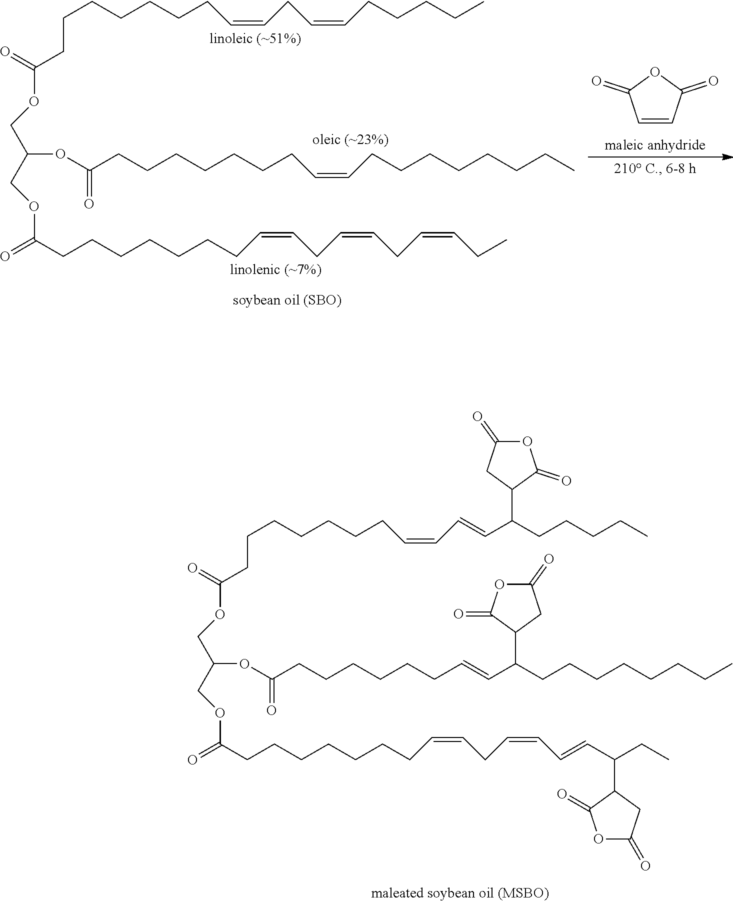 [SMILES: CC/C=C\C/C=C\C/C=C\CCCCCCCC(=O)OCC(COC(=O)CCCCCCC/C=C\C/C=C\CCCCC)OC(=O)CCCCCCC/C=C\CCCCCCCC ; O=C1C=CC(=O)O1 ; CCCCCCCCC(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C1CC(=O)OC1=O)C1CC(=O)OC1=O]

### Example A4: Grafting of Maleic Anhydride onto Palm Oil

In a 1-Liter, 4 neck kettle equipped with a thermocouple, a condenser, a nitrogen sparge adapter, and a mechanical stirrer, 100 g of palm oil and 23 g (2 mole eq. based on palm oil) of maleic anhydride was charged. The mixture was sparged with nitrogen for 15 min at RT only. The mixture was slowly heated from room temperature to 210° C. and held isothermally at 210° C. for about 8-10 hours. The one pot reaction without catalyst and solvent yields >96% amber color viscous product which was characterized by NMR and LC<1% residual maleic anhydride.

### Example A5: Grafting of Maleic Anhydride onto Canola Oil

In a 1-Liter, 4 neck kettle equipped with a thermocouple, a condenser, a nitrogen sparge adapter, and a mechanical stirrer, 100 g of canola oil and 22.2 g (2 mole eq. based on canola oil) of maleic anhydride was charged. The mixture was sparged with nitrogen for 15 min at RT only. The mixture was slowly heated from room temperature to 210° C. and held isothermally at 210° C. for about 8-10 hours. The one pot reaction without catalyst and solvent yields >96% amber color viscous product which was characterized by NMR and LC<1% residual maleic anhydride.

### Example A6: Grafting of Maleic Anhydride onto Sunflower Oil

In a 1-Liter, 4 neck kettle equipped with a thermocouple, a condenser, a nitrogen sparge adapter, and a mechanical stirrer, 100 g of sunflower oil and 22.4 g (2 mole eq. based on sunflower oil) of maleic anhydride was charged. The mixture was sparged with nitrogen for 15 min at RT only. The mixture was slowly heated from room temperature to 210° C. and held isothermally at 210° C. for about 8-10 hours. The one pot reaction without catalyst and solvent yields >96% amber color viscous product which was characterized by NMR and LC<1% residual maleic anhydride.

### Example A7: Grafting of Maleic Anhydride onto Castor Oil

In a 1-Liter, 4 neck kettle equipped with a thermocouple, a condenser, a nitrogen sparge adapter, and a mechanical stirrer, 100 g of yellow color castor oil and 21 g (2 mole eq. based on castor oil) of maleic anhydride was charged. The mixture was sparged with nitrogen for 15 min at RT only. The mixture was slowly heated from room temperature to 210° C. and held isothermally at 210° C. for about 8-10 hours. The one pot reaction without catalyst and solvent yields >96% amber color viscous product which was characterized by NMR and LC<1% residual maleic anhydride.

### Example B: Grafting of Hydrophobic Alcohol (Octyl Dodecanol) onto Maleic Anhydride onto Natural Oil

### Example B1

In a 1-Liter, 4 neck kettle equipped with a thermocouple, a condenser, a nitrogen purge adapter, and a mechanical stirrer, 100 g of amber color viscous product from maleination reaction Example A1 and 30.5 g (1 mole eq.) of 2-octyl-1-dodecanol were mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

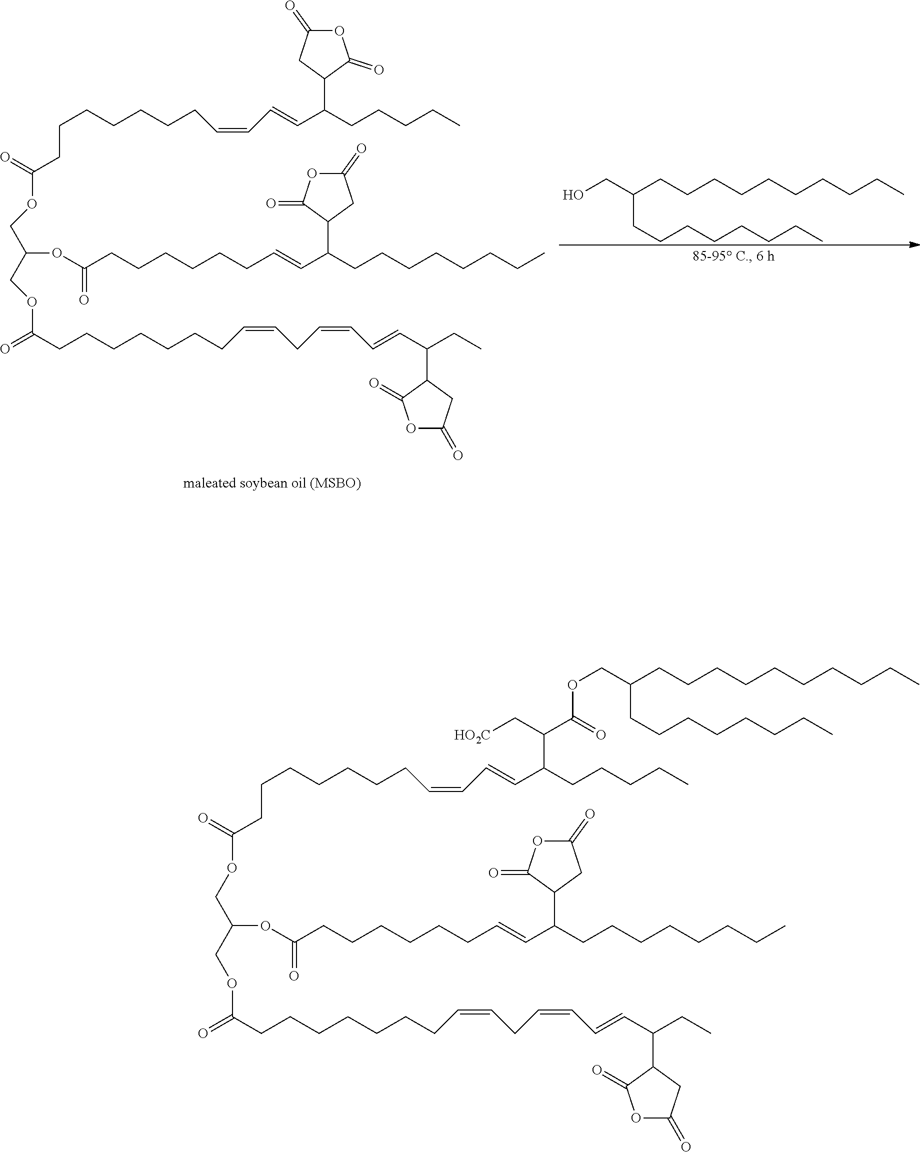 [SMILES: CCCCCCCCC(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C1CC(=O)OC1=O)C1CC(=O)OC1=O ; CCCCCCCCCCC(CO)CCCCCCCC ; CCCCCCCCCCC(CCCCCCCC)COC(=O)C(CC(=O)O)C(/C=C/C=C\CCCCCCCC(=O)OCC(COC(=O)CCCCCCC/C=C\C/C=C\C=C\C(CC)C1CC(=O)OC1=O)OC(=O)CCCCCC/C=C/C(CCCCCCCC)C1CC(=O)OC1=O)CCCCC]

### Example B2

In a 1-Liter, 4 neck kettle equipped with a thermocouple, a condenser, a nitrogen purge adapter, and a mechanical stirrer, 100 g of amber color viscous product from maleination reaction Example A2 and 55.64 g (2 mole eq.) of 2-octyl-1-dodecanol were mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B3

In a 1-Liter, 4 neck kettle equipped with a thermocouple, a condenser, a nitrogen purge adapter, and a mechanical stirrer, 100 g of amber color viscous product from maleination reaction Example A2 and 61.20 g (2.2 mole eq.) of 2-octyl-1-dodecanol were mixed and heated to 90° C. and held for 6 hours. The one pot reaction without catalyst and solvent yields >96% amber color viscous product which was characterized by NMR, GC<5% for residual octyl dodecanol and LC<1% residual maleic anhydride.

### Example B4

In a 1-Liter, 4 neck kettle equipped with a thermocouple, a condenser, a nitrogen purge adapter, and a mechanical stirrer, 100 g of amber color viscous product from maleination reaction Example A3 and 25.44 g (1 mole eq.) of 2-octyl-1-dodecanol were mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B5

In a 1-Liter, 4 neck kettle equipped with a thermocouple, a condenser, a nitrogen purge adapter, and a mechanical stirrer, 100 g of amber color viscous product from maleination reaction Example A3 and 31.81 g (1.25 mole eq.) of 2-octyl-1-dodecanol were mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B6

In a 1-Liter, 4 neck kettle equipped with a thermocouple, a condenser, a nitrogen purge adapter, and a mechanical stirrer, 100 g of amber color viscous product from maleination reaction Example A3 and 38.17 g (1.5 mole eq.) of 2-octyl-1-dodecanol were mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B7

In a 1-Liter, 4 neck kettle equipped with a thermocouple, a condenser, a nitrogen purge adapter, and a mechanical stirrer, 100 g of amber color viscous product from maleination reaction Example A 3 and 50.89 g (2 mole eq.) of 2-octyl-1-dodecanol were mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B8

In a 1-Liter, 4 neck kettle equipped with a thermocouple, a condenser, a nitrogen purge adapter, and a mechanical stirrer, 100 g of amber color viscous product from maleination reaction Example A3 and 63.61 g (2.5 mole eq.) of 2-octyl-1-dodecanol were mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B9

In a 1-Liter, 4 neck kettle equipped with a thermocouple, a condenser, a nitrogen purge adapter, and a mechanical stirrer, 100 g of amber color viscous product from maleination reaction Example A4 and 35 g (1 mole eq.) of 2-octyl-1-dodecanol was mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B10

In a 1-Liter, 4 neck kettle equipped with a thermocouple, a condenser, a nitrogen purge adapter, and a mechanical stirrer, 100 g of amber color viscous product from maleination reaction Example A5 and 35 g (1 mole eq.) of 2-octyl-1-dodecanol was mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B11

In a 1-Liter, 4 neck kettle equipped with a thermocouple, a condenser, a nitrogen purge adapter, and a mechanical stirrer, 100 g of amber color viscous product from maleination reaction Example A6 and 35 g (1 mole eq.) of 2-octyl-1-dodecanol was mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example B12

In a 1-Liter, 4 neck kettle equipped with a thermocouple, a condenser, a nitrogen purge adapter, and a mechanical stirrer, 100 g of amber color viscous product from maleination reaction Example A7 and 35 g (1 mole eq.) of 2-octyl-1-dodecanol was mixed and heated to 90° C. and held for 6 hours. The one pot reaction without catalyst and solvent yields >96% amber color viscous product, which was characterized by NMR, IR, GC<5% for residual octyl dodecanol and LC<1% residual maleic anhydride.

### Example C: Grafting of Hydrophobic and Hydrophilic Moiety (Glycerin) onto Hydrophobic Maleic Anhydride onto Natural Oil with Octyl Dodecanol

### Example C 1

In a 1-Liter, 4 neck kettle equipped with a thermocouple, a condenser, a nitrogen purge adapter, and a mechanical stirrer, 100 g of amber color viscous product from reaction B 6 and 5.7 g (1 mole eq.) of glycerin were mixed and heated to 90° C. and held for 4-6 hours. The one pot reaction without catalyst and solvent yields >96% amber color viscous product which was characterized by NMR and LC<0.05% residual maleic anhydride.

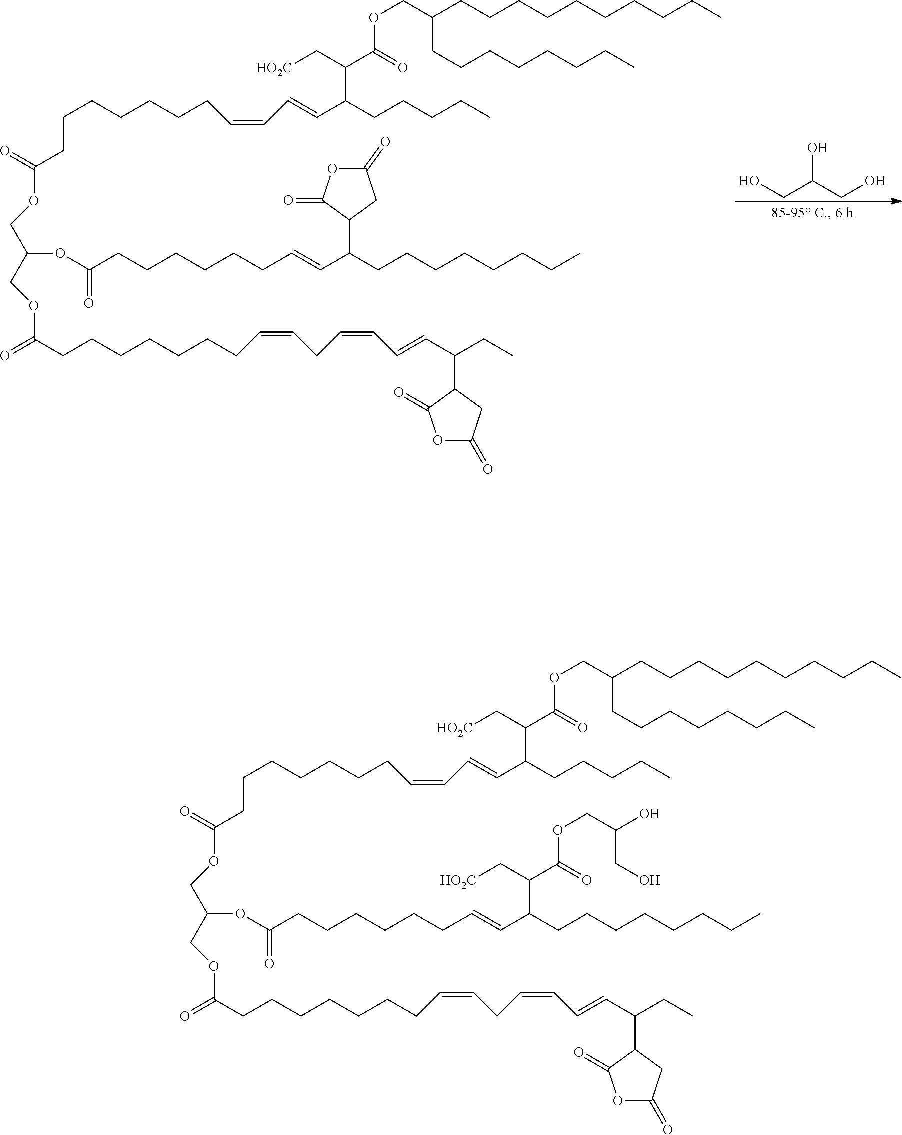 [SMILES: CCCCCCCCCCC(CCCCCCCC)COC(=O)C(CC(=O)O)C(/C=C/C=C\CCCCCCCC(=O)OCC(COC(=O)CCCCCCC/C=C\C/C=C\C=C\C(CC)C1CC(=O)OC1=O)OC(=O)CCCCCC/C=C/C(CCCCCCCC)C1CC(=O)OC1=O)CCCCC ; OCC(O)CO ; CCCCCCCCCCC(CCCCCCCC)COC(=O)C(CC(=O)O)C(/C=C/C=C\CCCCCCCC(=O)OCC(COC(=O)CCCCCCC/C=C\C/C=C\C=C\C(CC)C1CC(=O)OC1=O)OC(=O)CCCCCC/C=C/C(CCCCCCCC)C(CC(=O)O)C(=O)OCC(O)CO)CCCCC]

### Example C 2

In a 1-Liter, 4 neck kettle equipped with a thermocouple, a condenser, a nitrogen purge adapter, and a mechanical stirrer, 100 g of amber color viscous product from reaction B 4 and 6.28 g (1 mole eq.) of glycerin were mixed and heated to 90° C. and held for 4-6 hours. The one pot reaction without catalyst and solvent yields >96% amber color viscous product which was characterized by NMR and LC<0.05% residual maleic anhydride.

### Example C 3

In a 1-Liter, 4 neck kettle equipped with a thermocouple, a condenser, a nitrogen purge adapter, and a mechanical stirrer, 100 g of amber color viscous product from reaction B 4 and 9.42 g (1.5 mole eq.) of glycerin were mixed and heated to 90° C. and held for 4 hours. The one pot reaction without catalyst and solvent yields >96% amber color viscous product which was characterized by NMR and LC<0.05% residual maleic anhydride.

### Example C 4

In a 1-Liter, 4 neck kettle equipped with a thermocouple, a condenser, a nitrogen purge adapter, and a mechanical stirrer, 100 g of amber color viscous product from reaction B 9 and 11 g (1 mole eq.) of glycerin was mixed and heated to 90° C. and held for 4-6 hours. The one pot reaction without catalyst and solvent yields >96% amber color viscous product which was characterized by NMR and LC<0.05% residual maleic anhydride.

### Example C 5

In a 1-Liter, 4 neck kettle equipped with a thermocouple, a condenser, a nitrogen purge adapter, and a mechanical stirrer, 100 g of amber color viscous product from reaction B 10 and 11 g (1 mole eq.) of glycerin was mixed and heated to 90° C. and held for 4-6 hours. The one pot reaction without catalyst and solvent yields >96% amber color viscous product which was characterized by NMR and LC<0.05% residual maleic anhydride.

### Example C 6

In a 1-Liter, 4 neck kettle equipped with a thermocouple, a condenser, a nitrogen purge adapter, and a mechanical stirrer, 100 g of amber color viscous product from reaction B 11 and 11 g (1 mole eq.) of glycerin was mixed and heated to 90° C. and held for 4-6 hours. The one pot reaction without catalyst and solvent yields >96% amber color viscous product which was characterized by NMR and LC<0.05% residual maleic anhydride.

### Example C 7

In a 1-Liter, 4 neck kettle equipped with a thermocouple, a condenser, a nitrogen purge adapter, and a mechanical stirrer, 100 g of amber color viscous product from reaction B 12 and 11 g (1 mole eq.) of glycerin was mixed and heated to 90° C. and held for 4-6 hours. The one pot reaction without catalyst and solvent yields >96% amber color viscous product which was characterized by NMR and LC<0.05% residual maleic anhydride.

### Example C 8

In a 1-Liter, 4 neck kettle equipped with a thermocouple, a condenser, a nitrogen purge adapter, and a mechanical stirrer, 152 g of amber color viscous product from reaction B 4 and 4.74 g (1 mole eq.) of ethanol were mixed and heated to 90° C. and held for 8 hours. The one pot reaction without catalyst and solvent yields >96% amber color product which was characterized by NMR and LC<0.05% residual maleic anhydride.

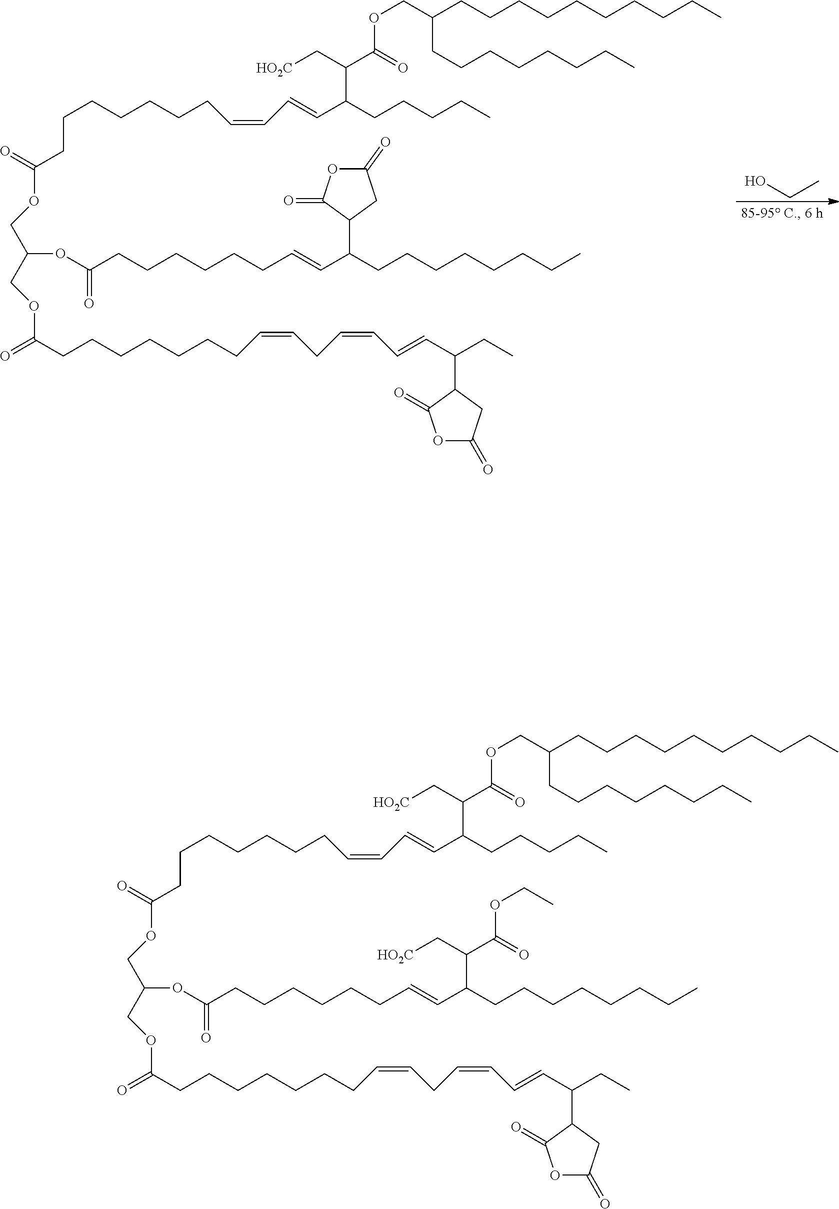

### Example C 9

In a 1-Liter, 4 neck kettle equipped with a thermocouple, a condenser, a nitrogen purge adapter, and a mechanical stirrer, 152 g of amber color viscous product from reaction B 4 and 9.47 g (2 mole eq.) of ethanol were mixed and heated to 90° C. and held for 8 hours. The one pot reaction without catalyst and solvent yields >96% amber color product which was characterized by NMR and LC<0.05% residual maleic anhydride.

### Example D: Grafting of Hydrophilic Alcohol (Beta Cyclodextrin, Glycerin) onto Maleic Anhydride onto Natural Oil

### Example D 1

In a 1-Liter, 4 neck kettle equipped with a thermocouple, a condenser, a nitrogen purge adapter, and a mechanical stirrer, 68.43 g of amber color viscous product from reaction B 6 and 23.73 g (0.50 mole eq.) of beta cyclodextrin were mixed and heated to 90° C. and held for 6 hours. The one pot reaction without catalyst and solvent yields >96% yellow color product which was characterized by IR and LC<0.05% residual maleic anhydride.

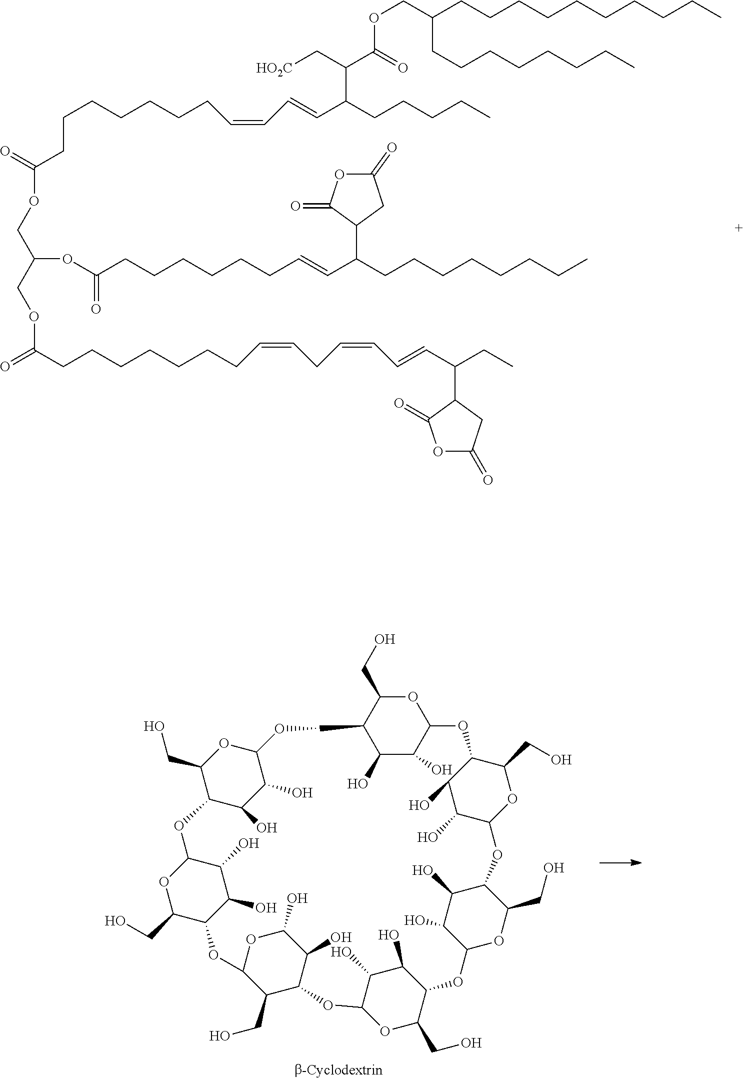

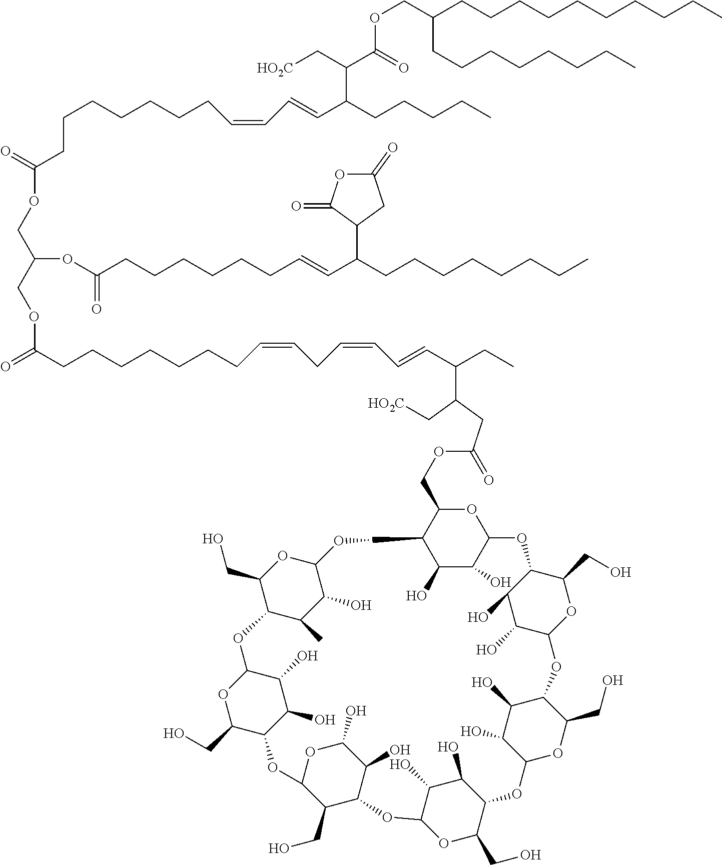

### Example D 2

In a 1-Liter, 4 neck kettle equipped with a thermocouple, a condenser, a nitrogen purge adapter, and a mechanical stirrer, 68.43 g of amber color viscous product from reaction B 6 and 23.73 g (0.50 mole eq.) of beta cyclodextrin and 3.85 g (1 mole eq.) of glycerin were mixed and heated to 90° C. and held for 4 hours. The one pot reaction without catalyst and solvent yields >96% yellow color product which was characterized by IR and LC<0.05% residual maleic anhydride.

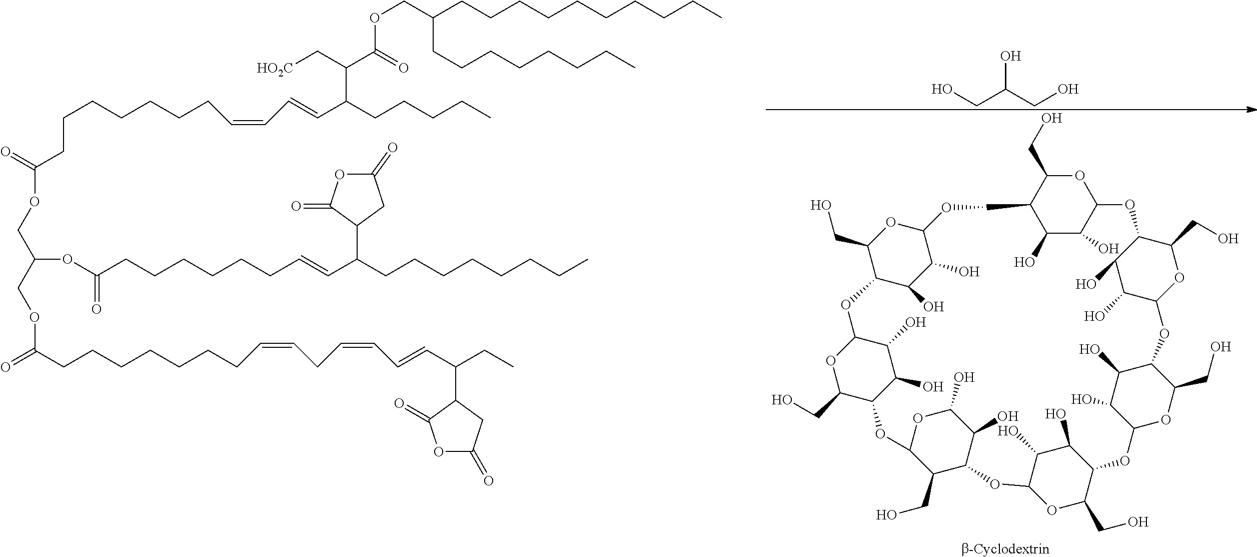

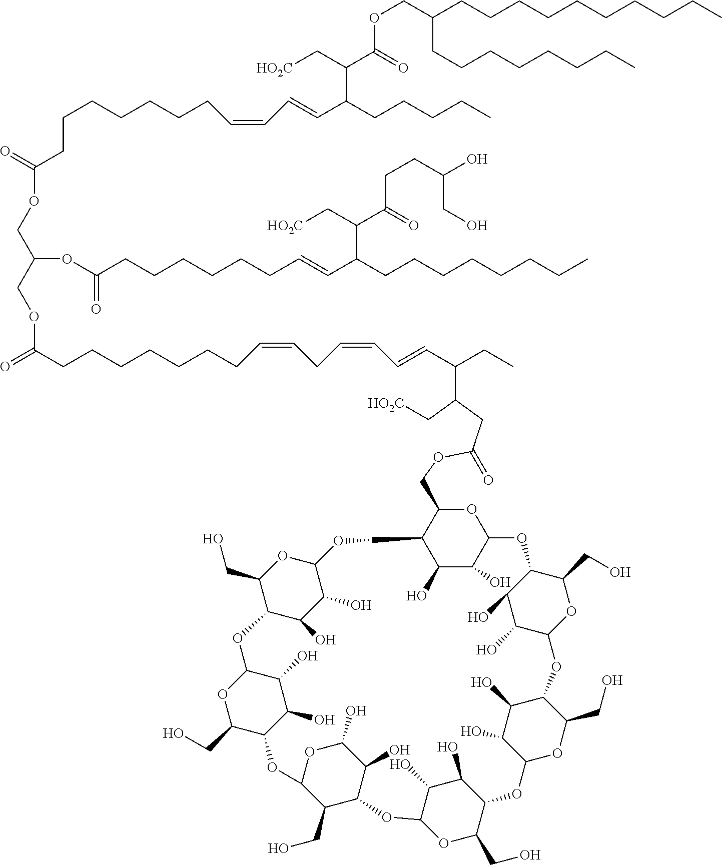

### Example D 3

In a 1-Liter, 4 neck kettle equipped with a thermocouple, a condenser, a nitrogen purge adapter, and a mechanical stirrer, 68.43 g of amber color viscous product from reaction B 6 and 23.73 g (0.50 mole eq.) of beta cyclodextrin and 1.93 g (0.50 mole eq.) of glycerin were mixed and heated to 90° C. and held for 4 hours. The one pot reaction without catalyst and solvent yields >96% yellow color product which was characterized by IR and LC<0.05% residual maleic acid. The one pot reaction without catalyst and solvent yields >96% yellow color product which was characterized by IR and LC<0.05% residual maleic anhydride.

### Example E: Maleination Reaction with Water

### Example E 1

In a 1-Liter, 4 neck kettle equipped with a thermocouple, a condenser, a nitrogen purge adapter, and a mechanical stirrer, 100 g of amber color viscous product from maleination reaction A 3 and 6.10 g (3 mole eq.) of water were mixed and heated to 90° C. and held for 20 hours. The one pot reaction without catalyst and solvent yields >90% yellow color product which was characterized by NMR, IR and LC<0.05% residual maleic acid.

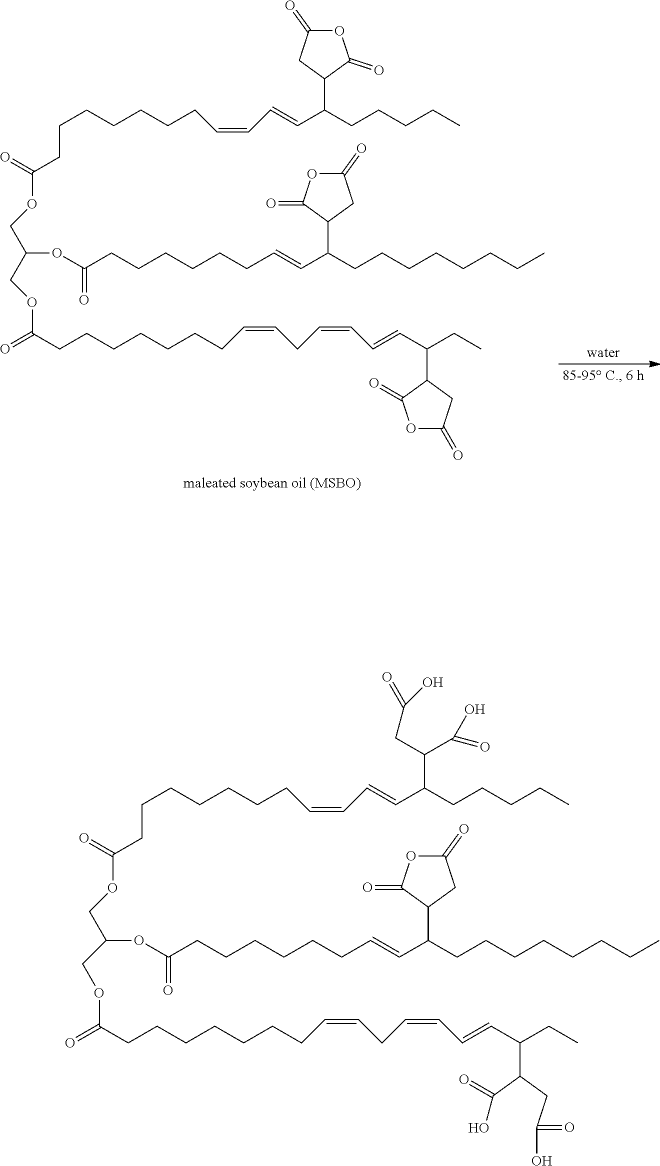 [SMILES: CCCCCCCCC(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C1CC(=O)OC1=O)C1CC(=O)OC1=O ; CCCCCCCCC(/C=C/CCCCCCC(=O)OC(COC(=O)CCCCCCC/C=C\C=C\C(CCCCC)C(CC(=O)O)C(=O)O)COC(=O)CCCCCCC/C=C\C/C=C\C=C\C(CC)C(CC(=O)O)C(=O)O)C1CC(=O)OC1=O]

### Example F: Grafting of Hydrophilic Glycerin onto Maleic Anhydride onto Soybean Oil

### Example F 1

In a 1-Liter, 4 neck kettle equipped with a thermocouple, a condenser, a nitrogen purge adapter, and a mechanical stirrer, 176 g of amber color viscous product from maleination reaction A 3 and 6.87 g (0.5 mole eq.) of glycerin were mixed and heated to 90° C. and held for 2 hours. The one pot reaction without catalyst and solvent yields >96% yellow color product which was characterized by IR and LC<0.05% residual maleic anhydride.

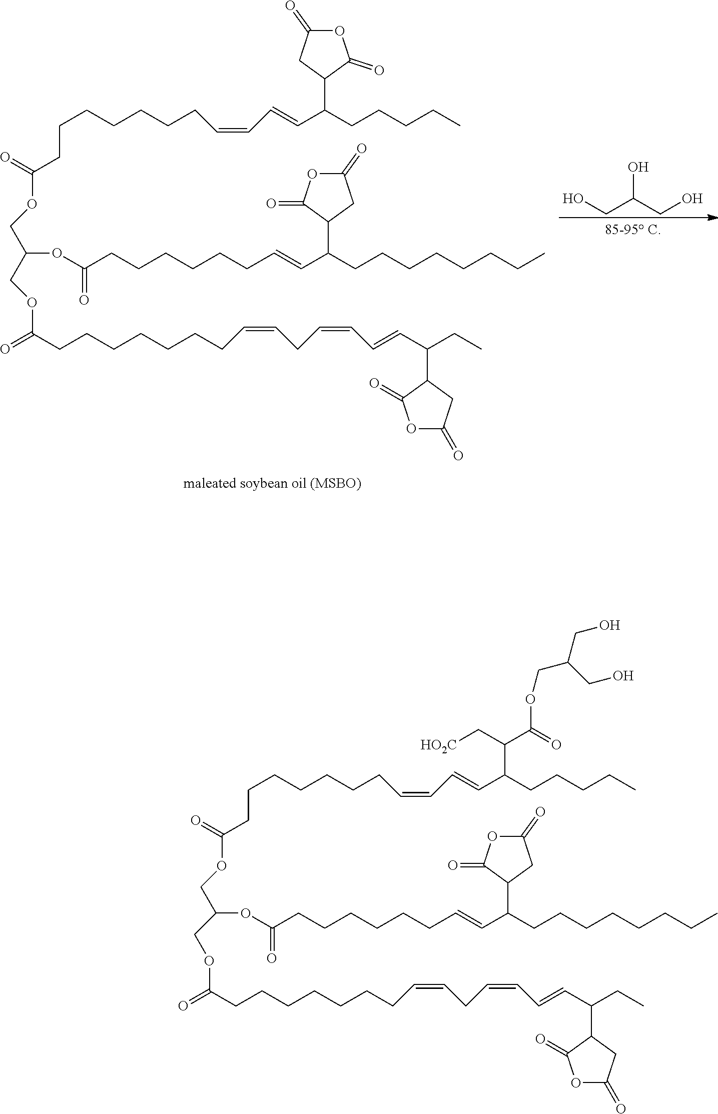 [SMILES: CCCCCCCCC(/C=C/CCCCCCC(=O)OC(COC(=O)CCCCCCC/C=C\C=C\C(CCCCC)C1CC(=O)OC1=O)COC(=O)CCCCCCC/C=C\C/C=C\C=C\C(CC)C1CC(=O)OC1=O)C1CC(=O)OC1=O ; OCC(O)CO ; CCCCCCCCC(/C=C/CCCCCCC(=O)OC(COC(=O)CCCCCCC/C=C\C=C\C(CCCCC)C(CC(=O)O)C(=O)OCC(CO)CO)COC(=O)CCCCCCC/C=C\C/C=C\C=C\C(CC)C1CC(=O)OC1=O)C1CC(=O)OC1=O]

### Example F 2

In a 1-Liter, 4 neck kettle equipped with a thermocouple, a condenser, a nitrogen purge adapter, and a mechanical stirrer, 176 g of amber color viscous product from maleination reaction A 3 and 13.74 g (1 mole eq.) of glycerin were mixed and heated to 90° C. and held for 4 hours. The one pot reaction without catalyst and solvent yields >96% yellow color product which was characterized by IR and LC<0.05% residual maleic anhydride.

### Nonionic Sunscreen Emulsion Procedure

In Phase A, the water and glycol were added into a glass beaker. Sprinkle in Carbomer, mix until all in and smooth. Weigh out the Phase B ingredients and heated at a temperature of 75-80° C. and was added slowly to the phase A and continue to homogenize. The homogenize mixture was cooled at 60-65° C. Weigh out the Phase C ingredients and slowly add to the homogenize mixture of Phase A and Phase B and continue to homogenize. The pH was adjusted as needed. Sweep mix until the reactor vessel was cooled.

### Water in Silicone Mineral (Zinc and Titanium) Emulsion Procedure

Pre-weigh ingredients of phase A. and the ingredients were mixed and heat to 40-45° C., homogenize until uniform and then cool down at 30-35° C. In a separate beaker phase C were added and heated to 65° C. and continue mix until clear. Cool down the phase C to 35-40° C. Pulverize phase B and add to phase C while mixing at moderate high speed. Add phase A to the mixture of Phase B and C slowly and continue mixing at moderate to high speed for about 10 minutes. Cool to room temperature.

### W/Si Mineral (Zinc) Emulsion Procedure

In Phase A, Dimethicone 1 and Dimethicone 2 were added to main beaker and begin mixing with a high lift mixing blade at high speed. Cetyl PEG/PPG-10/1 Dimethicone was added and continue mixing at high speed then add polyglyceryl-4 isostearate, cetyl PEG/PPG-10/1 Dimethicone and hexyl laurate and continue mixing. Then add the caprylic/capric Triglyceride, stearalkonium hectorite, Propylene Carbonate. In a separate beaker combine Phase B ingredients and mix. Once Phase B mixture was uniform, it was added to phase A and continue mixing. In a separate beaker phase C ingredient were added. Water was added and continue mixing, then hydroxyethyl cellulose was added and heat to 80-85° C. once dispersed, glycerin and butylene glycol were added and continue mixing and heating to 85° C. until the hydroxyethyl cellulose is solubilized and then phenoxyethanol and salt were added. Ensure that all the salt is dissolved and begin cooling slowly to room temperature. Once all the ingredients in phase C was uniform increase mixing on phase A and slowly pour phase C into phase A. Continue mixing until uniform. Zinc Oxide was added to the main batch and continue prop mixing for 5 minutes until the batch is homogenous. Switch to the homogenizer and continue homogenizing for 10 minutes.

### Anionic Emulsion Procedure

In Phase A, water and Glycerin and Glyceryl Acrylate/Acrylic Acid Copolymer and PVM/MA copolymer were added into a glass beaker and heated to 75-80° C. Sprinkle in Acrylic Acid/VP crosspolymer, mix until all in and smooth. Weigh out the Phase B ingredients and heated at a temperature of 75-80° C. and was added slowly to the phase A and continue to homogenize. The homogenize mixture was cooled at 60-65° C. Weigh out the Phase C ingredients and slowly add to the homogenize mixture of Phase A and Phase B and continue to homogenize. The pH was adjusted as needed. Sweep mix until the reactor vessel was cooled.

### Hydrosheer™ Spray Procedure

Phase A ingredients were mixed in a vessel until fully dissolved. In a separate vessel, Phase B ingredients were mixed and heated with low heat until crystals are dissolved. Add Phase B to Phase A, continue mixing until homogeneous.

### Lipstick Formula Procedure

Pre-weigh ingredients of phase A. and the ingredients were mixed and heat to 90-95° C., homogenize until all clear Pulverize phase B and then added to phase A and continue mixing to make sure all in using glass slide. Phase C ingredients were added and continue mix until clear for 5 minutes. Phase D ingredients were added and continue mix until clear for 15 minutes. Check for pigments dispersion using two glass slides. SB-700 was added and mixed well. Pour to mold at 80° C. and refrigerate for 10 minutes.

### Example G: Formulations with B1

### Example G 1

TABLE 1
Nonionic Sunscreen Emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 60.00 | 60.00 | 60.00 |
| Propylene glycol | 2.00 | 2.00 | 2.00 |
| Carbomer | 0.30 | 0.30 | 0.30 |
| Methylparaben | 1.00 | 1.00 | 1.00 |

Phase B

| | | | |
|---|---|---|---|
| Avobenzone | 3.00 | 3.00 | 3.00 |
| Ethylhexyl Salicylate | 5.00 | 5.00 | 5.00 |
| Octocrylene | 5.00 | 5.00 | 5.00 |
| Benzophenone-3 | 6.00 | 6.00 | 6.00 |
| Homosalate | 10.00 | 10.00 | 10.00 |
| PEG-100 Stearate (and) Glyceryl | 4.00 | 4.00 | 4.00 |
| Stearate | | | |
| C12-15 Alkyl Benzoate | 2.00 | | |
| Benzyl O-toluate | | 2.00 | |
| Phenethyl Benzoate | | | 2.00 |
| Example B1 | 1.00 | 1.00 | 1.00 |

Phase C

| | | | |
|---|---|---|---|
| Sodium hydroxide 10% | 0.70 | 0.70 | 0.70 |
| Total | 100.00 | 100.00 | 100.00 |

### Example G 2

TABLE 2
Water in Silicone mineral (zinc and titanium) emulsion

| | | | |
|---|---|---|---|
| | Formula #1 | Formula#2 | Formula#3 |
| Ingredients | % W/W | % W/W | % W/W |

Phase A

| | | | |
|---|---|---|---|
| Water | 47.50 | 47.50 | 47.50 |
| Glycerin | 5.00 | 5.00 | 5.00 |
| Hydroxyethylcellulose | 0.50 | 0.50 | 0.50 |
| Sodium Chloride | 0.50 | 0.50 | 0.50 |
| Caprylyl Glycol, Phenoxyethanol | 1.50 | 1.50 | 1.50 |

Phase B

| | | | |
|---|---|---|---|
| Zinc Oxide (and) ITT | 8.00 | 8.00 | 8.00 |
| Titanium dioxide (and) ITT | 8.00 | 8.00 | 8.00 |

Phase C

| | | | |
|---|---|---|---|
| Dimethicone(and)Dimethicone/ | 2.50 | 2.50 | 2.50 |
| PEG-10/15 Crosspolymer | | | |
| Lauryl PEG-9 | 3.00 | 3.00 | 3.00 |
| Polydimethylsiloxyethyl | | | |
| Dimethicone | | | |
| C12-15 Alkyl Benzoate | 5.00 | — | — |
| Benzyl O-toluate | — | 5.00 | — |
| Phenethyl Benzoate | — | — | 5.00 |
| Phenyl Trimethicone | 4.00 | 4.00 | 4.00 |
| Octyl Palmitate | 5.00 | 5.00 | 5.00 |
| Stearalkonium Hectorite & | 2.50 | 2.50 | 2.50 |
| Caprylic/capric Triglyceride & | | | |
| Propylene Carbonate | | | |
| Example B1 | 2.00 | 2.00 | 2.00 |
| Butyloctyl Salicylate | 5.00 | 5.00 | 5.00 |
| Total | 100 | 100 | 100 |

### Example G 3

TABLE 3
W/Si mineral (zinc) emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Dimethicone 1cst | 5.00 | 5.00 | 5.00 |
| Dimethicone 2cst | 10.00 | 10.00 | 10.00 |
| Cetyl PEG/PPG-10/1 | 0.50 | 0.50 | 0.50 |
| Dimethicone | | | |
| Polyglyceryl-4 Isostearate (and) | 3.00 | 3.00 | 3.00 |
| Cetyl PEG/PPG-10/1 | | | |
| Dimethicone (and) Hexyl Laurate | | | |
| Caprylic/Capric Triglyceride, | 3.50 | 3.50 | 3.50 |
| Stearalkonium hectorite, | | | |
| Propylene Carbonate | | | |

Phase B

| | | | |
|---|---|---|---|
| Diisopropyl adipate | 1.50 | 1.50 | 1.50 |
| Butyloctyl Salicylate | 5.00 | 5.00 | 5.00 |
| Example B1 | 2.00 | 2.00 | 2.00 |

Phase C

| | | | |
|---|---|---|---|
| Water | 37.82 | 37.82 | 37.82 |
| Hydroxyethyl Cellulose | 0.20 | 0.20 | 0.20 |
| Glycerin | 2.00 | 2.00 | 2.00 |
| C12-15 Alkyl Benzoate | 5.00 | | |
| Benzyl O-toluate | | 5.00 | |
| Phenethyl Benzoate | | | 5.00 |
| Phenoxyethanol (and) Benzoic | | | |
| Acid (and) Dehydroacetic Acid | 1.00 | 1.00 | 1.00 |
| 1,2-Hexanediol | 0.50 | 0.50 | 0.50 |
| Sodium Chloride | 1.00 | 1.00 | 1.00 |

Phase D

| | | | |
|---|---|---|---|
| Zinc Oxide and | 21.98 | 21.98 | 21.98 |
| Triethoxycaprylylsilane | | | |
| Total | 100 | 100 | 100 |

### Example G 4

TABLE 4
Anionic emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 53.30 | 53.30 | 53.30 |
| Glycerin and Glyceryl Acrylate/ | 5.00 | 5.00 | 5.00 |
| Acrylic Acid Copolymer and PVM/ | | | |
| MA Copolymer | | | |
| Tetrasodium EDTA | 0.10 | 0.10 | 0.10 |
| Acrylic Acid/VP Crosspolymer | 0.30 | 0.30 | 0.30 |
| Benzoic acid and Dehydroacetic | 1.00 | 1.00 | 1.00 |
| acid in Phenoxyethanol | | | |
| Methylparaben NF | 0.30 | 0.30 | 0.30 |

Phase B

| | | | |
|---|---|---|---|
| Potassium cetyl phosphate | 1.50 | 1.50 | 1.50 |
| Ethylhexyl triazone | 5.00 | 5.00 | 5.00 |
| Avobenzone | 3.00 | 3.00 | 3.00 |
| Bis-ethylhexyloxyphenol | 3.00 | 3.00 | 3.00 |
| Methoxyphenyl Triazine | | | |
| Octisalate | 5.00 | 5.00 | 5.00 |
| Homosalate | 10.00 | 10.00 | 10.00 |
| C12-15 Alkyl Benzoate | 5.00 | | |
| Benzyl O-toluate | | 5.00 | |
| Phenethyl Benzoate | | | 5.00 |
| Dimethicone | 2.00 | 2.00 | 2.00 |
| Behenyl Alcohol and polyglycerol-10 | 1.50 | 1.50 | 1.50 |
| Pentastearate and Sodium Stearoyl | | | |
| Lactate | | | |
| Example B1 | 2.00 | 2.00 | 2.00 |

Phase C

| | | | |
|---|---|---|---|
| NaOH 10% Solution | 2.00 | 2.00 | 2.00 |
| Total | 100.00 | 100.00 | 100.00 |

### Example G 5

TABLE 5
Hydrosheer ™ Spray

| | | | |
|---|---|---|---|
| | Formula#1 | Formula#2 | Formula#3 |
| Ingredients | % w/w | % w/w | % w/w |

Phase A

| | | | |
|---|---|---|---|
| Ethanol | 44.00 | 44.00 | 44.00 |
| Example B1 | 2.00 | 2.00 | 2.00 |

Phase B

| | | | |
|---|---|---|---|
| Avobenzone | 3.00 | 3.00 | 3.00 |
| Octisalate | 5.00 | 5.00 | 5.00 |
| Homosalate | 10.00 | 10.00 | 10.00 |
| Octocrylene | 8.00 | 8.00 | 8.00 |
| Bemotrizinol | 2.00 | 2.00 | 2.00 |
| C12-15 Alkyl Benzoate | 3.00 | | |
| Benzyl O-toluate | | 3.00 | |
| Phenethyl Benzoate | | | 3.00 |
| Diisopropyl Adipate | 5.00 | 5.00 | 5.00 |
| Lauryl Lactate | 5.00 | 5.00 | 5.00 |
| C12-15 Alkyl Lactate | 5.00 | 5.00 | 5.00 |
| Dicaprylyl Carbonate | 4.00 | 4.00 | 4.00 |
| Isodecyl Salicylate | 3.00 | 3.00 | 3.00 |
| Total | 100 | 100 | 100 |

### Example G 6

TABLE 6
Lipstick formula

| | |
|---|---|
| Ingredients | % W/W |

Phase A

| | |
|---|---|
| Ozokerite Wax | 12.97 |
| Polyethylene | 6.25 |
| Octyldodecyl stearate | 6.0 |
| Diisopropyl adipate | 5.0 |
| Octyldodecyl Stearoyl Stearate | 5.5 |
| Pentaerythrityl tetraoctanoate | 3.44 |
| C12-15 Alkyl lactate | 4.4 |
| Myristyl lactate | 3.4 |
| Hydrogenated Polyisobutene | 3.7 |
| Example B1 | 2.0 |
| Octocrylene | 6.52 |
| Ethylhexyl Salicylate | 4.66 |
| Avobenzone | 5.6 |
| Homosalate | 8.36 |

Phase B

| | |
|---|---|
| Caprylyl Glycol (and) Phenoxyethanol | 1.2 |

Phase C

| | |
|---|---|
| Ricinus communis seed oil (and) CI 15850 | 0.2 |
| Ricinus communis seed oil (and) CI 15850 | 0.58 |
| Ricinus communis (Castor) seed oil (and) CI 77891 (and) | 1.54 |
| Polyhydroxystearic Acid | |
| Ricinus communis (Castor)seed oil (and) CI 77491 and | 0.11 |
| C77492 and C177499 and Polyhydroxystearic Acid | |
| Mica (and)Iron Oxides C177491 (and) Titanium Dioxide | 2.99 |
| Synthetic Fluorphogopite and Titanium dioxide and Tin Oxide | 11.17 |
| C177491 and CI 77891 and Synthetic Fluorphlogopite | 3.41 |
| Water (and) Butylene Glycol (and) Hexapeptide-3 | 1 |
| Total | 100 |

### Example H: Formulations with C1

### Example H 1

TABLE 7
Nonionic Sunscreen Emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 60.00 | 60.00 | 60.00 |
| Propylene glycol | 2.00 | 2.00 | 2.00 |
| Carbomer | 0.30 | 0.30 | 0.30 |
| Methylparaben | 1.00 | 1.00 | 1.00 |

Phase B

| | | | |
|---|---|---|---|
| Avobenzone | 3.00 | 3.00 | 3.00 |
| Ethylhexyl Salicylate | 5.00 | 5.00 | 5.00 |
| Octocrylene | 5.00 | 5.00 | 5.00 |
| Benzophenone-3 | 6.00 | 6.00 | 6.00 |
| Homosalate | 10.00 | 10.00 | 10.00 |
| PEG-100 Stearate (and) Glyceryl | 4.00 | 4.00 | 4.00 |
| Stearate | | | |
| C12-15 Alkyl Benzoate | 2.00 | | |
| Benzyl O-toluate | | 2.00 | |
| Phenethyl Benzoate | | | 2.00 |
| Example C1 | 1.00 | 1.00 | 1.00 |

Phase C

| | | | |
|---|---|---|---|
| Sodium hydroxide 10% | 0.70 | 0.70 | 0.70 |
| Total | 100.00 | 100.00 | 100.00 |

### Example H 2

TABLE 8
Water in Silicone mineral (zinc and titanium) emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 47.50 | 47.50 | 47.50 |
| Glycerin | 5.00 | 5.00 | 5.00 |
| Hydroxyethylcellulose | 0.50 | 0.50 | 0.50 |
| Sodium Chloride | 0.50 | 0.50 | 0.50 |
| Caprylyl Glycol, Phenoxyethanol | 1.50 | 1.50 | 1.50 |

Phase B

| | | | |
|---|---|---|---|
| Zinc Oxide (and) ITT | 8.00 | 8.00 | 8.00 |
| Titanium dioxide (and) ITT | 8.00 | 8.00 | 8.00 |

Phase C

| | | | |
|---|---|---|---|
| Dimethicone(and)Dimethicone/ | 2.50 | 2.50 | 2.50 |
| PEG-10/15 Crosspolymer | | | |
| Lauryl PEG-9 | 3.00 | 3.00 | 3.00 |
| Polydimethylsiloxyethyl | | | |
| Dimethicone | | | |
| C12-15 Alkyl Benzoate | 5.00 | — | — |
| Benzyl O-toluate | — | 5.00 | — |
| Phenethyl Benzoate | — | — | 5.00 |
| Phenyl Trimethicone | 4.00 | 4.00 | 4.00 |
| Octyl Palmitate | 5.00 | 5.00 | 5.00 |
| Stearalkonium Hectorite & | 2.50 | 2.50 | 2.50 |
| Caprylic/capric Triglyceride & | | | |
| Propylene Carbonate | | | |
| Example C1 | 2.00 | 2.00 | 2.00 |
| Butyloctyl Salicylate | 5.00 | 5.00 | 5.00 |
| Total | 100 | 100 | 100 |

### Example H 3

TABLE 9
W/Si mineral (zinc) emulsion

| | | | |
|---|---|---|---|
| | Formula#1 | Formula#2 | Formula #3 |
| Ingredients | % W/W | % W/W | % W/W |

Phase A

| | | | |
|---|---|---|---|
| Dimethicone 1 cst | 5.00 | 5.00 | 5.00 |
| Dimethicone 2 cst | 10.00 | 10.00 | 10.00 |
| Cetyl PEG/PPG-10/1 Dimethicone | 0.50 | 0.50 | 0.50 |
| Polyglyceryl-4 Isostearate (and) Cetyl PEG/ | 3.00 | 3.00 | 3.00 |
| PPG-10/1 Dimethicone (and) Hexyl Laurate | | | |
| Caprylic/Capric Triglyceride, Stearalkonium | 3.50 | 3.50 | 3.50 |
| hectorite, Propylene Carbonate | | | |

Phase B

| | | | |
|---|---|---|---|
| Diisopropyl adipate | 1.50 | 1.50 | 1.50 |
| Butyloctyl Salicylate | 5.00 | 5.00 | 5.00 |
| Example C1 | 2.00 | 2.00 | 2.00 |

Phase C

| | | | |
|---|---|---|---|
| Water | 37.82 | 37.82 | 37.82 |
| Hydroxyethyl Cellulose | 0.20 | 0.20 | 0.20 |
| Glycerin | 2.00 | 2.00 | 2.00 |
| C12-15 Alkyl Benzoate | 5.00 | | |
| Benzyl O-toluate | | 5.00 | |
| Phenethyl Benzoate | | | 5.00 |
| Phenoxyethanol (and) Benzoic Acid (and) | 1.00 | 1.00 | 1.00 |
| Dehydroacetic Acid | | | |
| 1,2-Hexanediol | 0.50 | 0.50 | 0.50 |
| Sodium Chloride | 1.00 | 1.00 | 1.00 |

Phase D

| | | | |
|---|---|---|---|
| Zinc Oxide and Triethoxycaprylylsilane | 21.98 | 21.98 | 21.98 |
| Total | 100 | 100 | 100 |

### Example H 4

TABLE 10
Anionic emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 53.30 | 53.30 | 53.30 |
| Glycerin and Glyceryl Acrylate/ | 5.00 | 5.00 | 5.00 |
| Acrylic Acid Copolymer and | | | |
| PVM/MA Copolymer | | | |
| Tetrasodium EDTA | 0.10 | 0.10 | 0.10 |
| Acrylic Acid/VP Crosspolymer | 0.30 | 0.30 | 0.30 |
| OPTIPHEN ™ ND | 1.00 | 1.00 | 1.00 |
| Methylparaben NF | 0.30 | 0.30 | 0.30 |

Phase B

| | | | |
|---|---|---|---|
| Potassium cetyl phosphate | 1.50 | 1.50 | 1.50 |
| Univol T 150 | 5.00 | 5.00 | 5.00 |
| Escalol 517 (Avobenzone) | 3.00 | 3.00 | 3.00 |
| Bis-ethylhexyloxyphenol | 3.00 | 3.00 | 3.00 |
| Methoxyphenyl Triazine | | | |
| Escalol 587 (Octisalate) | 5.00 | 5.00 | 5.00 |
| Homosalate | 10.00 | 10.00 | 10.00 |
| C12-15 Alkyl Benzoate | 5.00 | | |
| Benzyl O-toluate | | 5.00 | |
| Phenethyl Benzoate | | | 5.00 |
| Dimethicone | 2.00 | 2.00 | 2.00 |
| Behenyl Alcohol and polyglycerol-10 | 1.50 | 1.50 | 1.50 |
| Pentastearate and Sodium Stearoyl | | | |
| Lactate | | | |
| Example C1 | 2.00 | 2.00 | 2.00 |

Phase C

| | | | |
|---|---|---|---|
| NaOH 10% Solution | 2.00 | 2.00 | 2.00 |
| Total | 100.00 | 100.00 | 100.00 |

### Example H 5

TABLE 11
Hydrosheer ™ Spray

| | | | |
|---|---|---|---|
| | Formula#1 | Formula#2 | Formula#3 |
| Ingredient | % w/w | % w/w | % w/w |

Phase A

| | | | |
|---|---|---|---|
| Ethanol | 44.00 | 44.00 | 44.00 |
| Example C1 | 2.00 | 2.00 | 2.00 |

Phase B

| | | | |
|---|---|---|---|
| Avobenzone | 3.00 | 3.00 | 3.00 |
| Octisalate | 5.00 | 5.00 | 5.00 |
| Homosalate | 10.00 | 10.00 | 10.00 |
| Octocrylene | 8.00 | 8.00 | 8.00 |
| Bemotrizinol | 2.00 | 2.00 | 2.00 |
| C12-15 Alkyl Benzoate | 3.00 | | |
| Benzyl O-toluate | | 3.00 | |
| Phenethyl Benzoate | | | 3.00 |
| Diisopropyl Adipate | 5.00 | 5.00 | 5.00 |
| Lauryl Lactate | 5.00 | 5.00 | 5.00 |
| C12-15 Alkyl Lactate | 5.00 | 5.00 | 5.00 |
| Dicaprylyl Carbonate | 4.00 | 4.00 | 4.00 |
| Isodecyl Salicylate | 3.00 | 3.00 | 3.00 |
| Total | 100 | 100 | 100 |

### Example H 6

TABLE 12
Lipstick formula

| | |
|---|---|
| Ingredients | % W/W |

Phase A

| | |
|---|---|
| Ozokerite Wax | 12.97 |
| Polyethylene | 6.25 |
| Octyldodecyl stearate | 6 |
| Diisopropyl adipate | 5 |
| Octyldodecyl Stearoyl Stearate | 5.5 |
| Pentaerythrityl tetraoctanoate | 3.44 |
| C12-15 Alkyl lactate | 4.4 |
| Myristyl lactate | 3.4 |
| Hydrogenated Polyisobutene | 3.7 |
| Example C1 | 2 |
| Octocrylene | 6.52 |
| Ethylhexyl Salicylate | 4.66 |
| Avobenzone | 5.6 |
| Homosalate | 8.36 |

Phase B

| | |
|---|---|
| Caprylyl Glycol (and) Phenoxyethanol | 1.2 |

Phase C

| | |
|---|---|
| Ricinus communis seed oil (and) CI 15850 | 0.2 |
| Ricinus communis seed oil (and) CI 15850 | 0.58 |
| Ricinus communis (Castor) seed oil (and) CI 77891 (and) | 1.54 |
| Polyhydroxystearic Acid | |
| Ricinus communis (Castor)seed oil (and) CI 77491 and C77492 | 0.11 |
| and C177499 and Polyhydroxystearic Acid | |
| Mica (and)Iron Oxides C177491 (and) Titanium Dioxide | 2.99 |
| Synthetic Fluorphogopite and Titanium dioxide and Tin Oxide | 11.17 |
| C177491 and CI 77891 and Synthetic Fluorphlogopite | 3.41 |
| Water (and) Butylene Glycol (and) Hexapeptide-3 | 1 |
| Total | 100 |

### Example I: Formulations with C4

### Example I 1

TABLE 13
Nonionic Sunscreen Emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 60.00 | 60.00 | 60.00 |
| Propylene glycol | 2.00 | 2.00 | 2.00 |
| Carbomer | 0.30 | 0.30 | 0.30 |
| Methylparaben | 1.00 | 1.00 | 1.00 |

Phase B

| | | | |
|---|---|---|---|
| Avobenzone | 3.00 | 3.00 | 3.00 |
| Ethylhexyl Salicylate | 5.00 | 5.00 | 5.00 |
| Octocrylene | 5.00 | 5.00 | 5.00 |
| Benzophenone-3 | 6.00 | 6.00 | 6.00 |
| Homosalate | 10.00 | 10.00 | 10.00 |
| PEG-100 Stearate (and) Glyceryl | 4.00 | 4.00 | 4.00 |
| Stearate | | | |
| C12-15 Alkyl Benzoate | 2.00 | | |
| Benzyl O-toluate | | 2.00 | |
| Phenethyl Benzoate | | | 2.00 |
| Example C4 | 1.00 | 1.00 | 1.00 |

Phase C

| | | | |
|---|---|---|---|
| Sodium hydroxide 10% | 0.70 | 0.70 | 0.70 |
| Total | 100.00 | 100.00 | 100.00 |

### Example I 2

TABLE 14
Water in Silicone mineral (zinc and titanium) emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 47.50 | 47.50 | 47.50 |
| Glycerin | 5.00 | 5.00 | 5.00 |
| Hydroxyethylcellulose | 0.50 | 0.50 | 0.50 |
| Sodium Chloride | 0.50 | 0.50 | 0.50 |
| Caprylyl Glycol, Phenoxyethanol | 1.50 | 1.50 | 1.50 |

Phase B

| | | | |
|---|---|---|---|
| Zinc Oxide (and) ITT | 8.00 | 8.00 | 8.00 |
| Titanium dioxide (and) ITT | 8.00 | 8.00 | 8.00 |

Phase C

| | | | |
|---|---|---|---|
| Dimethicone(and)Dimethicone/ | 2.50 | 2.50 | 2.50 |
| PEG-10/15 Crosspolymer | | | |
| Lauryl PEG-9 | 3.00 | 3.00 | 3.00 |
| Polydimethylsiloxyethyl Dimethicone | | | |
| C12-15 Alkyl Benzoate | 5.00 | — | — |
| Benzyl O-toluate | — | 5.00 | — |
| Phenethyl Benzoate | — | — | 5.00 |
| Phenyl Trimethicone | 4.00 | 4.00 | 4.00 |
| Octyl Palmitate | 5.00 | 5.00 | 5.00 |
| Stearalkonium Hectorite & Caprylic/ | 2.50 | 2.50 | 2.50 |
| capric Triglyceride & Propylene | | | |
| Carbonate | | | |
| Example C4 | 2.00 | 2.00 | 2.00 |
| Butyloctyl Salicylate | 5.00 | 5.00 | 5.00 |
| Total | 100 | 100 | 100 |

### Example I 3

TABLE 15
W/Si mineral (zinc) emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Dimethicone 1 cst | 5.00 | 5.00 | 5.00 |
| Dimethicone 2 cst | 10.00 | 10.00 | 10.00 |
| Cetyl PEG/PPG -10/1 Dimethicone | 0.50 | 0.50 | 0.50 |
| Polyglyceryl-4 Isostearate (and) | 3.00 | 3.00 | 3.00 |
| Cetyl PEG/PPG-10/1 Dimethicone | | | |
| (and) Hexyl Laurate | | | |
| Caprylic/Capric Triglyceride, | 3.50 | 3.50 | 3.50 |
| Stearalkonium hectorite, Propylene | | | |
| Carbonate | | | |

Phase B

| | | | |
|---|---|---|---|
| Diisopropyl adipate | 1.50 | 1.50 | 1.50 |
| Butyloctyl Salicylate | 5.00 | 5.00 | 5.00 |
| Example C4 | 2.00 | 2.00 | 2.00 |

Phase C

| | | | |
|---|---|---|---|
| Water | 37.82 | 37.82 | 37.82 |
| Hydroxyethyl Cellulose | 0.20 | 0.20 | 0.20 |
| Glycerin | 2.00 | 2.00 | 2.00 |
| C12-15 Alkyl Benzoate | 5.00 | | |
| Benzyl O-toluate | | 5.00 | |
| Phenethyl Benzoate | | | 5.00 |
| Phenoxyethanol (and) Benzoic Acid | 1.00 | 1.00 | 1.00 |
| (and) Dehydroacetic Acid | | | |
| 1,2-Hexanediol | 0.50 | 0.50 | 0.50 |
| Sodium Chloride | 1.00 | 1.00 | 1.00 |

Phase D

| | | | |
|---|---|---|---|
| Zinc Oxide and | 21.98 | 21.98 | 21.98 |
| Triethoxycaprylylsilane | | | |
| Total | 100 | 100 | 100 |

### Example I 4

TABLE 16
Anionic emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 53.30 | 53.30 | 53.30 |
| Glycerin and Glyceryl Acrylate/ | 5.00 | 5.00 | 5.00 |
| Acrylic Acid Copolymer and PVM/ | | | |
| MA Copolymer | | | |
| Tetrasodium EDTA | 0.10 | 0.10 | 0.10 |
| Acrylic Acid/VP Crosspolymer | 0.30 | 0.30 | 0.30 |
| OPTIPHEN ™ ND | 1.00 | 1.00 | 1.00 |
| Methylparaben NF | 0.30 | 0.30 | 0.30 |

Phase B

| | | | |
|---|---|---|---|
| Potassium cetyl phosphate | 1.50 | 1.50 | 1.50 |
| Univol T 150 | 5.00 | 5.00 | 5.00 |
| Avobenzone | 3.00 | 3.00 | 3.00 |
| Bis-ethylhexyloxyphenol | 3.00 | 3.00 | 3.00 |
| Methoxyphenyl Triazine | | | |
| Octisalate | 5.00 | 5.00 | 5.00 |
| Homosalate | 10.00 | 10.00 | 10.00 |
| C12-15 Alkyl Benzoate | 5.00 | | |
| Benzyl O-toluate | | 5.00 | |
| Phenethyl Benzoate | | | 5.00 |
| Dimethicone | 2.00 | 2.00 | 2.00 |
| Behenyl Alcohol and polyglycerol-10 | 1.50 | 1.50 | 1.50 |
| Pentastearate and Sodium Stearoyl | | | |
| Lactate | | | |
| Example C4 | 2.00 | 2.00 | 2.00 |

Phase C

| | | | |
|---|---|---|---|
| NaOH 10% Solution | 2.00 | 2.00 | 2.00 |
| Total | 100.00 | 100.00 | 100.00 |

### Example I5

TABLE 17
Hydrosheer ™ Spray

| | | | |
|---|---|---|---|
| | Formula#1 | Formula#2 | Formula#3 |
| Ingredient | % W/W | % W/W | % W/W |

Phase A

| | | | |
|---|---|---|---|
| Ethanol | 44.00 | 44.00 | 44.00 |
| Example C4 | 2.00 | 2.00 | 2.00 |

Phase B

| | | | |
|---|---|---|---|
| Avobenzone | 3.00 | 3.00 | 3.00 |
| Octisalate | 5.00 | 5.00 | 5.00 |
| Homosalate | 10.00 | 10.00 | 10.00 |
| Octocrylene | 8.00 | 8.00 | 8.00 |
| Bemotrizinol | 2.00 | 2.00 | 2.00 |
| C12-15 Alkyl Benzoate | 3.00 | | |
| Benzyl O-toluate | | 3.00 | |
| Phenethyl Benzoate | | | 3.00 |
| Diisopropyl Adipate | 5.00 | 5.00 | 5.00 |
| Lauryl Lactate | 5.00 | 5.00 | 5.00 |
| C12-15 Alkyl Lactate | 5.00 | 5.00 | 5.00 |
| Dicaprylyl Carbonate | 4.00 | 4.00 | 4.00 |
| Isodecyl Salicylate | 3.00 | 3.00 | 3.00 |
| Total | 100 | 100 | 100 |

### Example I 6

TABLE 18
Lipstick formula

| | |
|---|---|
| Ingredients | % W/W |

Phase A

| | |
|---|---|
| Ozokerite Wax | 12.97 |
| Polyethylene | 6.25 |
| Octyldodecyl stearate | 6 |
| Diisopropyl adipate | 5 |
| Octyldodecyl Stearoyl Stearate | 5.5 |
| Pentaerythrityl tetraoctanoate | 3.44 |
| C12-15 Alkyl lactate | 4.4 |
| Myristyl lactate | 3.4 |
| Hydrogenated Polyisobutene | 3.7 |
| Example C4 | 2 |
| Octocrylene | 6.52 |
| Ethylhexyl Salicylate | 4.66 |
| Avobenzone | 5.6 |
| Homosalate | 8.36 |

Phase B

| | |
|---|---|
| Caprylyl Glycol (and) Phenoxyethanol | 1.2 |

Phase C

| | |
|---|---|
| Ricinus communis seed oil (and) CI 15850 | 0.2 |
| Ricinus communis seed oil (and) CI 15850 | 0.58 |
| Ricinus communis (Castor) seed oil (and) CI 77891 | 1.54 |
| (and) Polyhydroxystearic Acid | |
| Ricinus communis (Castor)seed oil (and) CI 77491 | 0.11 |
| and C77492 and C177499 and Polyhydroxystearic Acid | |
| Mica (and)Iron Oxides C177491 (and) Titanium Dioxide | 2.99 |
| Synthetic Fluorphogopite and Titanium dioxide and Tin Oxide | 11.17 |
| C177491 and CI 77891 and Synthetic Fluorphlogopite | 3.41 |
| Water (and) Butylene Glycol (and) Hexapeptide-3 | 1 |
| Total | 100 |

### Example J: Formulations with D1 or D2

### Example J 1

TABLE 19
Nonionic Sunscreen Emulsion

| | | | |
|---|---|---|---|
| | Formula 1 | Formula 2 | Formula 3 |
| Ingredients | % W/W | % W/W | % W/W |

Phase A

| | | | |
|---|---|---|---|
| Water | 60.00 | 60.00 | 60.00 |
| Propylene glycol | 2.00 | 2.00 | 2.00 |
| Carbomer | 0.30 | 0.30 | 0.30 |
| Methylparaben | 1.00 | 1.00 | 1.00 |

Phase B

| | | | |
|---|---|---|---|
| Avobenzone | 3.00 | 3.00 | 3.00 |
| Ethylhexyl Salicylate | 5.00 | 5.00 | 5.00 |
| Octocrylene | 5.00 | 5.00 | 5.00 |
| Benzophenone-3 | 6.00 | 6.00 | 6.00 |
| Homosalate | 10.00 | 10.00 | 10.00 |
| PEG-100 Stearate (and) Glyceryl | 4.00 | 4.00 | 4.00 |
| Stearate | | | |
| C12-15 Alkyl Benzoate | 2.00 | | |
| Benzyl O-toluate | | 2.00 | |
| Phenethyl Benzoate | | | 2.00 |
| Example D1 or D2 | 1.00 | 1.00 | 1.00 |

Phase C

| | | | |
|---|---|---|---|
| Sodium hydroxide 10% | 0.70 | 0.70 | 0.70 |
| Total | 100.00 | 100.00 | 100.00 |

### Example J 2

TABLE 20
Water in Silicone mineral (zinc and titanium) emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 47.50 | 47.50 | 47.50 |
| Glycerin | 5.00 | 5.00 | 5.00 |
| Hydroxyethylcellulose | 0.50 | 0.50 | 0.50 |
| Sodium Chloride | 0.50 | 0.50 | 0.50 |
| Caprylyl Glycol, Phenoxyethanol | 1.50 | 1.50 | 1.50 |

Phase B

| | | | |
|---|---|---|---|
| Zinc Oxide (and) ITT | 8.00 | 8.00 | 8.00 |
| Titanium dioxide (and) ITT | 8.00 | 8.00 | 8.00 |

Phase C

| | | | |
|---|---|---|---|
| Dimethicone(and)Dimethicone/PEG- | 2.50 | 2.50 | 2.50 |
| 10/15 Crosspolymer | | | |
| Lauryl PEG-9 | 3.00 | 3.00 | 3.00 |
| Polydimethylsiloxyethyl Dimethicone | | | |
| C12-15 Alkyl Benzoate | 5.00 | — | — |
| Benzyl O-toluate | — | 5.00 | — |
| Phenethyl Benzoate | — | — | 5.00 |
| Phenyl Trimethicone | 4.00 | 4.00 | 4.00 |
| Octyl Palmitate | 5.00 | 5.00 | 5.00 |
| Stearalkonium Hectorite & | 2.50 | 2.50 | 2.50 |
| Caprylic/capric Triglyceride & | | | |
| Propylene Carbonate | | | |
| Example D1 or D2 | 2.00 | 2.00 | 2.00 |
| Butyloctyl Salicylate | 5.00 | 5.00 | 5.00 |
| Total | 100 | 100 | 100 |

### Example J 3

TABLE 21
W/Si mineral (zinc) emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Dimethicone 1 cst | 5.00 | 5.00 | 5.00 |
| Dimethicone 2 cst | 10.00 | 10.00 | 10.00 |
| Cetyl PEG/PPG -10/1 Dimethicone | 0.50 | 0.50 | 0.50 |
| Polyglyceryl-4 Isostearate (and) | 3.00 | 3.00 | 3.00 |
| Cetyl PEG/PPG-10/1 Dimethicone | | | |
| (and) Hexyl Laurate | | | |
| Caprylic/Capric Triglyceride, | 3.50 | 3.50 | 3.50 |
| Stearalkonium hectorite, Propylene | | | |
| Carbonate | | | |

Phase B

| | | | |
|---|---|---|---|
| Diisopropyl adipate | 1.50 | 1.50 | 1.50 |
| Butyloctyl Salicylate | 5.00 | 5.00 | 5.00 |
| Example D1 or D2 | 2.00 | 2.00 | 2.00 |

Phase C

| | | | |
|---|---|---|---|
| Water | 37.82 | 37.82 | 37.82 |
| Hydroxyethyl Cellulose | 0.20 | 0.20 | 0.20 |
| Glycerin | 2.00 | 2.00 | 2.00 |
| C12-15 Alkyl Benzoate | 5.00 | | |
| Benzyl O-toluate | | 5.00 | |
| Phenethyl Benzoate | | | 5.00 |
| Phenoxyethanol (and) Benzoic Acid | 1.00 | 1.00 | 1.00 |
| (and) Dehydroacetic Acid | | | |
| 1,2-Hexanediol | 0.50 | 0.50 | 0.50 |
| Sodium Chloride | 1.00 | 1.00 | 1.00 |

Phase D

| | | | |
|---|---|---|---|
| Zinc Oxide and | 21.98 | 21.98 | 21.98 |
| Triethoxycaprylylsilane | | | |
| Total | 100 | 100 | 100 |

### Example J 4

TABLE 22
Anionic emulsion

| | | | |
|---|---|---|---|
| | Formula#1 | Formula#2 | Formula#3 |
| Ingredients | % W/W | % W/W | % W/W |

Phase A

| | | | |
|---|---|---|---|
| Water | 53.30 | 53.30 | 53.30 |
| Glycerin and Glyceryl Acrylate/ | 5.00 | 5.00 | 5.00 |
| Acrylic Acid Copolymer and PVM/ | | | |
| MA Copolymer | | | |
| Tetrasodium EDTA | 0.10 | 0.10 | 0.10 |
| Acrylic Acid/VP Crosspolymer | 0.30 | 0.30 | 0.30 |
| OPTIPHEN ™ ND | 1.00 | 1.00 | 1.00 |
| Methylparaben NF | 0.30 | 0.30 | 0.30 |

Phase B

| | | | |
|---|---|---|---|
| Potassium cetyl phosphate | 1.50 | 1.50 | 1.50 |
| Univol T 150 | 5.00 | 5.00 | 5.00 |
| Avobenzone | 3.00 | 3.00 | 3.00 |
| Bis-ethylhexyloxyphenol | 3.00 | 3.00 | 3.00 |
| Methoxyphenyl Triazine | | | |
| Octisalate | 5.00 | 5.00 | 5.00 |
| Homosalate | 10.00 | 10.00 | 10.00 |
| C12-15 Alkyl Benzoate | 5.00 | | |
| Benzyl O-toluate | | 5.00 | |
| Phenethyl Benzoate | | | 5.00 |
| Dimethicone | 2.00 | 2.00 | 2.00 |
| Behenyl Alcohol and polyglycerol-10 | 1.50 | 1.50 | 1.50 |
| Pentastearate and Sodium | | | |
| Stearoyl Lactate | | | |
| Example D1 or D2 | 2.00 | 2.00 | 2.00 |

Phase C

| | | | |
|---|---|---|---|
| NaOH 10% Solution | 2.00 | 2.00 | 2.00 |
| Total | 100.00 | 100.00 | 100.00 |

### Example J 5

TABLE 23
Hydrosheer ™ Spray

| | | | |
|---|---|---|---|
| | Formula#1 | Formula#2 | Formula#3 |
| Ingredients | % W/W | % W/W | % W/W |

Phase A

| | | | |
|---|---|---|---|
| Ethanol | 44.00 | 44.00 | 44.00 |
| Example D1 or D2 | 2.00 | 2.00 | 2.00 |

Phase B

| | | | |
|---|---|---|---|
| Avobenzone | 3.00 | 3.00 | 3.00 |
| Octisalate | 5.00 | 5.00 | 5.00 |
| Homosalate | 10.00 | 10.00 | 10.00 |
| Octocrylene | 8.00 | 8.00 | 8.00 |
| Bemotrizinol | 2.00 | 2.00 | 2.00 |
| C12-15 Alkyl Benzoate | 3.00 | | |
| Benzyl O-toluate | | 3.00 | |
| Phenethyl Benzoate | | | 3.00 |
| Diisopropyl Adipate | 5.00 | 5.00 | 5.00 |
| Lauryl Lactate | 5.00 | 5.00 | 5.00 |
| C12-15 Alkyl Lactate | 5.00 | 5.00 | 5.00 |
| Dicaprylyl Carbonate | 4.00 | 4.00 | 4.00 |
| Isodecyl Salicylate | 3.00 | 3.00 | 3.00 |
| Total | 100 | 100 | 100 |

### Example J 6

TABLE 24
Lipstick formula

| | |
|---|---|
| Ingredients | % W/W |

Phase A

| | |
|---|---|
| Ozokerite Wax | 12.97 |
| Polyethylene | 6.25 |
| Octyldodecyl stearate | 6.0 |
| Diisopropyl adipate | 5.0 |
| Octyldodecyl Stearoyl Stearate | 5.5 |
| Pentaerythrityl tetraoctanoate | 3.44 |
| C12-15 Alkyl lactate | 4.4 |
| Myristyl lactate | 3.4 |
| Hydrogenated Polyisobutene | 3.7 |
| Example D1 or D2 | 2 |
| Octocrylene | 6.52 |
| Ethylhexyl Salicylate | 4.66 |
| Avobenzone | 5.6 |
| Homosalate | 8.36 |

Phase B

| | |
|---|---|
| Caprylyl Glycol (and) Phenoxyethanol | 1.2 |

Phase C

| | |
|---|---|
| Ricinus communis seed oil (and) CI 15850 | 0.2 |
| Ricinus communis seed oil (and) CI 15850 | 0.58 |
| Ricinus communis (Castor) seed oil (and) CI 77891 (and) | 1.54 |
| Polyhydroxystearic Acid | |
| Ricinus communis (Castor)seed oil (and) CI 77491 and C77492 | 0.11 |
| and C177499 and Polyhydroxystearic Acid | |
| Mica (and)Iron Oxides C177491 (and) Titanium Dioxide | 2.99 |
| Synthetic Fluorphogopite and Titanium dioxide and Tin Oxide | 11.17 |
| C177491 and CI 77891 and Synthetic Fluorphlogopite | 3.41 |
| Water (and) Butylene Glycol (and) Hexapeptide-3 | 1 |
| Total | 100 |

### Nonionic Sunscreen Test Emulsion

Experimental procedure-Nonionic sunscreen test emulsion 12898-61: Water and glycol were added to main beaker. Begin homogenizing and heated to 75-80 C. Sprinkle in carbomer, mix until all in and smooth. Paraben was added. In a separate beaker, weigh ingredients of phase B. Heated to 75-80 C with mixing until uniform. Phase A was added and continue to homogenize. Begin cooling to 60-65 C. Phase C was added and continue to homogenize. Check pH, adjust as needed to 5.5-6.0. Change to sweep blade and continue mixing until cool.

### Example K

| | | % W/W | % W/W |
|---|---|---|---|
| Phase | INCI | 12898-35 | 12898-61 |
| A | Deionized Water | 59.0 | 60.0 |
| | Propylene glycol | 2.0 | 2.0 |
| | Carbomer | 0.3 | 0.3 |
| | Phenoxyethanol (and) Methylparaben | 1.0 | 1.0 |
| | (and) Ethyl paraben (and) Propylparaben | | |
| B | Butyl Methoxydibenzoylmethane | 3.0 | 3.0 |
| | Ethylhexyl Salicylate | 5.0 | 5.0 |
| | Octocrylene | 5.0 | 5.0 |
| | Benzophenone-3 | 6.0 | 6.0 |
| | Homosalate | 10.0 | 10.0 |
| | PEG-100 Stearate (and) Glyceryl Stearate | 4.0 | 4.0 |
| | Diisopropyl Adipate | 2.0 | 2.0 |
| | Maleated Soybean Oil Glyceryl/ | — | 1.0 |
| | Octyldodecanol polymer | | |
| C | Sodium hydroxide 10% | 0.7 | 0.7 |

| | | |
|---|---|---|
| Total | 100 | 100 |

### Anionic Sunscreen Test Emulsion

Experimental procedure-Anionic sunscreen test emulsion 12898-32 procedure: Ingredients of Phase A was added to main beaker. Begin homogenized and heated to 70-75 C. Sprinkle in acrylic acid/VP crosspolymer, mix until all in and smooth. Separately weigh ingredients of Phase C and heated to 70-75 C until clear. Phase A was added and continue to homogenize. Begin cooling to 60-65 C. Phase D was added and continue to homogenize. Check pH, adjust as needed to 5.5-6.5. Changed to sweep blade and continue mixing until cool.

### Example L

| | | % W/W | % W/W |
|---|---|---|---|
| Phase | Ingredients | 12777-211 | 12898-32 |
| A | Deionized Water | 50.0 | 48.0 |
| | Glycerin | 5.0 | 5.0 |
| | Propylene glycol | 5.0 | 5.0 |
| | Disodium EDTA | 0.1 | 0.1 |
| | Phenoxyethanol (and) Caprylyl Glycol | 1.0 | 1.0 |
| | Sodium hydroxide 10% | 0.3 | 0.3 |
| B | Acrylic Acid/VP Crosspolymer | 0.5 | 0.5 |
| C | Butyl Methoxydibenzoylmethane | 3.0 | 3.0 |
| | Benzophenone-3 | 6.0 | 6.0 |
| | Ethylhexyl Salicylate | 5.0 | 5.0 |
| | Octocrylene | 5.0 | 5.0 |
| | Homosalate | 10.0 | 10.0 |
| | Diisopropyl Adipate | 4.0 | 4.0 |
| | Cetearyl Alcohol, Dicetyl Phosphate | 3.5 | 3.5 |
| | and Ceteth -10 Phosphate | | |
| | Ceteareth-20 | 0.6 | 0.6 |
| | Maleated Soybean Oil Glyceryl/ | — | 2.0 |
| | Octyldodecanol Polymer | | |
| D | Sodium hydroxide 10% | 1.0 | 1.0 |
| | total | 100 | 100 |

Water/Silicone with Zinc Oxide Test Emulsion

Experimental procedure-water-in-silicone 12867-155 procedure: Dimethicones were added to main beaker and begin mixing with a high lift mixing blade at high speed. Remaining ingredients of phase A are added. In a separate beaker ingredients of phase B were added and heated to 80-85 C. Once uniform cool to 70 C and phase A was added and continue mixing. In a separate beaker, phase C ingredients were added. Water was added at first and begin mixing then hydroxyethylcellulose was added and heated to 80-85 C. Once dispersed, glycerin and butylene glycol were added. Continue mixing and heated to 85 C until the cellulose is solubilized. Phenoxyethanol and salt were added. Ensure that all the salt is dissolved and begin cooling slowly to room temperature. Once all the ingredients in phase C were uniform, increase mixing on phase A and slowly pour phase C into phase A. Continue mixing until uniform. Zinc Oxide was added to the main batch and continue prop mixing for 5 minutes until the batch is homogenous.

Switched to the homogenizr 1\ and continue homogenizing for 10 minutes.

### Example M: Sunscreen Test Emulsion-Water/Silicone Zinc Oxide

| | | % W/W | % W/W |
|---|---|---|---|
| Phase | Ingredients | 12867-113 | 12867-155 |
| A | Dimethicone 1 cst | 5.0 | 5.0 |
| | Dimethicone 2 cst | 10.0 | 10.0 |
| | Cetyl PEG/PPG -10/1 Dimethicone | 0.5 | 0.5 |
| | Polyglyceryl-4 Isostearate (and) Cetyl PEG/PPG-10/1 | 3.0 | 3.0 |
| | Dimethicone (and) Hexyl Laurate | | |
| | Caprylic/Capric Triglyceride, Stearalkonium | 3.5 | 3.5 |
| | hectorite, Propylene Carbonate | | |
| B | Diisopropyl Adipate | 2.0 | 2.0 |
| | Butyloctyl Salicylate | 5.0 | 5.0 |
| | Maleated Soybean Oil Glyceryl/Octyldodecanol polymer | — | 2.0 |
| C | Deionized Water | 40.32 | 40.32 |
| | Hydroxyethylcellulose | 0.2 | 0.2 |
| | Glycerin | 2.0 | 2.0 |
| | Butylene Glycol | 2.0 | 2.0 |
| | Phenoxyethanol (and) Benzoic Acid (and) Dehydroacetic Acid | 1.0 | 1.0 |
| | 1,2-Hexanediol | 0.5 | 0.5 |
| | Sodium Chloride | 1.0 | 1.0 |
| D | Zinc Oxide and Triethoxycaprylylsilane | 21.98 | 21.98 |

| | | |
|---|---|---|
| Total | 100 | 100 |

Nonionic Test Emulsion with Inorganic Sunscreens

Experimental procedure-Nonionic test emulsion with inorganic sunscreens 12951-10 procedure: Water was added to the main beaker and begin to homogenize mixing. Heated to 80-85 C and add disodium EDTA. Then premix the butylene glycol with the cellulose gum and cetyl hydroxyethylcellulose. Added to the batch. Maintain 80-85 C and allow to mix for 10 minutes. In separate beaker, Phase B esters were added, then heated to ˜80 C. Continue heating to 80° C. and remaining ingredients were added. Then zinc oxide and Tio2 were added and continue mixing. Once get uniform and at 80-85 C phase A were added and homogenize for 10 minutes. Begin cooling to 60-65 C and continue to homogenize. Mixed until uniform. Changed to sweep mixing and continue until cool. At 45 phase C were added and mixed until room temperature.

### Example N

| | | % W/W | % W/W |
|---|---|---|---|
| Phase | INCI | 12951-15 | 12951-10 |
| A | Deionized Water | 52.7 | 50.7 |
| | Disodium EDTA | 0.05 | 0.05 |
| | Butylene Glycol | 3.0 | 3.0 |
| | Cetyl Hydroxyethylcellulose | 0.2 | 0.2 |
| | Cellulose gum | 0.8 | 0.8 |
| | Raspberry Ketone (and) Propanediol (and) Propanol | 2.0 | 2.0 |
| B | Isononyl Isononanoate (and) Ethylhexyl | 5.0 | 5.0 |
| | Isononanoate | | |
| | Butyloctyl Salicylate | 5.0 | 5.0 |
| | C12-15 Alkyl Lactate | 5.0 | 5.0 |
| | Octyldodecyl Stearoyl Stearate | 3.0 | 3.0 |
| | Diisopropyl Adipate | 2.0 | 2.0 |
| | Glyceryl stearate (and) Cetyl Alcohol (and) stearyl | 4.0 | 4.0 |
| | Alcohol (and) behenyl alcohol (and) palmitic acid | | |
| | (and) stearic acid (and) hydroxyethyl | | |
| | Cetearamidopropyldimonium Chloride | | |
| | Maleated Soybean Oil Glyceryl/Octyldodecanol | / | 2.0 |
| | polymer | | |
| | Titanium Dioxide | 8.0 | 8.0 |
| | Zinc Oxide and Triethoxycaprylylsilane | 8.0 | 8.0 |
| C | Fragrance | 0.25 | 0.25 |
| | Marsdenia Cundurango Bark Extract (and) | 1.0 | 1.0 |
| | Caprylic/Capric Triglyceride | | |
| | Total | 100 | 100 |

### Anhydrous Sunscreen

Experimental procedure: In main beaker, combine ingredients of Phase A. Mixed well. Separately combine all ingredients of Phase B. Heated to 45 C with mixing until clear. Cool and Phase B was added to Phase A. Phase C ingredients were added.

### Example O

| | | % W/W | % W/W |
|---|---|---|---|
| Phase | Ingredients | 12946-33-1 | 12946-33-2 |
| A | SD Alcohol 40B | 39.0 | 41.0 |
| | Maleated Soybean Oil Glyceryl/ | 2.0 | — |
| | Octyldodecanol polymer | | |
| B | Butyl Methoxydibenzoylmethane | 3.0 | 3.0 |
| | Benzephenone-3 | 6.0 | 6.0 |
| | Ethylhexyl Salicylate | 5.0 | 5.0 |
| | Homosalate | 12.0 | 12.0 |
| | C12-15 Alkyl Benzoate | 2.0 | 2.0 |
| | Octocrylene | 8.0 | 8.0 |
| C | Isodecyl Neopentanoate | 4.0 | 4.0 |
| | Isocetyl alcohol | 2.5 | 2.5 |
| | Dicaprylyl carbonate | 3.5 | 3.5 |
| | 2-ethylhexyl isononanoate | 5.0 | 5.0 |
| | Caprylyl methicone | 8.0 | 8.0 |

| | | |
|---|---|---|
| Total | 100 | 100 |

### Example O1: Alcohol-Free Anhydrous Sunscreen

| | | % W/W | % W/W |
|---|---|---|---|
| Phase | INCI | BRJNC10 | BRJNC11 |
| A | Maleated Soybean Oil | 2.0 | / |
| | Glyceryl/Octyldodecanol Polymer | | |
| | Bis-Ethylhexyloxyphenol Methoxyphenyl | 4.5 | 4.5 |
| | Triazine | | |
| | Ethylhexyl Triazone | 4.5 | 4.5 |
| | Diethylamino hydroxybenzoyl hexyl | 4.5 | 4.5 |
| | benzoate | | |
| | Ethylhexyl Salicylate | 5.0 | 5.0 |
| | Homosalate | 10.0 | 10.0 |
| | Diisopropyl Adipate | 15.0 | 15.0 |
| | C12-15 Alkyl Lactate | 11.32 | 13.32 |
| | Phenethyl Benzoate | 6.0 | 6.0 |
| | Tridecyl Neopentonate | 2.0 | 2.0 |
| B | Dodecane | 15.0 | 15.0 |
| | Polycitronellol Acetate, Undecane, | 8.0 | 8.0 |
| | Tridecane | | |
| | C13-15 Alkane | 8.0 | 8.0 |
| | 1,2 Hexanediol | 3.0 | 3.0 |
| C | Fragrance | 0.15 | 0.15 |
| | Octyldodecanol, Santalum Album | 1.0 | 1.0 |
| | (Sandalwood) Wood Extract | | |
| | CI 75120, Helianthus annuus seed oil, | 0.03 | 0.03 |
| | Ascorbyl palmitate, Tocopherol | | |

| | | |
|---|---|---|
| Total | 100 | 100 |

### Color Cosmetics

Experimental procedure: mascara 12919-127 procedure: In main beaker pre-weigh water & disodium EDTA and mix with homogenizer until clear. Cellulose gum was added and mixed until clear. Then Xanthan Gum was added and mixed until uniform. Separately weigh ingredient of phase B and was added to phase A. Begin heating the batch to 75 C-80 C. Weigh ingredients of Phase C and heated the batch to 75 C-80 C. Then Phase A was added and continue to homogenize. Cool down to 60 C. Phase D was added to ABC while homogenizing. Homo-mix for about 10 minutes. Begin cooling the batch to 45 C. Switch to sweep agitation and cooled to 25 C-30 C.

### Example P: Mascara

| | | % W/W | % W/W |
|---|---|---|---|
| Phase | INCI | 12919-128 | 12919-127 |
| A | Water | 66.7 | 63.7 |
| | Disodium EDTA | 0.1 | 0.1 |
| | Cellulose Gum | 0.3 | 0.3 |
| | Xanthan Gum | 0.2 | 0.2 |
| B | LC989 Iron Oxide | 12 | 12 |
| C | Glyceryl Stearate (and) Laureth-23 | 3.0 | 3.0 |
| | C18-36 Acid Triglyceride | 4.0 | 4.0 |
| | Cera Alba (Beeswax) | 4.0 | 4.0 |
| | Stearic Acid | 2.0 | 2.0 |
| | Copernicia Cerifera (Carnauba) wax | 2.0 | 2.0 |
| | Euphorbia Cerifera (Candelilla) wax | 2.0 | 2.0 |
| | PEG-20 Stearate | 2.0 | 2.0 |
| | Maleated Soybean Oil | / | 3.0 |
| | Glyceryl/Octyldodecanol Polymer | | |
| D | Tocopheryl Acetate | 0.2 | 0.2 |
| | 1,2 Octanediol, 2-Phenoxyethanol | 1.5 | 1.5 |

| | | |
|---|---|---|
| Total | 100 | 100 |

Experimental procedure: Lipstick: Pre-weigh ingredients of phase A. Heat to 90/95 C while mixing until all clear. Pulverize Phase B well. Then phase A was added while mixing to make sure all is in using glass slide. Phase C was added and continue mixing for another 5 minutes. Pigments of phase D were added and continue mixing for about 15 minutes Check for pigments dispersion using two glass slides and pour to mold at 80 C refrigerate for 10 minutes.

Lipstick 12919-121 color retention procedure: To test the transfer resistance of 3 lipsticks on the lips of subjects. (a) Panelists will read and sign the Informed Consent form; (b) Visia images are taken with clean lips. (c) Panelists self-apply lipstick X (per randomization) over entire lips and wait 10 min. (d) Visia images of initial lipstick color; (e) Panelists bite for 2s on the edge of a paper coffee cup that was previously cut open to flatten the paper. (f) Visia images of panelist lips after paper cup imprint; (g) Lipsticks 2 and 3 are tested on 2 other days by following the same steps b-f. All cross polarized images from Visia are analyzed in Image Pro Plus v7 to extract a-chanel color images in the Lab color space.

RESULTS: All scaled values have been averaged and analyzed for statistical significance by paired t-tests versus the control formulation.

### Example Q: Lipstick

| | | % w/w | % w/w |
|---|---|---|---|
| | | 12919- | 12919- |
| Phase | INCI | 116 | 121 |
| A | Ozokerite | 13.9 | 13.9 |
| | Polyethylene | 6.5 | 6.5 |
| | Octyldodecyl Stearate | 8.7 | 8.7 |
| | Diisopropyl Adipate | 15.8 | 15.8 |
| | Octyldodecyl Stearoyl Stearate | 5.7 | 5.7 |
| | Pentaerythrityl Tetraethylhexanoate | 4.7 | 4.7 |
| | C12-15 Alkyl lactate | 6.7 | 6.7 |
| | Myristyl Lactate (and) Myristyl Alcohol | 5.56 | 5.56 |
| | Hydrogenated Polyisobutene | 3.76 | 3.76 |
| | Maleated Soybean Oil | — | 2 |
| | Glyceryl/Octyldodecanol Polymer | | |
| | Ethylhexyl Salicylate | 4.54 | 4.54 |
| B | Zinc Oxide (and) Isopropyl Titanium | 4.54 | 4.54 |
| | Triisostearate | | |
| | Titanium Dioxide (and) Isopropyl | 3.65 | 3.65 |
| | Titanium Triisostearate | | |
| C | Phenoxyethanol (and) Caprylyl Glycol | 1.2 | 1.2 |
| D | Ricinus Communis (Castor) Seed Oil (and) | 1.09 | 1.09 |
| | CI 15850 (Red 7) | | |
| | Ricinus Communis (Castor) Seed Oil (and) | 0.15 | 0.15 |
| | CI 77499 (Iron Oxides) (and) | | |
| | Polyhydroxystearic Acid | | |
| | Ricinus Communis (Castor) Seed Oil (and) | 1.82 | 1.82 |
| | CI 77491 (Iron Oxides) | | |
| | Mica (and) CI 77891 (Titanium Dioxide) | 4.54 | 4.54 |
| | (and) CI 77491 (Iron Oxides) | | |
| | Mica (and) CI 77891 (Titanium Dioxide) | 2.72 | 2.72 |
| | Calcium Aluminum Borosilicate (and) CI | 1.45 | 1.45 |
| | 77891 (Titanium Dioxide) | | |
| | Water/Aqua (and) Butylene Glycol (and) | 1.0 | 1.0 |
| | Rosa Centifolia Flower extract | | |

| | | |
|---|---|---|
| Total | 100.00% | 100.00% |

### Example Q1: Foundation

Experimental procedure: Foundation 12919-139 procedure: In main beaker, pre-weigh water and add Disodium EDTA. Begin to homo mix. Premix cellulose gum and xanthan gum with glycerin and added to main beaker. Homogenize for 45 minutes. Phase B was added and heat batch to 70-75 C while homogenizing. In a separate beaker add ingredients of phase D and heat to 65 C-70 C while mixing. Pulverize phase C and add to phase D while homogenizing, then add to phase AB. Homogenize for 15 minutes until uniform. Begin cooling the batch and switch to sweep agitation and cool to RT.

### Example Q1

| | | % W/W | % W/W |
|---|---|---|---|
| Phase | INCI | 12919-140 | 12919-139 |
| A | Water | 55.3 | 51.3 |
| | Glycerin | 2.0 | 2.0 |
| | Disodium EDTA | 0.1 | 0.1 |
| | Cellulose Gum | 0.3 | 0.3 |
| | Xanthan Gum | 0.2 | 0.2 |
| B | Caprylyl Glycol (and)Phenoxyethanol (and) Sorbic Acid | 1.5 | 1.5 |
| C | Silica | 1.5 | 1.5 |
| | Titanium Dioxide (and) Isopropyl Titanium Triisostearate | 8.2 | 8.2 |
| | CI 77499 (and) Isopropyl Titanium Triisostearate | 0.24 | 0.24 |
| | CI 77491 (and) Isopropyl Titanium Triisostearate | 0.26 | 0.26 |
| | CI 77492 (and) Isopropyl Titanium Triisostearate | 1.14 | 1.14 |
| D | Glyceryl Stereate (and) laureth-23 | 2.0 | 2.0 |
| | Ceteareth-20 | 1.0 | 1.0 |
| | C-12-15 Alkyl Lactate | 1.5 | 1.5 |
| | Isocetyl Stearate | 0.75 | 0.75 |
| | Octocrylene | 8.0 | 8.0 |
| | Ethylhexyl Salicylate | 5.0 | 5.0 |
| | Butyl Methoxydibenzoylmethane | 3.0 | 3.0 |
| | Dimethicone | 7.0 | 7.0 |
| | Maleated Soybean Oil Glyceryl/Octyldodecanol Polymer | / | 4.0 |
| | Tridecyl Neopentanoate | 1.0 | 1.0 |
| | Water (and) Butylene Glycol (and) Theobroma Cacao | 0.01 | 0.01 |
| | (Cocoa) Seed Extract | | |

| | | |
|---|---|---|
| total | 100 | 100 |

### Example 31: SLES/CAPB Anionic Body Wash Formula

Experimental procedure: SLES/CAPB anionic body wash 12896-215-2 procedure: In main beaker combine ingredients of Phase A. Mix with homogenizer (good turnover, avoid air). Heated using a water-bath to 80-85 C. Mixing time is approximately 20 minutes. While heating Phase A, in separate beaker combine ingredients of Phase B. Heat to 80-85 C. Dissolve materials completely. Once Phase B is melted and A and B at 80-85 C add Phase B to Phase A. Homogenize at this temperature for ˜10 minutes. After Phase B and Phase, A have mixed for 10 minutes stop heat and transfer main beaker to double cut-blade stirrer. Keep stirrer at a moderate speed so there is formulation turn-over. Add the betaine and mix 8-10 minutes. Add the dimethyl lauramide and mix another 8-10 minutes. Keep formulation covered to prevent water loss. Allow combine ABC to cool while mixing to 35-40 C. Ingredients of Phase D are added one at a time, on order waiting for materials to dissolve before adding the next. Once all ingredients are added measure pH and record. Adjust to ˜6.7 using 18% NaOH. Allow to equilibrate and measure final pH and viscosity.

### Skin Conditioning Preference Procedure

### Objective:

Measure the skin conditioning perception of 2 liquid soaps.

### Sample Names:

### 2 Formulations:

Product A 12896-215-1 (control)

Product P 12896-215-2 (1% Antaron Soja glyceride)

### Conclusions

Product P (12896-215-2 with 1% Antaron Soja) is selected as skin conditioning product by 85% of subjects in the wet skin state and by 93% of subjects in the dry skin state.

### Number of Subjects:

14

### Protocol:

Amounts of each soap have been premeasured and provided in the form of easy dispense syringes. Each panelist is provided with 1 syringe of each product containing exactly 1.5 ml amounts. Ivory soap is used as a pre-wash skin cleanser before testing each liquid soap product.

All tests are performed as a double-blind study.

Panelists are given the following instructions for the study along with ivory soap and a room temperature fan to air dry hands.
1. Wash hands with Ivory soap for 30s then rinse completely.
2. Keep hands wet
3. Dispense the first liquid soap in the palm of the hand
4. Lather to generate foam for 60 seconds.
5. Evaluate wet skin conditioning.
6. Rinse hands for 60 seconds
7. AIR DRY hands with FAN (NO paper towel) WAIT 10 minutes
8. Repeat all steps 1-8 with 2nd liquid soap.
9. Answer skin conditioning questions

### During Lather

Which product leaves skin more conditioned? Circle the preferred product

### After Air Drying

Which product leaves skin more conditioned? Circle the preferred product

### Example R

| | | % w/w | % w/w |
|---|---|---|---|
| | | 12896- | 12896- |
| Phase | INCI Name | 215-1 | 215-2 |
| A | Water | 55.36 | 54.36 |
| | Glycerin | 2.0 | 2.0 |
| | Acrylates Copolymer (and) Water | 10.0 | 10.0 |
| | Sodium Laureth Sulfate (and) Water | 17.14 | 17.14 |
| B | Maleated Soybean Oil | / | 1.0 |
| | Glyceryl/Octyldodecanol Polymer | | |
| | Soybean Oil | 2.0 | 2.0 |
| | Hydroxyethyl cetearamidopropyl dimonium | 1.0 | 1.0 |
| | chloride (and) Behenyl alcohol (and) Cetearyl | | |
| | alcohol | | |
| C | Cocoamidopropyl Betaine (and) Water | 10 | 10 |
| | Dimethyl Lauramide/Myristamide | 1.0 | 1.0 |
| D | Phenoxyethanol (and) Caprylyl Glycol | 1.0 | 1.0 |
| | Sodium Hydroxymethylglycinate (and) Water | 0.5 | 0.5 |

| | | |
|---|---|---|
| Total | 100 | 100 |

### Example 32: SAOS-CAPB Body Wash Formula

Experimental procedure: Combine ingredients one at a time, in order, in main beaker waiting for uniformity before adding the next. Once all ingredients are combined adjust pH to ˜5.0 using citric acid

### Example R1: SAOS-CAPB System

| INCI Name | % w/w |
|---|---|
| Deionized Water | 57.00 |
| Glycerin | 2.00 |
| Sodium C14-16 Olefin Sulfonate (40%) | 25.00 |
| Cocamidopropyl Betaine (30%) | 10.00 |
| Decyl Glucoside (50%) | 2.00 |
| Cocoglucoside (50%) | 2.00 |
| Benzyl Alcohol (and) Aqua (Water) (and) Sodium Benzoate | 1.00 |
| (and) Potassium Sorbate | |
| Maleated Soybean Oil Glyceryl/Octyldodecanol Polymer | 1.00 |
| Total | 100.00 |

### Example R2: SAOS-CAPB System APG Body Wash Formula

Experimental procedure: Combine water, glycerin, Decyl glucoside Cocoglucoside in main beaker-heat to 45 C. Soja was added to batch directly and mixed. Preservative was added and mixed well. Adjust to pH 5-5.2 using citric acid.

### Example R2: APG System

| INCI Name | % w/w |
|---|---|
| Deionized Water | 69.00 |
| Glycerin | 3.00 |
| Decyl Glucoside (50%) | 16.00 |
| Cocoglucoside (50%) | 10.00 |
| Benzyl Alcohol (and) Aqua (Water) (and) Sodium Benzoate | 1.00 |
| (and) Potassium Sorbate | |
| Maleated Soybean Oil Glyceryl/Octyldodecanol Polymer | 1.00 |
| Total | 100.00 |

### Example R3: Amino Acid System

Experimental procedure: Amino acid body wash formula. Ingredients are added at a time, in order, in main beaker maintaining for uniformity before adding the next. Mix for at least 30 minutes to ensure complete uniformity and adjusted pH to ˜6.0 using citric acid.

### Example R3

| INCI Name | % w/w |
|---|---|
| Deionized Water | 32.50 |
| Glycerin | 20.00 |
| Disodium Cocoyl Glutamate (40%) | 20.00 |
| Sodium Cocoyl Alaninate (30%) | 26.00 |
| Propylene Glycol (and) Diazolidinyl Urea (and) Iodopropynyl | 0.50 |
| Butylcarbamate | |
| Maleated Soybean Oil Glyceryl/Octyldodecanol Polymer | 1.00 |
| Total | 100.00 |

### Example R4: DSCADA Body Wash Formula

Experimental procedure: Ingredients were added at a time, in order, in main beaker waiting for uniformity before adding the next. Mix well for at least 30 minutes to ensure complete uniformity and adjust pH to ˜5.5-6.0 using citric acid.

### Example R4

| INCI Name | % w/w |
|---|---|
| Deionized Water | 56.14 |
| Glycerin | 4.00 |
| Cocamidopropyl Betaine (30%) | 22.86 |
| Decyl Glucoside (50%) | 4.00 |
| Disodium cocoamphodiacetate (38%) | 8.00 |
| Cocoglucoside (50%) | 2.00 |
| raspberry ketone | 1.00 |
| Phenyl propanol | 1.00 |
| Maleated Soybean Oil Glyceryl/Octyldodecanol Polymer | 1.00 |
| Total | 100.00 |

While the compositions and methods of the disclosed and/or claimed inventive concept(s) have been described in terms of particular aspects, it will be apparent to those of ordinary skill in the art that variations may be applied to the compositions and/or methods and in the steps or in the sequence of steps of the method described herein without departing from the concept, spirit and scope of the disclosed and/or claimed inventive concept(s). All such similar substitutes and modifications apparent to those skilled in the art are deemed to be within the spirit, scope and concept of the disclosed and/or claimed inventive concept(s).

What is claimed is:

1. A composition comprising a reaction product of
(a) a maleated natural oil, comprising a natural oil with maleated functionality; and
(b) a functionalized or unfunctionalized moiety selected from the group consisting of hydrophobic moieties, hydrophilic moieties, and combinations thereof;
with the proviso that the hydrophilic moiety is not a glycerol moiety.

2. The composition according to claim 1, wherein the reaction product comprises an unreacted maleated functionality.

3. The composition according to claim 1, wherein the reaction product comprises a maleated functionality functionalized with a hydrophobic moiety, a hydrophilic moiety, or combinations thereof.

4. The composition according to claim 1, wherein the hydrophobic moiety is a moiety selected from the group consisting of unsubstituted or substituted alkyl, cycloalkyl, alkenyl, and aryl alcohols, wherein any of the beforehand mentioned groups may be with or without heteroatoms, containing from about C6 to about C36 atoms, unsubstituted or substituted alkyl, cycloalkyl, alkenyl, and aryl amines, wherein any of the beforehand mentioned groups may be with or without heteroatoms, containing from about C6 to about C36 atoms, silicon-based compounds, and combinations thereof.

5. The composition according to claim 1, wherein the hydrophilic moiety is a moiety selected from the group consisting of unsubstituted or substituted alkyl, cycloalkyl, alkenyl, and aryl alcohols, wherein any of the beforehand mentioned groups may be with or without heteroatoms, containing from about C1 to about C5 atoms, unsubstituted or substituted alkyl, cycloalkyl, alkenyl, and aryl amines, wherein any of the beforehand mentioned groups may be with or without heteroatoms, containing from about C1 to about C5 atoms, unsubstituted or substituted polyols, wherein any of the beforehand mentioned groups may be with or without heteroatoms, containing from about C2 to about C36 atoms, silanes, and combinations thereof.

6. The composition according to claim 5, wherein the silane is functionalized with an alcohol or an amine, and combinations thereof.

7. The composition according to claim 4, wherein the hydrophobic alcohol is selected from the group consisting of heptanol, nonanol, decanol, dodecanol, phenol, ethylbenzyl alcohol, 2-ethyl-1-hexanol, 1-octanol, 2-octanol, 2-octyl-1-dodecyl alcohol, 2-tertradecanol, 2-hexadecanol, 3,7-dimethyl-1-octanol, 2-propyl-1-pentanol, 4-methyl-1-pentanol, and mixtures thereof.

8. The composition according to claim 5, wherein the hydrophilic alcohol is selected from the group consisting of methanol, ethanol, propanol, isopropanol, butanol, ethylene glycol, propylene glycol, diethylene glycol, dipropylene glycol, dibutylene glycol, polyethylene glycol, methoxypolyethylene glycol, polypropylene glycol, hexylene glycol, sorbitol, neopentylglycol, eythritol, mannitol, xylitol, threitol, pentaerythritol, beta-cyclodextrin, L-Ribose, 2-deoxy-D-galactose, and mixtures thereof.

9. The composition according to claim 4, wherein the hydrophobic amine is selected from the group consisting of benzylamine, cyclohexylamine, hexylamine, methylhexylamine, phenethylamine, octylamine, oleylamine, decylamine, dodecylamine, octadecylamine, undecyl amine, pentadecyl amine, 2-methyl butyl amine, dimethyl amine, and mixtures thereof.

10. The composition according to claim 5, wherein the hydrophilic amine is selected from the group consisting of 2-methylpentane-1,5-diamine, diethanol amine, diisopropanolamine, serinol hydrochloride, 2-amino-2-ethyl-1,3-propanediol, N-methyl-D-glucosamine, D-galactosamine hydrochloride, D-glucosamine hydrochloride, D-mannosamine hydrochloride, and mixtures thereof.

11. The composition according to claim 4, wherein the silicon-based compound is a hydrophobic compound selected from the group consisting of aminopropylmethylsiloxane-dimethylsiloxane, N-ethylaminoisobutyl terminated polydimethylsiloxane, poly(1,1-dimethylsilazane) telomer, aminopropyl terminated polydimethylsiloxane, monoaminopropyl terminated polydimethylsiloxane, (tetramethylpiperidinyloxy)propylmethylsiloxane]-dimethylsiloxane copolymer, polydimethylsiloxane, carbinol (hydroxyl) terminated polydimethylsiloxane, monocarbinol terminated polydimethylsiloxane, monocarbinol terminated functional polydimethylsiloxane, [Bis(hydroxyethyl)amine] terminated polydimethylsiloxane, silanol terminated polydimethylsiloxane, silanol terminated polydiphenylsiloxane, dodecylmethylsiloxane-hydroxypolyalkyleneoxypropyl methylsiloxane, and mixtures thereof.

12. The composition according to claim 5, wherein the silane is a hydrophilic compound selected from the group consisting of 3-aminopropylsilanetriol, N-(2-aminoethyl)-3-aminopropylsilanetriol, and mixtures thereof.

13. The composition according to claim 1, wherein the maleated natural oil is selected from the group consisting of maleated avocado oils, maleated coconut oils, maleated corn oils, maleated cottonseed oils, maleated jojoba oils, maleated linseed oils, maleated nut oils, maleated olive oils, maleated palm oils, maleated raisin oils, maleated rapeseed oils, maleated safflower oils, maleated sesame oils, maleated soybean oils, maleated squash oils, maleated sunflower oils, maleated almond oils, maleated canola oils, maleated flaxseed oils, maleated grapeseed oils, maleated palm oils, maleated palm kernel oils, maleated peanut oils, maleated walnut oils, maleated chickpea oils, and mixtures thereof.

14. (canceled)

15. The composition according to claim 1, wherein the composition is selected from the group consisting of skin care compositions, oral care compositions, hair care compositions, energy compositions, construction compositions, biocidal compositions, preservative compositions, nutraceutical compositions, food compositions, agricultural compositions, coating compositions, cosmetic compositions, homecare compositions, industrial and institutional compositions, textile compositions, laundry compositions, cleaning compositions, and disinfecting compositions.

16-27. (canceled)

28. A composition comprising:
(A) a reaction product of:
(a) a maleated natural oil, comprising a natural oil with maleated functionality; and
(b) a functionalized or unfunctionalized moiety selected from the group consisting of hydrophobic moieties, hydrophilic moieties, and combinations thereof;
with the proviso that the hydrophilic moiety is not a glycerol moiety
(B) (a) a functional system active ingredient.

29. The composition according to claim 28, wherein the reaction product comprises an unreacted maleated functionality.

30. The composition according to claim 28, wherein the reaction product comprises a maleated functionality functionalized with a hydrophobic moiety, a hydrophilic moiety, and combinations thereof.

31. The composition according to claim 28, wherein the hydrophobic moiety is a moiety selected from the group consisting of unsubstituted or substituted alkyl, cycloalkyl, alkenyl, and aryl alcohols, wherein any of the beforehand mentioned groups may be with or without heteroatoms, containing from about C6 to about C36 atoms, unsubstituted or substituted alkyl, cycloalkyl, alkenyl, and aryl amines, wherein any of the beforehand mentioned groups may be with or without heteroatoms, containing from about C6 to about C36 atoms, silicon-based compounds, and combinations thereof.

32. The composition according to claim 28, wherein the hydrophilic moiety is a moiety selected from the group consisting of unsubstituted or substituted alkyl, cycloalkyl, alkenyl, and aryl alcohols, wherein any of the beforehand mentioned groups may be with or without heteroatoms, containing from about C1 to about C5 atoms, unsubstituted or substituted alkyl, cycloalkyl, alkenyl, and aryl amines, wherein any of the beforehand mentioned groups may be with or without heteroatoms, containing from about C1 to about C5 atoms, unsubstituted or substituted polyols, wherein any of the beforehand mentioned groups may be with or without heteroatoms, containing from about C2 to about C36 atoms, silanes, and combinations thereof.

33. The composition according to claim 32, wherein the silane is functionalized with an alcohol or an amine, and combinations thereof.

34. The composition according to claim 31, wherein the hydrophobic alcohol is selected from the group consisting of heptanol, nonanol, decanol, dodecanol, phenol, ethylbenzyl alcohol, 2-ethyl-1-hexanol, 1-octanol, 2-octanol, 2-octyl-1-dodecyl alcohol, 2-tertradecanol, 2-hexadecanol, 3,7-dimethyl-1-octanol, 2-propyl-1-pentanol, 4-methyl-1-pentanol, and mixtures thereof.

35. The composition according to claim 32, wherein the hydrophilic alcohol is selected from the group consisting of methanol, ethanol, propanol, isopropanol, butanol, ethylene glycol, propylene glycol, diethylene glycol, dipropylene glycol, dibutylene glycol, polyethylene glycol, methoxypolyethylene glycol, polypropylene glycol, hexylene glycol, sorbitol, neopentylglycol, eythritol, mannitol, xylitol, threitol, pentaerythritol, beta-cyclodextrin, L-Ribose, 2-deoxy-D-galactose, and mixtures thereof.

36. The composition according to claim 31, wherein the hydrophobic amine is selected from the group consisting of benzylamine, cyclohexylamine, hexylamine, methylhexylamine, phenethylamine, octylamine, oleylamine, decylamine, dodecylamine, octadecylamine, undecyl amine, pentadecyl amine, 2-methyl butyl amine, dimethyl amine, and mixtures thereof.

37. The composition according to claim 32, wherein the hydrophilic amine is selected from the group consisting of 2-methylpentane-1,5-diamine, diethanol amine, diisopropanolamine, serinol hydrochloride, 2-amino-2-ethyl-1,3-propanediol, N-methyl-D-glucosamine, D-galactosamine hydrochloride, D-glucosamine hydrochloride, D-mannosamine hydrochloride, and mixtures thereof.

38. The composition according to claim 31, wherein the silicon-based compound is a hydrophobic compound selected from the group consisting of aminopropylmethylsiloxane-dimethylsiloxane, N-ethylaminoisobutyl terminated polydimethylsiloxane, poly(1,1-dimethylsilazane) telomer, aminopropyl terminated polydimethylsiloxane, monoaminopropyl terminated polydimethylsiloxane, (tetramethylpiperidinyloxy)propylmethylsiloxane]-dimethylsiloxane copolymer, polydimethylsiloxane, carbinol (hydroxyl) terminated polydimethylsiloxane, monocarbinol terminated polydimethylsiloxane, monocarbinol terminated functional polydimethylsiloxane, [Bis(hydroxyethyl)amine] terminated polydimethylsiloxane, silanol terminated polydimethylsiloxane, silanol terminated polydiphenylsiloxane,dodecylmethylsiloxane-hydroxypolyalkyleneoxypropyl methylsiloxane, and mixtures thereof.

39. The composition according to claim 32, wherein the silane is a hydrophilic compound selected from the group consisting of 3-aminopropylsilanetriol, N-(2-aminoethyl)-3-aminopropylsilanetriol, and mixtures thereof.

40. The composition according to claim 28, wherein the maleated natural oil is selected from the group consisting of maleated avocado oils, maleated coconut oils, maleated corn oils, maleated cottonseed oils, maleated jojoba oils, maleated linseed oils, maleated nut oils, maleated olive oils, maleated palm oils, maleated raisin oils, maleated rapeseed oils, maleated safflower oils, maleated sesame oils, maleated soybean oils, maleated squash oils, maleated sunflower oils, maleated almond oils, maleated canola oils, maleated flaxseed oils, maleated grapeseed oils, maleated palm oils, maleated palm kernel oils, maleated peanut oils, maleated walnut oils, maleated chickpea oils and mixtures thereof.

41. (canceled)

42. The composition according to claim 28, wherein the composition is selected from the group consisting of skin care compositions, oral care compositions, hair care compositions, energy compositions, construction compositions, biocidal compositions, preservative compositions, nutraceutical compositions, food compositions, agricultural compositions, coating compositions, cosmetic compositions, homecare compositions, industrial and institutional compositions, textile compositions, laundry compositions, cleaning compositions, and disinfecting compositions.

43-141. (canceled)
